(19) United States
(12) Patent Application Publication
(10) Pub. No.: US 2026/0183666 A1
(43) Pub. Date: Jul. 2, 2026

(54) ONE OR MORE COMPUTER-READABLE STORAGE MEDIA, GAME SYSTEM, AND GAME PROCESSING METHOD

(71) Applicant: NINTENDO CO., LTD., Kyoto (JP)

(72) Inventors: Yusuke KITAZONO, Kyoto (JP); Kazuya TAKAHASHI, Kyoto (JP); Yusaku YAMANAKA, Kyoto (JP)

(21) Appl. No.: 19/413,513

(22) Filed: Dec. 9, 2025

(30) Foreign Application Priority Data
Dec. 26, 2024 (JP) 2024-229891

(51) Int. Cl. A63F 13/577; A63F 13/211; A63F 13/5255; A63F 13/69

(52) U.S. Cl. CPC A63F 13/577; A63F 13/211; A63F 13/5255; A63F 13/69

(57) ABSTRACT

A position of a cursor is controlled based on an operation input from an operation device. A material of a mesh of a voxel object at a position in a virtual space related to the position of the cursor is identified as a first material according to a first instruction based on an operation input from the operation device. An object for which the first material is set is moved toward the position in the virtual space related to the position of the cursor, according to a second instruction based on an operation input from the operation device. An in-game effect including a change in at least one of densities and materials of voxels in voxel data related to a voxel update range set at a collision position based on collision determination between the object and the mesh.

### CROSS REFERENCE TO RELATED APPLICATION

This application claims priority to Japanese Patent Application No. 2024-229891, filed on Dec. 26, 2024, the entire contents of which are incorporated herein by reference.

### FIELD

The technology disclosed herein relates to one or more computer-readable storage media, game systems, and game processing methods that generate an object in a virtual space using voxel data.

### BACKGROUND AND SUMMARY

A technique for generating a mesh based on voxel data has conventionally been proposed.

It is considered that in the case in which a game employing the voxel mesh generation technique is provided, a material set for an object using voxel data is utilized.

The present example discloses one or more computer-readable storage media, a game system, and a game processing method that are capable of further utilizing a material set for an object using voxel data in a game.

The present example may have the following features (1) to (9), for example.
(1) An example configuration of one or more non-transitory computer-readable storage media according to the present example is one or more non-transitory computer-readable storage media having stored therein instructions that, when executed, cause an information processing system to perform operations comprising: generating and updating a mesh based on voxel data defined in a virtual space, wherein the mesh is a mesh of a voxel object related to the voxel data, wherein in the voxel data, for each of a plurality of voxels, at least a density indicating the degree of virtual occupation of a content in a space defined by the voxel, and a material indicating the type of the content, are set, and wherein vertex coordinates of the mesh are determined based on at least the density, and a material of the mesh is determined based on at least the material included in the voxel data; controlling a position of a first cursor based on an operation input from a first operation device; identifying a material of the mesh at a position in the virtual space related to the position of the first cursor according to a first instruction based on an operation input from the first operation device, wherein the identified material is a first material; moving a first object for which the first material is set, toward the position in the virtual space related to the position of the first cursor, according to a second instruction based on an operation input from the first operation device; and setting a first voxel update range at a collision position based on collision determination between the first object and the mesh, and producing a first in-game effect including a change in at least one of the densities and materials of voxels in the voxel data related to the first voxel update range.

With the configuration of (1), a game can be provided which is based on interaction between a mesh of a voxel object and a first object for which a material corresponding to a position of a first cursor on the mesh of the voxel object is acquired and set. Therefore, a material set for an object using voxel data can be further utilized in a game.
(2) In the configuration of (1), the operations may further comprise: controlling movement of the first player character in the virtual space based on an operation input from a second operation device; controlling movement of the second player character together with the movement of the first player character; causing the first player character to perform a first action according to a third instruction based on an operation input from the second operation device; and causing the second player character to perform a second action, and moving the first object, according to the second instruction.

With the configuration of (2), actions of different player characters are controlled according to operation on respective ones of two different operation devices, and movements of the two player characters are controlled according to operation on one of the operation devices. Therefore, a plurality of users can play a game in cooperation with each other.
(3) In the configuration of (2), the operations may further comprise: controlling a position of a virtual camera in the virtual space based on a position of the first player character; and controlling an orientation of the virtual camera based on at least an operation input from the first operation device.

With the configuration of (3), the orientation of the virtual camera is controlled according to operation using the first operation device. Therefore, it is easier to aim the first cursor in cooperative play by a plurality of users.
(4) In the configuration of (3), the operations may further comprise: controlling the orientation of the virtual camera, additionally based on an operation input from the second operation device.

With the configuration of (4), the orientation of the virtual camera can also controlled according to operation using the second operation device. Therefore, the virtual camera can be controlled by the other user in cooperative play.
(5) In the configuration of any one of (2) to (4), the operations may further comprise: controlling a position of a second cursor; causing the first player character to perform the first action, and moving a second object for which a second material is set toward a position in the virtual space related to the position of the second cursor, according to the third instruction; and setting a second voxel update range at a collision position based on collision determination between the second object and the mesh, and producing a second in-game effect including a change in at least one of the densities and materials of voxels in the voxel data related to the second voxel update range.

With the configuration of (5), when a plurality of users perform cooperative play, respective cursors used by the users are displayed separately. Therefore, a game can be provided in which each user aims at a target in the same game space.
(6) In the configuration of any one of (1) to (5), the operations may further comprise: producing, as the first in-game effect, one of a plurality of effects including at least an effect of reducing the densities of voxels in the voxel data related to the first voxel update range, an effect of increasing the densities of the voxels in the voxel data related to the first voxel update range and setting the materials of the voxels in the voxel data related to the first voxel update range to the first material, and an effect of, when a third material that is a material of the mesh at the collision position and the first material are a first combination, changing the materials of the voxels in the voxel data related to the first voxel update range to a fourth material, depending on the type of the first material.

With the configuration of (6), various in-game effects can be produced, depending on the type of a material of a first object, due to interaction between the first object and a mesh of a voxel object.
(7) In the configuration of any one of (1) to (6), the operation input from th first operation device may include at least one of data based on a mouse, data based on an inertial sensor, and direction input data. In that case, the operations may further comprise: controlling the position of the first cursor based on at least one of the data based on a mouse, the data based on an inertial sensor, and the direction input data.

With the configuration of (7), when an operation device capable of performing one of an operation using a mouse function, an operation using an inertial sensor, and an operation using a direction input unit is used and operated, a position of a first cursor can be controlled based on at least one of these operations. Therefore, various operations can be performed.
(8) In the configuration of any one of (1) to (7), the mesh may be a determination mesh used in the collision determination. In that case, the operations may further comprise: generating or updating a display mesh related to the voxel data and to be rendered based on a virtual camera, by determining vertex coordinates of the display mesh based on at least the density included in the voxel data, and determining a material of the display mesh based on at least the material included in the voxel data; and rendering the virtual space including the display mesh based on the vertex coordinates of the display mesh and a texture related to the material of the display mesh.

With the configuration of (8), a determination mesh and a display mesh are determined separately. Therefore, an appropriate mesh can be used for each application.
(9) In the configuration of any one of (1) to (8), the operations may further comprise: rendering the virtual space including the mesh based on the vertex coordinates of the mesh and a texture related to the material of the mesh.

With the configuration of (9), rendering and collision determination can be performed on the same mesh. Therefore, processing load for setting a mesh can be reduced.

The present example may also be carried out in the forms of a game system a game processing method.

According to the present example, a material set for an object using voxel data can be further utilized in a game.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a view showing a non-limiting example where a left controller and a right controller are attached to a main body apparatus;

FIG. 2 is a view showing a non-limiting example where a left controller and a right controller are removed from a main body apparatus;

FIG. 3 is a six-sided view showing a non-limiting example of a main body apparatus;

FIG. 4 is a six-sided view showing a non-limiting example of a left controller;

FIG. 5 is a six-sided view showing a non-limiting example of a right controller;

FIG. 6 is a block diagram showing a non-limiting example of an internal configuration of a main body apparatus;

FIG. 7 is a block diagram showing a non-limiting example of an internal configuration of a main body apparatus, a left controller and a right controller;

FIG. 8 is a diagram for describing a non-limiting example embodiment of controllers simultaneously connected to a single main body apparatus 2;

FIG. 9 is a view showing a non-limiting example of a terrain object, which is a voxel object;

FIG. 10 is a view showing a non-limiting example of states before and after the deletion of a portion of the terrain object shown in FIG. 9;

FIG. 11 is a view showing a non-limiting example of states before and after the deletion of a portion of the terrain object shown in FIG. 9;

FIG. 12 is a view showing a non-limiting example of voxel data;

FIG. 13 is a view showing a non-limiting example of material data;

FIG. 14 is a view showing a non-limiting example of a game space when an update event has occurred;

FIG. 15 is a view showing a non-limiting example of an update range;

FIG. 16 is a view showing a non-limiting example of a method for setting vertices;

FIG. 17 is a view showing a non-limiting example of a method for determining a material of a vertex;

FIG. 18 is a view showing a non-limiting example of vertex simplification;

FIG. 19 is a view showing a non-limiting example of conditions regarding materials;

FIG. 20 is a view showing a non-limiting example of a mesh generated based on vertices;

FIG. 21 is a view showing a non-limiting example of division of a quadrangle forming a mesh into two triangles;

FIG. 22 is a view showing a non-limiting example of a method for determining materials of polygons forming a display mesh;

FIG. 23 is a view showing a non-limiting example of materials set for vertices of adjacent two polygons;

FIG. 24 is a view showing a non-limiting example of application of textures to polygons;

FIG. 25 is a view showing a non-limiting example of a method for determining materials of polygons forming a determination mesh;

FIG. 26 is a view showing a non-limiting example of a game image representing a state in which a player character moves on a terrain object;

FIG. 27 is a diagram showing a non-limiting example of a game image representing a state in which a second player character 204 emits a shout object 253;

FIG. 28 is a diagram showing a non-limiting example of a game image representing a state after a second player character 204 has emitted a shout object 253;

FIG. 29 is a diagram showing another non-limiting example of a game image representing a state in which a player character moves on a terrain object;

FIG. 30 is a diagram showing a non-limiting example of a game image representing a state in which a second player character 204 emits a shout object 271;

FIG. 31 is a diagram showing a non-limiting example of a game image representing a state after a second player character 204 has emitted a shout object 271;

FIG. 32 is a diagram showing a non-limiting example of an in-game effect th is produced based on the type of a material set for a shout object 253 and the type of a material of an object with which the shout object 253 has collided;

FIG. 33 is a diagram showing a non-limiting example of a game image representing a state in which a first player character 201 pulls out a fragment object 256 from a terrain object 251;

FIG. 34 is a diagram showing a non-limiting example of a game image representing a state in which a fragment object 258 is generated by a first player character 201 destroying a terrain object 251;

FIG. 35 is a diagram showing a non-limiting example of a game image representing a state in which a player character 201 throws a fragment object 260 to a terrain object 252 made of a lava material;

FIG. 36 is a diagram showing a non-limiting example of a game image representing a state in which a player character 201 throws a fragment object 260 to a terrain object 252 made of a lava material;

FIG. 37 is a diagram showing a non-limiting example of operation instructions corresponding to operation inputs of each controller used by a first user;

FIG. 38 is a diagram showing a non-limiting example of operation instructions corresponding to operation inputs of each controller used by a second user;

FIG. 39 is a view showing a non-limiting example of various data used for information processing in a game system 1;

FIG. 40 is a flowchart showing a non-limiting example of a flow of game processing executed by a game system 1;

FIG. 41 is a subroutine showing a non-limiting example of a first half of a process of controlling a motion of each object executed in step S12 of FIG. 40; and

FIG. 42 is a subroutine showing a non-limiting example of a second half of the process of controlling a motion of each object executed in step S12 of FIG. 40.

### DETAILED DESCRIPTION OF NON-LIMITING EXAMPLE EMBODIMENTS

### 1. Configuration of Game System

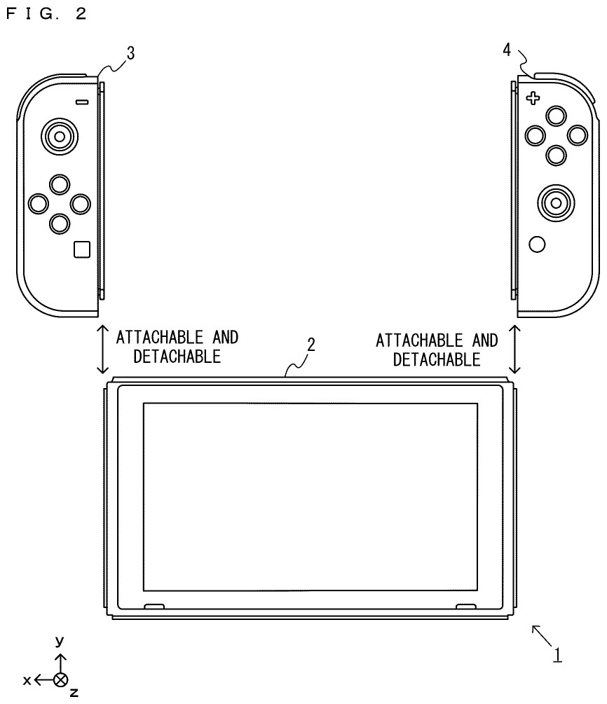

A game system according to the present example is described below. An example of a game system 1 according to the present example includes a main body apparatus (an information processing apparatus; which functions as a game apparatus main body in the present example) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the present example is described, and then, the control of the game system 1 according to the present example is described.

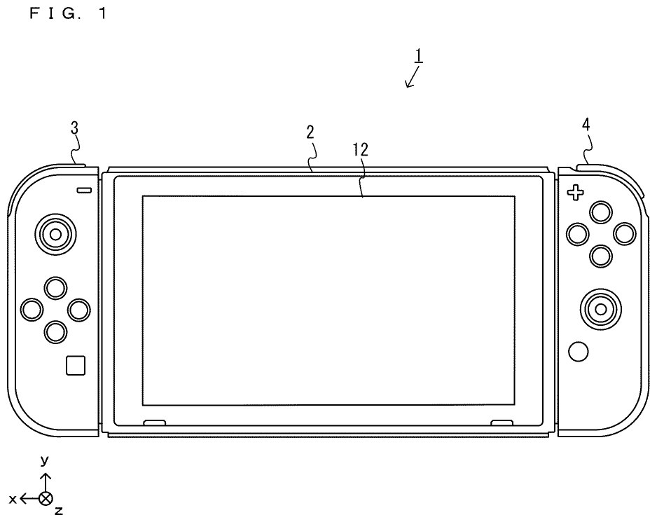

FIG. 1 is a diagram showing an example of the state in which the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state in which each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “first controller”.

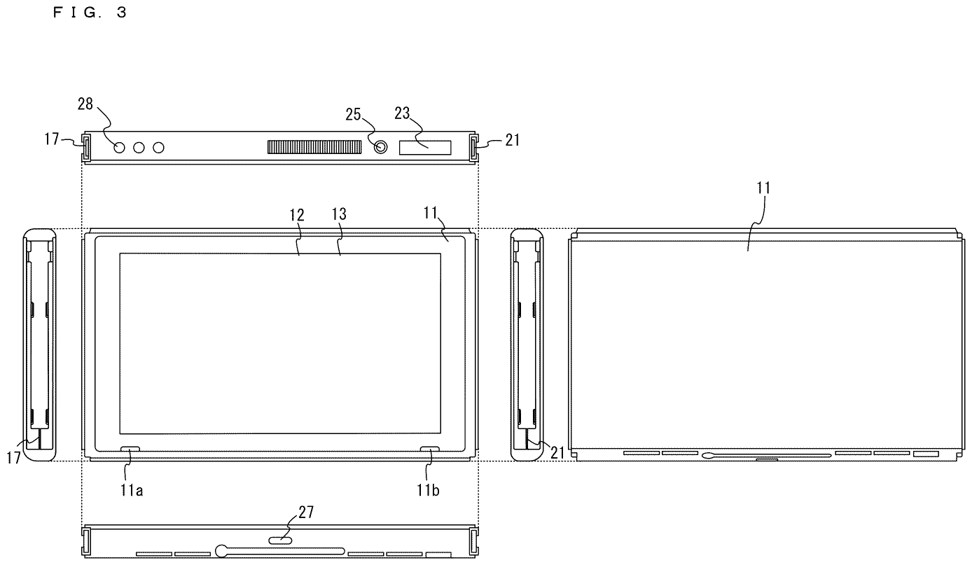

FIG. 3 is six orthogonal views showing an example of the main body apparatus 2. As shown in FIG. 3, the main body apparatus 2 includes an approximately plate-shaped housing 11. In the present example, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any type.

Further, the main body apparatus 2 includes a touch panel 13 on a screen of the display 12. In the present example, the touch panel 13 is of a type that allows a multi-touch input (e.g., a capacitive type). The touch panel 13, however, may be of any type. For example, the touch panel 13 may be of a type that allows a single-touch input (e.g., a resistive type).

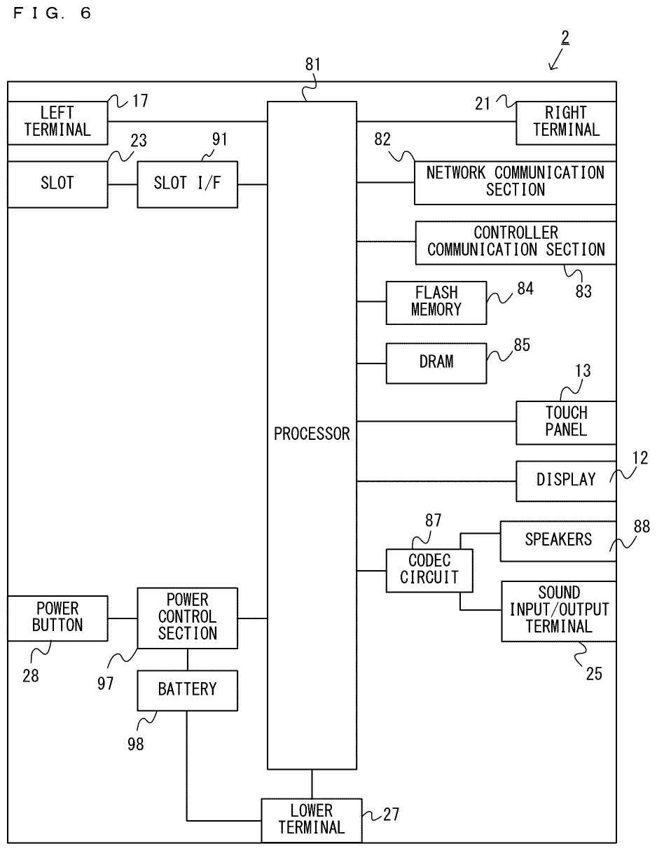

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the present example, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the present example, the cradle has the function of charging the unified apparatus or the main body apparatus 2 alone mounted on the cradle. Further, the cradle has the function of a hub device (specifically, a USB hub).

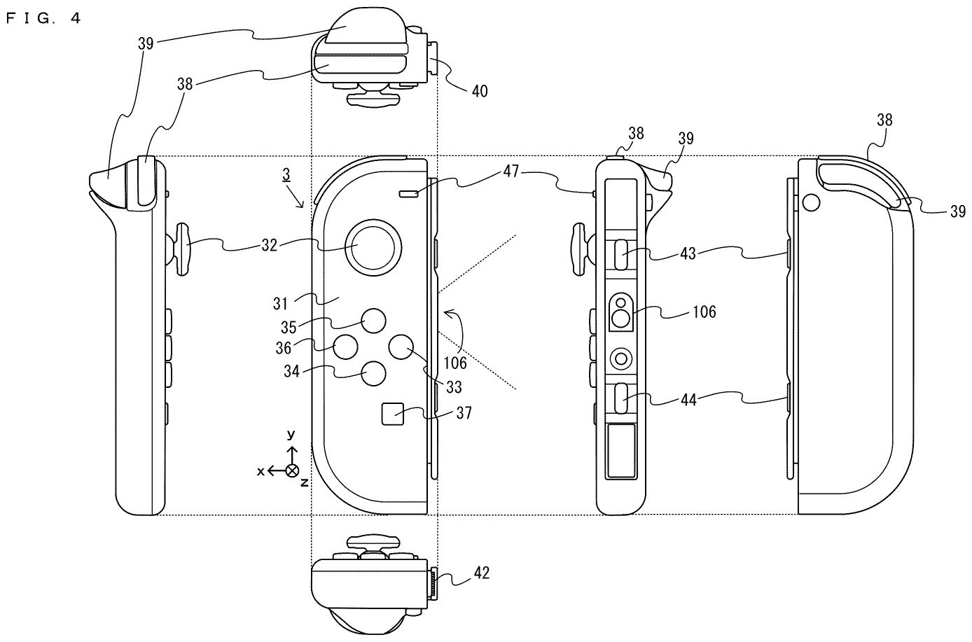

FIG. 4 is six orthogonal views showing an example of the left controller 3. As shown in FIG. 4, the left controller 3 includes a housing 31. In the present example, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands. In addition, in the present example, the user is allowed to use the left controller 3 as a mouse. For example, the left controller 3 may be used, being placed on a placement surface such as a desk surface.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

In addition, at the right side surface of the housing 31, a mouse sensor 106 is provided which is configured to provide a mouse function (e.g., the function of instructing to move a cursor displayed on a screen). The mouse sensor 106, which is, for example, an optical sensor using an LED, may be similar to the sensor that is used in conventional mice. The mouse sensor may, for example, be a sensor that uses laser light or infrared light. In the present example, the mouse sensor 106 is disposed in the housing 31 at a position where the mouse sensor 106 is exposed to the outside through a through hole formed in the right side surface of the housing 31. When the left controller 3 is placed on the placement surface with the right side surface of the housing 31 facing the placement surface, the light emitted by the mouse sensor 106 is incident to the placement surface, and the mouse sensor 106 detects the light reflected from the placement surface. Based on the result of detection of the reflected light, the game system 1 calculates parameters (e.g., a movement direction and a movement distance) related to the movement of the left controller 3 on the placement surface. It should be noted that the parameters may be calculated in the left controller 3, or in the main body apparatus 2, which receives, from the left controller 3, information related to the result of detection of the reflected light.

Further, the left controller 3 includes a terminal 42 for the left controller 3 to perform wired communication with the main body apparatus 2.

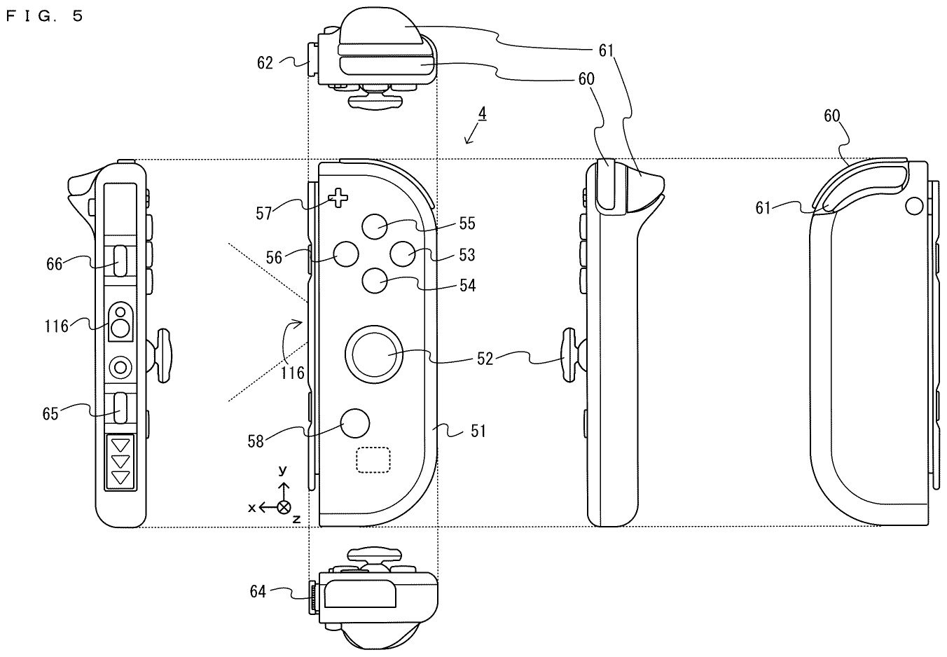

FIG. 5 is six orthogonal views showing an example of the right controller 4. As shown in FIG. 5, the right controller 4 includes a housing 51. In the present example, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands. In addition, in the present example, the user is allowed to use the right controller 4 as a mouse. For example, the right controller 4 may be used, being placed on a placement surface such as a desk surface.

Similarly to the left controller 3, the right controller 4 includes an analog stick 52 as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

In addition, at the left side surface of the housing 51, a mouse sensor 116 is provided which is configured to provide the mouse function. The mouse sensor 11 is an optical sensor as with the mouse sensor 106. In the present example, the mouse sensor 116 is disposed in the housing 51 at a position where the mouse sensor 116 is exposed to the outside through a through hole formed in the left side surface of the housing 51. When the right controller 4 is placed on the placement surface with the left side surface of the housing 51 facing the placement surface, the light emitted by the mouse sensor 116 is incident to the placement surface, and the mouse sensor 116 detects the light reflected from the placement surface. Based on the result of detection of the reflected light, the game system 1 calculates parameters related to the movement of the right controller 4 on the placement surface. It should be noted that the parameters may be calculated in the right controller 4, or in the main body apparatus 2, which receives, from the right controller 4, information related to the result of detection of the reflected light.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external storage non-transitory medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi (registered trademark) standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the present example, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the present example, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

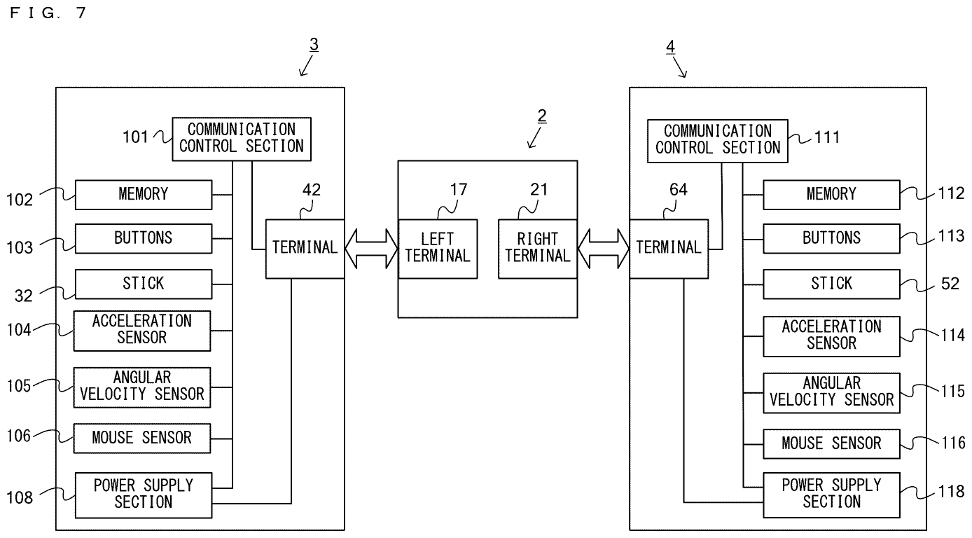

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the present example, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The left controller 3 includes inertial sensors. Specifically, the left controller 3 includes an acceleration sensor 104. The left controller 3 also includes an angular velocity sensor 105. In the present example, the acceleration sensor 104 detects the magnitudes of accelerations along predetermined three axial (e.g., the x-, y-, and z-axes shown in FIG. 4) directions. It should be noted that the acceleration sensor 104 may detect an acceleration or accelerations along one or two axial directions. In the present example, the angular velocity sensor 105 detects angular velocities about predetermined three axes (e.g., the x-, y-, and z-axes shown in FIG. 4). It should be noted that the angular velocity sensor 105 may detect an angular velocity or angular velocities about one or two axes. Each of the acceleration sensor 104 and the angular velocity sensor 105 is connected to the communication control section 101. The results of detection by the acceleration sensor 104 and the angular velocity sensor 105 are output to the communication control section 101 repeatedly with appropriate timing.

The communication control section 101 acquires information regarding an input (specifically, information regarding an operation or the result of detection by the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data. In addition, the main body apparatus 2 is capable of calculating information related to the motion and/or orientation of the left controller 3 based on operation data (specifically, the results of detection by the acceleration sensor104 and the angular velocity sensor 105).

The left controller 3 includes a power supply section 108. In the present example, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, an analog stick 52, and inertial sensors (an acceleration sensor 114 and an angular velocity sensor 115). These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

It should be noted that the game system 1 may be configured to include only one of the mouse sensor 106 provided in the left controller 3 and the mouse sensor 116 provided in the right controller 4. In addition, in the case in which the mouse function is not needed, neither of the mouse sensors 106 and 116 provided in the left controller 3 and the right controller 4 may be provided in the game system 1.

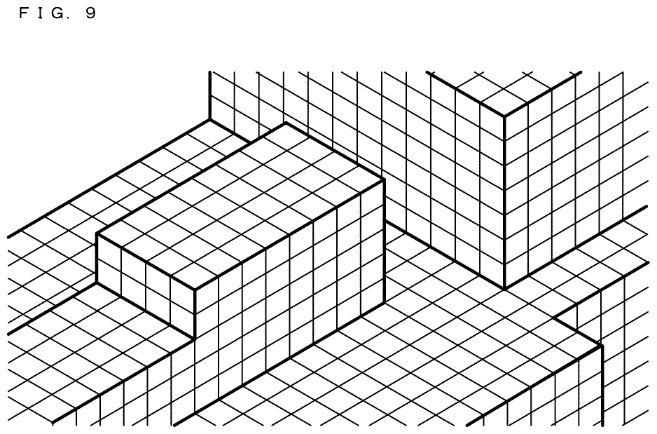

In addition, in the present example, the main body apparatus 2, which can simultaneously communicate with the above plurality of controllers that are the left controller 3 and/or the right controller 4 (first controller), may also be capable of communicating with a second controller 7 (see FIG. 9) that is different from the first controller simultaneously (e.g., in parallel). The second controller 7 can be held and operated by the user using both hands. The second controller 7 can be operated in a manner similar to that of the first controller, except for the mouse function. For example, the second controller 7 includes a left and a right analog stick on the main surface of the housing thereof, and various operation buttons similar to those of the first controller on the main and side surfaces of the housing thereof. The second controller 7 is used to provide instructions in accordance with various programs executed in the main body apparatus 2. In addition, the second controller 7 includes inertial sensors (e.g., an acceleration sensor and an angular velocity sensor) as with the first controller. When the second controller 7 is connected to the main body apparatus 2 in a wireless or wired manner, the details of operations of the analog sticks and operation buttons and the results of detection by the inertial sensors are transmitted to the main body apparatus 2 as appropriate. It should be noted that the first and second controllers may be hereinafter collectively referred to as a “controller”.

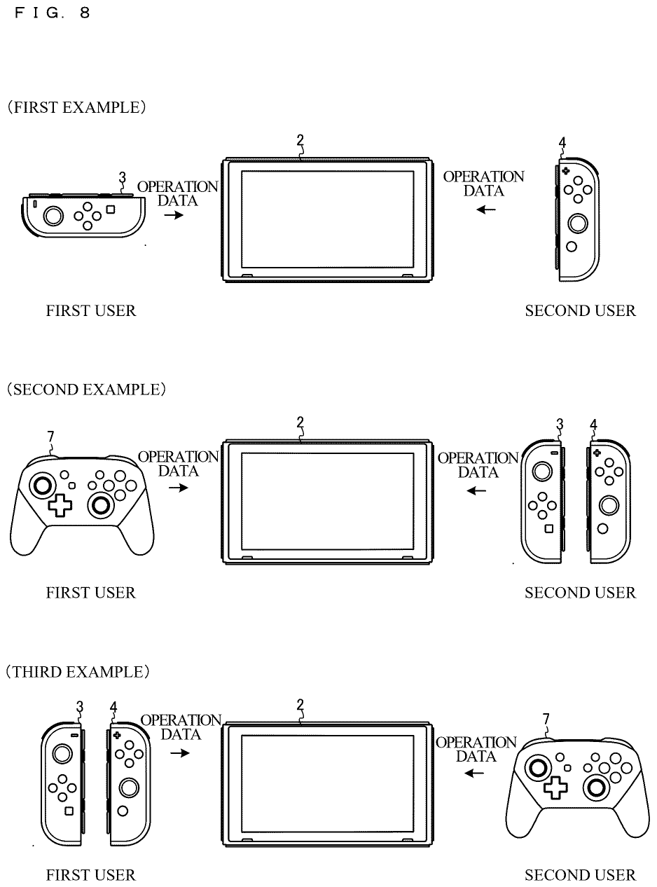

FIG. 8 is a diagram for describing an example embodiment of controllers simultaneously connected to a single main body apparatus 2. In the example shown in FIG. 8, a game displayed on the display 12 of the main body apparatus 2 is played by a plurality of users, and a first and a second user play the game by operating the respective controllers. For example, the first user operates the controller, which in turn outputs operation data to the main body apparatus 2, so as to control a motion of a first player character that appears in the game space in the game. In addition, the second user operates the controller, which in turn outputs operation data to the main body apparatus 2, so as to control a motion of a second player character that appears in the same game space.

In a first example shown in FIG. 8, the first user operates the left controller 3, and the second user operates the right controller 4. Specifically, the left controller 3 is held and operated in a landscape orientation by the first user using both hands. By this operation technique, the first user can operate the analog stick 32 (left analog stick), the operation button 43 (SL button), and the like with the left hand. In addition, the first user can operate the operation buttons 33 to 36 (upward, downward, leftward, and rightward buttons), the operation button 44 (SR button), and the like with the right hand. Furthermore, the first user can perform operations using the inertial sensors of the left controller 3 by moving the entire left controller 3 or changing the orientation of the entire left controller 3. In addition, the right controller 4 is operated by the second user using a single hand with the left side surface in a portrait orientation of the housing 51 placed on the placement surface, or is operated and held in a portrait orientation by the first user using a single hand. By this operation technique, the second user can hold and operate the analog stick 52 (right analog stick), the operation buttons 53 to 56 (A, B, X, and Y buttons), the operation buttons 60 and 61 (R and ZR buttons), and the like using a single hand. In addition, the second user can perform operations using the mouse sensor 116 based on the movement direction and movement distance on the placement surface of the right controller 4, and operations using the inertial sensors of the right controller 4 by moving the entire right controller 4 or changing the orientation of the entire right controller 4. It should be noted that in the first example, the first user may operate the right controller 4 in a landscape orientation, and the second user may operate the left controller 3 in a portrait orientation.

In a second example shown in FIG. 8, the first user operates the second controller 7, and the second user operates a set of the left controller 3 and the right controller 4. Specifically, the second controller 7 is held and operated by the first user using both hands. With this operation technique, the first user can operate the left analog stick and various operation buttons (e.g., the upward, downward, leftward, and rightward buttons, the L button, and the ZL button), and the like with the left hand. In addition, the first user can operate the right analog stick, various operation buttons (e.g., the A, B, X, and Y buttons, the R button, and the ZR button), and the like with the right hand. Furthermore, the first user can perform operations using the inertial sensors of the second controller 7 by moving the entire second controller 7 or changing the orientation of the entire second controller 7. In addition, the left controller 3 is held and operated in a portrait orientation by the second user using the left hand, and the right controller 4 is held and operated in a portrait orientation by the second user using the right hand. With this operation technique, the second user can operate the analog stick 32 (left analog stick), the operation buttons 33 to 36 (upward, downward, leftward, and rightward buttons), and the operation buttons 38 to 39 (L and ZL buttons) with the left hand, which is holding the left controller 3. In addition, the second user can operate the analog stick 52 (right analog stick), the operation buttons 53 to 56 (A, B, X, and Y buttons), the operation buttons 60 and 61 (R and ZR buttons), and the like with the right hand, which is holding the right controller 4. In addition, the second user can perform operations using the inertial sensors of the left controller 3 and/or the right controller 4 by moving the entire left controller 3 and/or the entire right controller 4 or changing the orientations of the entire left controller 3 and/or the entire right controller 4. It should be noted that in the second example, the second user may perform operations using the mouse sensors 106 and/or 116 of the left controller 3 and/or the right controller 4 based on the movement directions and movement distances on the placement surface of the left controller 3 and/or the right controller 4.

In a third example shown in FIG. 8, the first user operates a set of the left controller 3 and the right controller 4, and the second user operates the second controller 7. Specifically, the operation technique with which the first user operates a set of the left controller 3 and the right controller 4 is the same as that of the second user in the second example. In addition, the operation technique with which the second user operates the second controller 7 is the same as that of the first user in the second example.

Thus, in the present example, the first user can control a motion of a first player character that appears in the game space by operating the left controller 3 or the right controller 4, a set of the left controller 3 and the right controller 4, or the second controller 7. In addition, the second user can operate a second player character that appears in the same game space by operating the left controller 3 or the right controller 4, a set of the left controller 3 and the right controller 4, or the second controller 7. It should be noted that the combination of the types of controllers used by the first user and the types of controllers used by the second user is not particularly limited. The combinations illustrated in the first to third examples or other combinations may be used. In addition, in another example, the first user and/or the second user may operate controllers that are different from the first and second controllers and are connected to the main body apparatus 2 in a wireless or wired manner.

### 2. Outline of Process on Game System

Next, referring to FIG. 9 to FIG. 25, an outline of the process performed on the game system 1 will be described. In the present example, the game system 1 generates a game image in which terrain objects and characters (e.g., the player character controlled by the user) are arranged in a game space, which is a three-dimensional virtual space, and displays the game image on a display device. Note that in the present example, the display device on which the game image is displayed may be the display 12 described above, or may be a stationary monitor.

### 2-1. Voxel

In the present example, for some objects in the game space, the shape is defined by voxel data. Here, voxels are rectangular parallelepiped (more specifically, cubic) regions arranged in a grid pattern in the game space, and voxel data is data indicating information regarding the voxels. Hereinafter, an object whose shape is defined by voxel data will be referred to as a “voxel object”. In the present example, the game system 1 stores voxel data for a plurality of voxels that are set in the game space as data for generating voxel objects in the game space.

FIG. 9 is a view showing an example of a terrain object, which is a voxel object. As shown in FIG. 9, in the present example, a terrain object representing a terrain such as a ground surface has its shape defined by voxel data. The cubes shown in FIG. 9 represent a terrain object. Note that in FIG. 9, edges of the terrain object are indicated by thick lines. However, these thick lines are added for the purpose of making the drawings easier to understand, and there is no need for edges of the terrain object to be drawn thick.

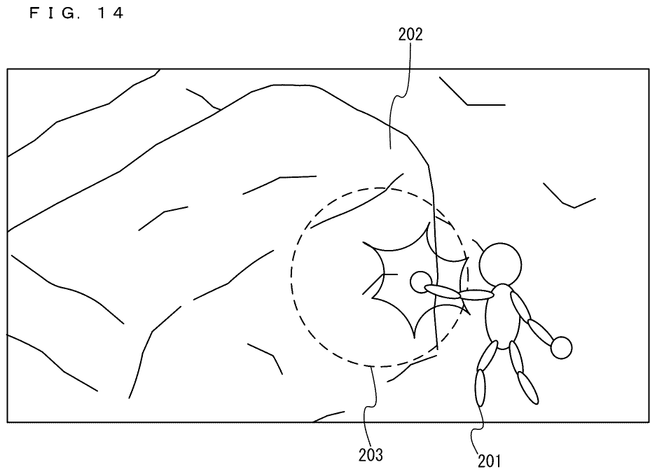

For example, the terrain object shown in FIG. 9 is generated by the following rule: “a cube is placed at the position of a voxel if a parameter included in the voxel data set for the voxel is greater than a predetermined value, and nothing is placed at the position of the voxel if the parameter is less than or equal to the predetermined value”. A terrain object in FIG. 9 is shown for the purpose of illustrating the relationship between voxels and voxel objects in an easy-to-understand manner. Note that in the present example, in practice, a voxel object is generated (e.g., based on voxel data) by such a rule that results in a terrain object having a complicated shape, such as a terrain object shown in FIG. 14 to be described below, for example. Note that there is no limitation on the rule for determining the shape of the voxel object based on the voxel data. In other examples, the game system 1 may generate a voxel object as shown in FIG. 9 based on the object data or may generate a voxel object as shown in FIG. 14 based on the object data.

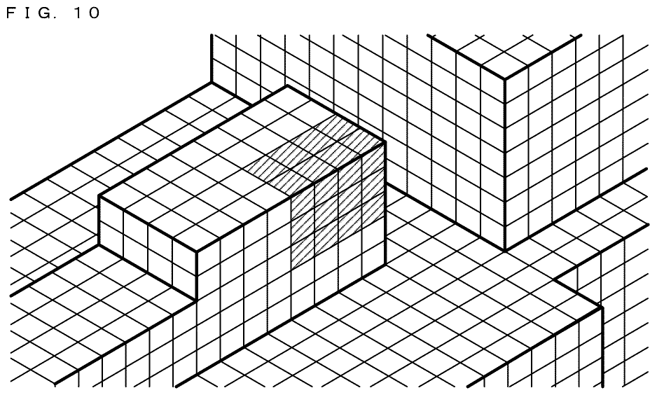

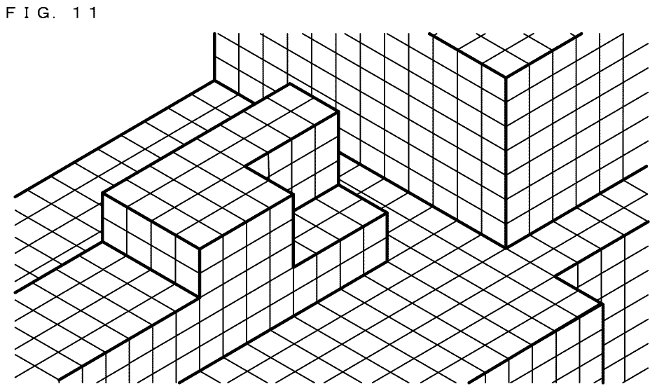

It is possible to change the shape of a voxel object by changing voxel data of voxels. FIG. 10 and FIG. 11 are views showing before and after the removal of a portion of the terrain object shown in FIG. 9. That is, when the hatched portion of the terrain object shown in FIG. 10 is broken, the terrain object changes to a shape as shown in FIG. 11. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

In the present example, voxels are defined in the entire game space (e.g., a voxel space in which voxels are set corresponds to the entire game space). However, the voxel space may not necessarily be set over the entire game space, and may be set in a certain area in the game space. If the voxel space is set in a certain area in the game space, the shape of the voxel object is defined by voxel data regarding voxels in the voxel space, and the position of the voxel object in the game space is defined by the position of the voxel space in the game space. The game space may include a plurality of voxel spaces, and may include a main voxel space that is set over the entire game space, and a sub voxel space that is set in a certain area in the game space. In this case, the game system 1 stores therein the voxel data for each voxel space.

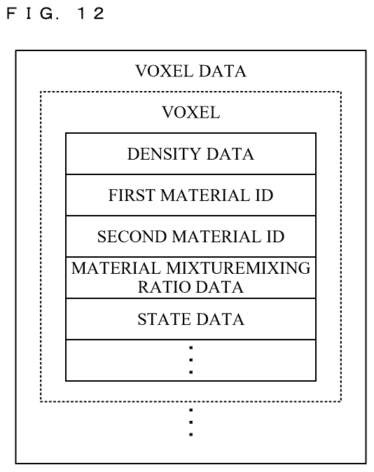

FIG. 12 shows an example of voxel data. The voxel data includes density data, a first material ID, a second material ID, material mixing ratio data, and state data, for each voxel defined in the game space. In the voxel data according to the present example, these pieces of data are set for each voxel.

The density data indicates a density that is an index used for defining the shape of a voxel object based on the voxel (specifically, the shape defined by a mesh described below). As will be described in detail below, the position and shape of the surface of the voxel object (e.g., the mesh described below) are determined based on the density.

In the present example, the density can take an integer value in a range from a lower limit value (e.g., 0) to an upper limit value (e.g., 255). In the present example, the game system 1 determines a surface shape of the voxel object, based on the density such that the proportion of the volume that the area in the voxel object occupies in the voxel tends to be greater when the density value set for the voxel is higher, and the proportion tends to be smaller when the density value is lower. Thus, the density is an index that has an influence on the proportion of the volume that the area in the voxel object occupies in the voxel. The density can also be regarded as an index that indicates the degree of virtual occupation of the content (e.g., the virtual content of the voxel object) in the space of the voxel. For example, when the density is 0, the voxel is empty. When the density is 255, the entire space in the voxel is the content of the voxel object. When the density is a value between 0 and 255, the content of the voxel object occupies the space in the voxel based on (e.g., in a proportion according to) the value. The shape of the mesh, e.g., the surface shape of the voxel object, can be determined based on the density. The mesh can be regarded as the surface of a part, of a voxel, in which the content exists, or as a boundary between a part, of a voxel, in which the content exists and a part, of the voxel, in which the content does not exist. The volume that the area in the voxel object generated based on the density occupies may not necessarily be the volume that exactly matches the proportion indicated by the density. For example, the volume of the voxel object may differ between the method for generating a voxel object as shown in FIG. 9 and the method for generating a voxel object as shown in FIG. 14 even if these methods are based on the same density.

In other examples, the density may indicate either a state in which the volume of the area in the voxel object occupies the entire area in the voxel or a state in which the volume of the area in the voxel object is not included in the area in the voxel. For example, the density data may be data that can take only 0 or 1.

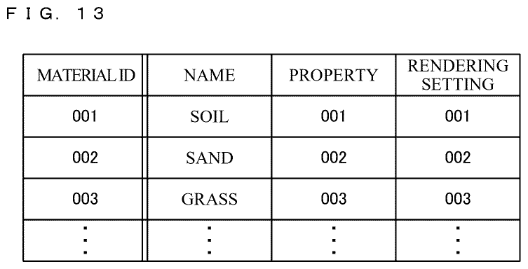

The first material ID and the second material ID are information indicating materials of the corresponding voxel. In the present example, a material such as sand, rock, soil, or gold is set for a voxel. In the game system 1, multiple types of materials are prepared as materials that can be set for voxels (see material data shown in FIG. 13). In the present example, at most two materials out of the prepared multiple types of materials can be set for one voxel. The first material ID is an ID indicating a first material set for the voxel, and the second material ID is an ID indicating a second material set for the voxel. As will be described in detail below, a material of a voxel object (e.g., a material to be set for a polygon of the voxel object) is determined based on the materials set for voxels.

As described above, in the present example, the voxel data includes the ID indicating the material. However, in other examples, the voxel data may have a data structure that includes data directly indicating the details of the material (e.g., information on the name, property, and rendering setting described below).

The material mixing ratio data is an example of data indicating a ratio of materials in the voxel. In the present example, since at most two material IDs are set for one voxel, the material mixing ratio data, which indicates the ratio of one of the material indicated by the first material ID and the material indicated by the second material ID, can also indicate the ratio of the other material. In the present example, it is assumed that the material mixing ratio is a value indicating the ratio of the second material to the entire material consisting of the first material and the second material. The value is 0 or more and 1 or less. For example, if the material mixing ratio set for a certain voxel is 0.4, this indicates that the voxel is composed of the first material and the second material in the ratio of 0.6:0.4. As will be described in detail below, the appearance and property of the voxel object are determined based on the materials. The material mixing ratio is used to determine the appearance and property of the voxel object. In other examples, the material mixing ratio may be a value indicating the proportion of the first material. The ratio of the materials in the voxel may be indicated by the values of the proportions of the materials. In particular, in other examples, if the number of settable types of materials is not limited to two at most and three or more types of materials can be set, the ratio of the materials in the voxel is indicated by a plurality of values respectively indicating the proportions of the materials.

In the present example, two types of materials may not necessarily be set for a voxel, and one type of material may be set. For example, if one type of material is set for a certain voxel, the first material ID indicates this material, and the material mixing ratio is set at 0.

The state data indicates a state that is set for the corresponding voxel. The specific content of state data and the number of types thereof are discretionary. In the present example, the state data includes data indicating the amount of damage set on the voxel. In other examples, the state data may include data indicating whether or not the voxel is wet (and its extent), for example.

As described above, in the present example, since the voxel data includes the material ID, the game system 1 stores therein material data that defines the content of the material indicated by the material ID. FIG. 13 shows an example of the material data. As shown in FIG. 13, in the material data according to the present example, for each material, a material ID is associated with information on a name, a property, and rendering setting that are set for the material.

The name included in the material data is a name (e.g., soil, sand, grass, gold, etc.) set for the material. It should be noted that during the game, the name of the material of the voxel object may be displayed. In order to perform such a display, the material data includes information on the name of the material.

The property included in the material data is a property set for the material. The property of the material is a property that the voxel object, on which the material is set, possesses in the game. The specific content of the property of the material, and the number of types of properties are discretionary. For example, at least one of the following pieces of information may be set as properties of a material.
Hardness
Weight
Slipperiness
Damage setting in the case where the player character comes into contact with the voxel object
Temperature
Whether another object can be bonded to the voxel object
Amount of hit points to be regained by the player character when the player character destroys or acquires the voxel object
Amount of in-game currency to be gained by the player character when the player character destroys or acquires a voxel object

In other examples, information different from those listed above may be set as information indicating a property of a material.

In the present example, the material data includes, as information that identifies a property of a material, an ID indicating the property (see FIG. 13). Although not shown in FIG. 13, the game system 1 stores, for each property to be prepared, property information in which the property ID is associated with the content of the property (e.g., a value indicating the aforementioned weight or slipperiness). By referring to the property information, the game system 1 can specify the specific content of the property set for the material.

The rendering setting included in the material data is information that indicates setting regarding rendering, such as a texture used for rendering of the voxel object for which the material is set. In the present example, the material data includes, as information on rendering setting, an ID of a texture to be used for rendering the voxel object for which the material is set (see FIG. 13). Although not shown in FIG. 13, the game system 1 stores, for each texture prepared, texture information in which the texture ID is associated with the texture indicated by the texture ID. By referring to the texture information, the game system 1 can specify the specific content of the texture set for the material. In other examples, as information on rendering setting, any information regarding setting of shading may be set in addition to the texture information. For example, information regarding reflectivity, normal, or the like may be set.

The material data may include data other than the data shown in FIG. 13. For example, the material data may include data regarding sound setting. For example, the data regarding the sound setting may be data that defines the sound of footsteps that is outputted when the player character walks on the voxel object based on the voxel.

The material data may be data of any form capable of specifying the property and/or rendering setting of the material. For example, in other examples, the material data may have a data structure including data that directly indicates the property and/or rendering setting of the material, instead of the data structure including the material ID and the texture ID.

### 2-2. Update of Voxel Data

During the game, the voxel object is deformed when the voxel data is updated. In the present example, when a game event for updating the voxel object (hereinafter referred to as “update event”) has occurred, the game system 1 updates the voxel data. The update event may have any content. For example, the update event may be that a character that appears in the game has performed an action to deform the voxel object (e.g., the player character has punched the voxel object), or may be that an event that deforms the voxel object has occurred (e.g., contact of an object thrown by a character with the voxel object, or explosion of a bomb).

FIG. 14 shows an example of a game space when an update event has occurred. In the situation shown in FIG. 14, a first player character 201 has performed a punching action to a terrain object 202 that is a voxel object. As will be described in detail below, in the example shown in FIG. 14, the voxel data is updated such that the terrain object 202 at and around a position hit by the punching action of the first player character 201 is deleted. This represents how the terrain object 202 is destroyed by the punching action of the first player character 201.

In the present example, when such an update event has occurred, the game system 1 sets, in the game space, an update range in which the voxel object is updated (in the example shown in FIG. 14, an update range 203). The position, shape, and size of the update range are discretionary. The position of the update range may be determined based on, for example, a position at which an object regarding the generated update event (e.g., the player character that has punched) comes into contact with the voxel object. In the example shown in FIG. 14, the position of the update range 203 may be determined based on a position that is hit by the punch of the first player character 201. For example, the hit position, or a position a predetermined distance ahead of the hit position may be a center position of the update range 203. The shape and size of the update range may be determined in advance according to the type of the update event. For example, when an update event due to a punch of the first player character 201 has occurred, the shape and size of the update range may be determined to be a sphere having a predetermined size as shown in FIG. 14. The size of the update range may be determined based on a value indicating the degree of influence of the generated update event (e.g., the intensity of the punch, or the magnitude of the explosion).

The game system 1 changes the density of a voxel corresponding to the set update range. The voxel corresponding to the update range is, for example, a voxel within the update range or a voxels overlapping the update range. As a result of the change in the density, the mesh of the voxel object is changed by a process described below, thereby changing the shape of the voxel object (the shape by appearance, and the shape used for contact determination). In other examples, in addition to changing the density of the voxel included in the update range, the game system 1 may change the material in the voxel (e.g., the first material, the second material, and the material mixing ratio), or may change the state in the voxel.

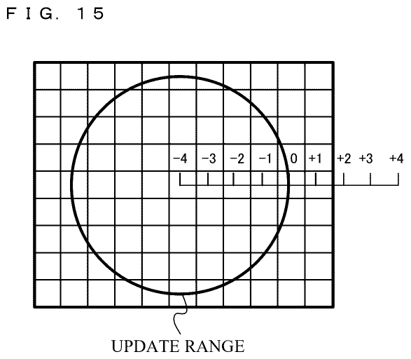

In the present example, the game system 1 determines whether or not a voxel is included in the update range, by using an SDF (Signed Distance Field). The game system 1 sets an SDF indicating an update range set in the game space, and performs the aforementioned determination based on the value of the SDF. The SDF represents distances, with signs, of any positions from a shape that the SDF defines. FIG. 15 shows an example of the update range. In the example shown in FIG. 15, a spherical update range is set in the game space. For example, in the example shown in FIG. 15, an SDF is set such that, among positions in the game space, positions inside the shape represented by the SDF have negative SDF values, and positions outside the shape represented by the SDF have positive SDF values. In this example, whether or not each position is included in the update range can be determined depending on whether or not the SDF value is positive or negative. In addition, using the SDF values allows not only simple inside/outside determination but also a process such as correction or interpolation.

In the example described above, a change in which the voxel object in the update range is deformed as if it is deleted, is applied to the voxel object. However, a change to be applied to the voxel object by using the update range is not limited thereto. For example, a change in which a voxel object is newly added in the update range (e.g., the volume that an area in the voxel object occupies is increased by the update range) may be applied to the voxel object. A change in which only the voxel material in the update range is changed while the voxel density is not changed, may be applied to the voxel object. A change in the voxel density and a change in the voxel material may be integrally applied.

### 2-3. Calculation of Vertices

When the voxel density has been updated as described above, the game system 1 sets vertices based on the updated voxel data. The vertices can be vertices of a mesh of a voxel object. As will be described in detail below, in the present example, the vertices are simplified, and the simplified vertices become the vertices of the mesh of the voxel object.

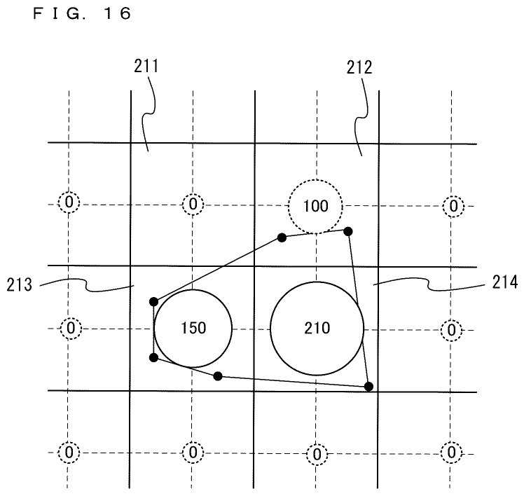

FIG. 16 shows an example of a method for setting vertices. In FIGS. 16 to 25, voxels, vertices, meshes, etc., are represented in two dimensions for the purpose of making the drawings easily viewable, and the description easily understandable. However, in actuality, vertices and meshes are set in a three-dimensional space, based on voxels in the three-dimensional space. In the present example, the game system 1 executes a method in which, for a portion where a voxel having a density that is set to a value indicating “existence” (e.g., a density equal to or greater than a reference value described below) is adjacent to a voxel having a density that is set to a value indicating “nonexistence” (e.g., a density less than the reference value described below), a vertex is set at coordinates based on the positions and densities of a plurality of neighboring voxels around the portion. Hereinafter, this method will be described in detail.

As described above, in the present example, the density set for a voxel is in the range of 0 to 255. A voxel having a density of 0 is completely empty, and a voxel having a density of 255 is completely filled up. Densities between 0 and 255 are complementarily treated, and are used for determining a vertex. In the present example, voxels are virtually treated such that voxels whose densities are equal to or greater than a reference value are inside a voxel object, and voxels whose densities are less than the reference value are outside the voxel object. It is also possible to virtually treat voxels such that voxels whose densities are equal to or greater than the reference value are voxels indicating “existence”, and voxels whose densities are less than the reference value are voxels indicating “nonexistence”. It is not necessary to define only voxels having a density of 0 as being outside the voxel object (e.g., reference value=1), and the reference value may be set to, for example, 128. In the example shown in FIG. 16, a voxel 211 and the other outer voxels have a density of 0, a voxel 212 has a density of 100 which is less than the reference value (e.g., 128), and voxels 213, 214 respectively have densities of 150, 210 which are greater than the reference value. In the present example, the game system 1 generates vertices between the voxels whose densities are equal to or greater than the reference value and the voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. The coordinates of each vertex are determined by comparing the densities of adjacent voxels and performing interpolation based on the difference in density for each of the XYZ axes. Normal information that defines positions and directions of straight lines connecting the vertices may be set in advance, whereby the coordinates of each vertex can be calculated based on the normal information. The normal information may be stored in advance for at least some of the voxels, or if not stored, the normal information may also be calculated based on the densities between adjacent voxels. In FIG. 16, since the density of the voxel 212 is less than the reference value, the voxel 212 is treated as being outside the voxel object in the determination of presence/absence of a vertex, but the density value itself of the voxel 212 is used to calculate the coordinates of the vertices to be generated. If the reference value is set to a value lower than the density of the voxel 212, it would result in an increase in the vertices on the upper right side and the upper left side in the voxel 212 shown in FIG. 16.

By setting the vertices as described above, it is possible to generate a shape whose volume is based on (e.g., reflects) the density of each voxel to some extent, in generating a mesh connecting the set vertices (or vertices obtained by subjecting the set vertices to a simplification process described below). However, depending on the relationship with the neighboring voxels, a voxel having a density of 0 may partially include a region inside the voxel object, or a voxel having a density of 255 may partially include a region outside the voxel object. In the present example, since voxels having densities less than the reference value are treated as being outside the voxel object, there are fewer vertices as compared with a case where those voxels are treated as being inside the voxel object, and the volume will be smaller accordingly. That is, there is no need to calculate the polygon mesh so that the volume strictly corresponds to the density value.

### 2-4. Determination of Material of Vertex

The game system 1 determines a material for each of the vertices set as described above. The material of the vertex is determined based on materials regarding voxels around this vertex. The voxels around the vertex are, for example, voxels used for determining whether or not to generate the vertex (e.g., voxels overlapping the aforementioned region that straddles voxels). In other examples, the voxels used for determining the material of the vertex and the voxels used for determining generation of the vertex may not necessarily be the same, and may be different from each other.

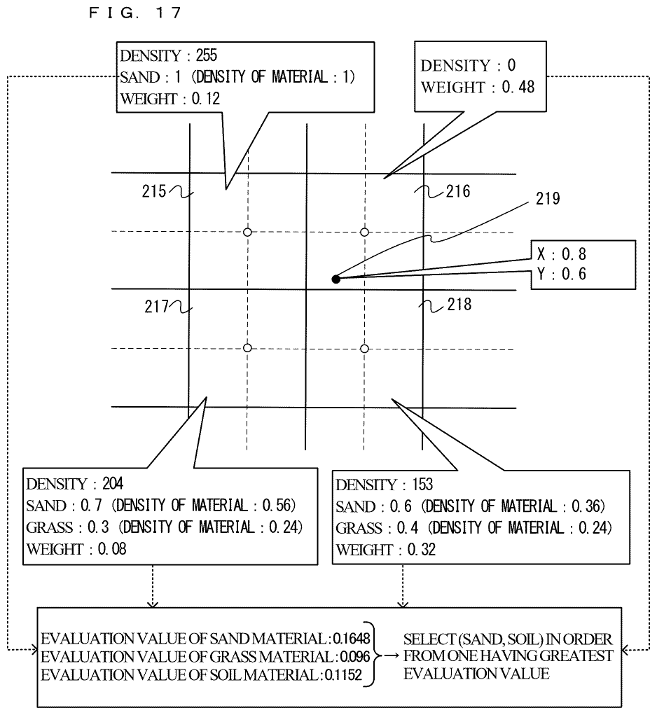

FIG. 17 shows an example of a method for determining a material of a vertex. In the example shown in FIG. 17, a vertex 219 is set with respect to four voxels 215 to 218, and the four voxels 215 to 218 correspond to the aforementioned “voxels around the vertex”. In an actual three-dimensional space, the number of voxels around the vertex is eight. In the example shown in FIG. 17, as for the voxel 215, a density of 255, a first material of “sand”, and a material mixing ratio of 0 (e.g., first material: second material=1:0, or the second material may not necessarily be set) are set. As for the voxel 216, a density of 0 is set (the first and second materials may not necessarily be set). As for the voxel 217, a density of 204, a first material of “sand”, a second material of “grass”, and a material mixing ratio of 0.3 (e.g., first material: second material=0.7:0.3) are set. As for the voxel 218, a density of 153, a first material of “soil”, a second material of “grass”, and a material mixing ratio of 0.4 (e.g., first material: second material=0.6:0.4) are set. In addition, the coordinates indicating the position of the vertex 219 are (X, Y)=(0.8, 0.6). A coordinate system for the coordinates has an X coordinate in the left-right direction and a Y coordinate in the up-down direction, in FIG. 17. In the coordinate system, among center positions of the voxels 215 to 218 (positions of white circles in FIG. 14), the center position of the lower-left voxel 217 is (0, 0).

In determining a material of the vertex, the game system 1 calculates an evaluation value for each of the materials of the neighboring voxels, based on the density of the material, and a weight value based on the distance from the voxel to the vertex. First, the weight value is calculated for each voxel. The shorter the distance from the center position of the voxel to the vertex is, the greater the weight value is. In the present example, assuming that the center position of a certain voxel is (x1, y1) and the coordinates of the vertex are (x2, y2), a weight value for the voxel is calculated according to the following formula (1).

$$( weight value ) = \vert ( 1 - x 1 ) - x 2 \vert \cdot \vert ( 1 - y 1 ) - y 2 \vert \qquad ( 1 )$$

In the example shown in FIG. 17, the weight values of the voxels 215 to 218 calculated according to the formula (1) are as follows.

$$\begin{matrix}( weight value of voxel 215 ) = \vert ( 1 - 0 ) - 0.8 \vert \cdot \vert ( 1 - 1 ) - 0.6 \vert = 0. 12 \\ ( weight value of voxel 216 ) = \vert ( 1 - 1 ) - 0.8 \vert \cdot \vert ( 1 - 1 ) - 0.6 \vert = 0.48 \\ ( weight value of voxel 217 ) = \vert ( 1 - 0 ) - 0.8 \vert \cdot \vert ( 1 - 0 ) - 0.6 \vert = 0.08 \\ ( weight value of voxel 218 ) = \vert ( 1 - 1 ) - 0.8 \vert \cdot \vert ( 1 - 0 ) - 0.6 \vert = 0. 32\end{matrix}$$

The game system 1 calculates a density of a material for each voxel. Here, the density of the material is a value obtained by multiplying the proportion of this material, among materials set for the voxel, by the density of the voxel. In the present example, for the densities of the voxels, values obtained by normalizing the aforementioned values from 0 to 255 to values from 0 to 1 are used. In the example shown in FIG. 17, as for the voxel 215, since the material set for this voxel is only sand, the proportion regarding the sand material is 1, and the density of the voxel is 1, and therefore, the density of the sand material is 1. As for the voxel 216, since the density is 0 and no material is set, a material density is not calculated. If any material is set, the density of this material is 0. As for the voxel 217, the proportions of the sand material and the grass material being set are 0.7 and 0.3, respectively, and the density of the voxel is 204/255=0.8. Therefore, the density of the sand material is 0.7·0.8=0.56, and the density of the grass material is 0.3·0.8=0.24. As for the voxel 218, the proportions of the soil material and the grass material being set are 0.6 and 0.4, respectively, and the density of the voxel is 153/255=0.6. Therefore, the density of the soil material is 0.6·0.6=0.36, and the density of the grass material is 0.4·0.6=0.24.

Then, the game system 1 calculates the evaluation value for each material, based on the weight value and the density of the material. In the present example, the evaluation value of the material is a value obtained by weighting the density of the material calculated for each voxel, according to the weight value of the voxel, and summing up the weighted densities of the neighboring voxels. In the example shown in FIG. 17, the evaluation value of the sand material is 1·0.12+0.56·0.08=0.1648 because the density of the material is 1 and the weight value is 0.12 for the voxel 215, and the density of the material is 0.56 and the weight value is 0.08 for the voxel 217. The evaluation value of the grass material is 0.24·0.08+0.24·0.32=0.096 because the density of the material is 0.24 and the weight value is 0.08 for the voxel 217, and the density of the material is 0.24 and the weight value is 0.32 for the voxel 218. The evaluation value of the soil material is 0.36·0.32=0.1152 because the density of the material is 0.36 and the weight value is 0.32 for the voxel 218.

The game system 1 determines a material of the vertex, based on the evaluation values of the respective materials. Specifically, a predetermined number of materials in order from one having the greater evaluation value are determined as materials of the vertex. In the present example, two materials having the first and second greatest evaluation values are determined as materials of the vertex. In the example shown in FIG. 17, since the evaluation values of the sand, grass, and soil materials are 0.1648, 0.096, and 0.1152, respectively, the sand material and the soil material are determined as the materials of the vertex. Furthermore, the game system 1 calculates the ratio of the determined two materials, based on the evaluation values described above. In the present example, the ratio of the two materials may be represented as a second material ratio that is a ratio of the second material to the whole, like the aforementioned material mixing ratio. In the example shown in FIG. 17, for example, if the first material and the second material are set to soil and sand, respectively, the second material ratio is represented as 0.1648/(0.1648+0.1152)≈0.59. In other examples, as a value representing the ratio of the two materials, a value representing the proportion of the first material may be used. Alternatively, values representing the proportions of the respective materials may be used.

In the present example, the game system 1 generates and stores therein vertex data indicating the position of a vertex, material IDs of the first and second materials set for the vertex, and the ratio of the materials. However, the method for managing materials set for a vertex is discretionary. In other examples, the vertex data may have a data structure including data that directly indicates the contents of the first and second materials.

As described above, in the present example, regarding material IDs included in voxel data of a plurality of neighboring voxels around each vertex, the game system 1 calculates a priority parameter (e.g., evaluation value) for each material ID, based on the voxel data. Then, based on the priority parameters, the game system 1 selects a predetermined number of (here, two) material IDs having the higher priorities, and determines the selected materials IDs as material IDs for the vertex. The specific parameter to be used as the priority parameter is not limited to the evaluation value. For example, in other examples, an evaluation value that is calculated using the density of the material without using the weight value may be used as a priority parameter.

In the present example, the evaluation value as an example of the priority parameter is calculated based on the densities of the plurality of neighboring voxels around the vertex such that the material set for the voxel having the higher density has the higher priority (e.g., the evaluation value of the material is increased and thereby the material is highly likely to be selected). Thus, the material of the vertex can be determined while also incorporating (e.g., reflecting) the magnitude of the density set for the voxel.

In the present example, the evaluation value as an example of the priority parameter is calculated based on the distances from reference positions (specifically, center positions) of a plurality of neighboring voxels around the vertex, to the vertex such that the material set for the voxel closer to the vertex has the higher priority. Thus, the material of the vertex can be determined while also incorporating (e.g., reflecting) the distances between the voxels and the vertex.

In the present example, it can also be said that the evaluation value as an example of the priority parameter is calculated based on the material mixing ratios of a plurality of neighboring voxels around the vertex such that the material having the higher material mixing ratio has the higher priority. Thus, in the case where a plurality of materials are set for one voxel, the material of the vertex can be determined while also incorporating (e.g., reflecting) the ratio of the materials.

### 2-5. Simplification of Vertices

In the present example, the game system 1 simplifies the vertices calculated as described above. That is, the game system 1 replaces some of the vertices calculated as described above with one vertex to decrease the number of vertices. As will be described in detail below, the coordinates (e.g., position) and the material of the replacing vertex are set based on a plurality of vertices before replacement. Such simplification can reduce the numbers of vertices and polygons that form a mesh of a voxel object, thereby reducing the amount of memory used for processing, and reducing the processing load.

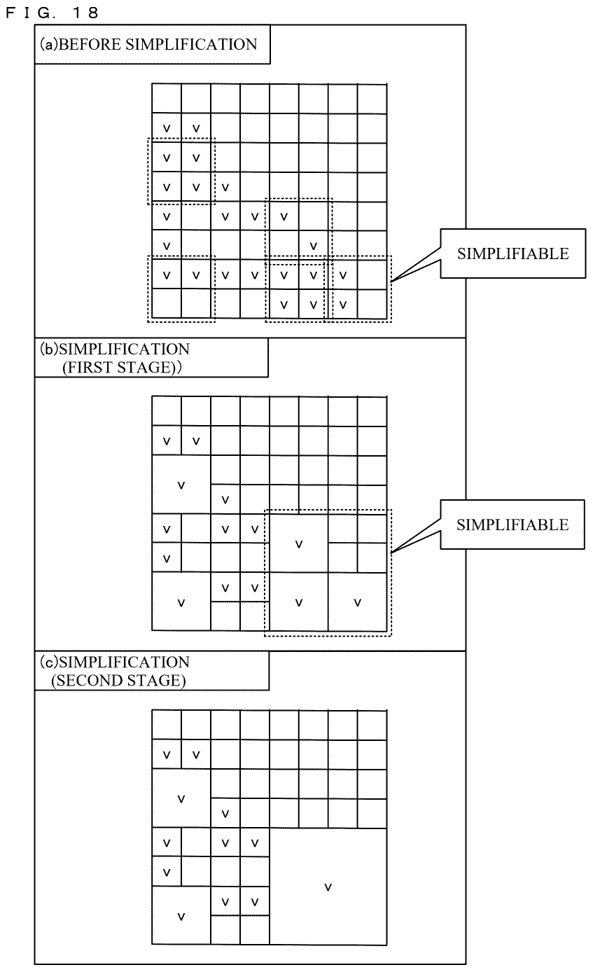

In the present example, the game system 1 performs simplification by representing vertices using SVO (Sparse Voxel Octree). FIG. 18 shows an example of vertex simplification. In FIG. 18, one square delimited by solid lines in (a) represents one vertex division region. Here, the vertex division region is a square region with a center position of a voxel being a vertex (in an actual three-dimensional space, the vertex division region is a cube or a rectangular parallelepiped), and corresponds to a region with the dotted lines being sides shown in FIG. 16 and FIG. 17. In FIG. 18, each vertex division region having a character “v” inside is a vertex division region in which a vertex is set.

In the present example, the game system 1 determines whether or not simplification can be performed with respect to the vertices in a predetermined number of (four in FIG. 18, and eight in an actual three-dimensional space) vertex division regions adjacent to each other. If the determination result is that simplification can be performed, simplification is performed for the vertices in the predetermined number of vertex division regions.

In FIG. 18, (a) shows the state before simplification is performed. In the example shown in FIG. 18, it is determined that simplification can be performed for vertex division regions within a range surrounded by dotted lines. In this case, the game system 1 performs simplification such that the vertices in the predetermined number of vertex division regions determined to be simplified are replaced with one vertex (see (b) shown in FIG. 18). Thus, the vertices in the predetermined number of vertex division regions are simplified to one vertex.

In the present example, the game system 1 performs simplification in a plurality of stages. The number of the stages is discretionary. In FIG. 18, first and second stages are shown and described. In FIG. 18, (b) shows the state in which the first-stage simplification has been performed, and (c) shows the state in which the second-stage simplification has been performed. In the second-stage simplification, whether or not simplification can be performed is determined for vertices that are generated by the first-stage simplification. In the example shown in FIG. 18, when the determination result is that the vertex division regions within a range surrounded by dotted lines in (b) shown in FIG. 18 can be subjected to simplification, the vertices in the vertex division regions are simplified, resulting in the state shown in (c) of FIG. 18. The condition for determining whether or not the first-stage simplification can be performed and the condition for determining whether or not the second-stage simplification can be performed may be the same or different from each other.

The specific method for determining whether or not simplification can be performed is discretionary. In the present example, as conditions for the above determination, a condition regarding the shape of the voxel object and a condition regarding the material of the voxel object are used. In the present example, if both the condition regarding the shape of the voxel object and the condition regarding the material of the voxel object are satisfied, it is determined that simplification can be performed. If at least one of the condition regarding the shape of the voxel object and the condition regarding the material of the voxel object is not satisfied, it is determined that simplification cannot be performed.

The condition regarding the shape is, for example, that there is no significant change between the shape due to the vertices before the simplification and the shape due to the vertices after the simplification. For example, determination as to whether or not there is a significant change in the shape due to the vertices before and after the simplification may be performed by calculating an index indicating an error between the mesh before the simplification and the mesh after the simplification, and determining whether or not the index is equal to or smaller than a predetermined allowable value. Furthermore, for example, if the shape due to the vertices after the simplification is not a hollow shape while the shape due to the vertices before the simplification is a hollow shape (e.g., the simplification causes missing of information that the shape is hollow), it is determined that the condition regarding the shape is not satisfied. Whether or not the aforementioned case will occur can be determined based on, for example, the densities of voxels corresponding to the vertex division regions to be subjected to the determination. Moreover, for example, if the shape due to the vertices before the simplification can be represented only by two or more vertices, e.g. it cannot be represented by one vertex, it is determined that the condition regarding the shape is not satisfied. As the condition regarding the shape of the voxel object, the same condition as that used for the conventional method with the SVO may be used.

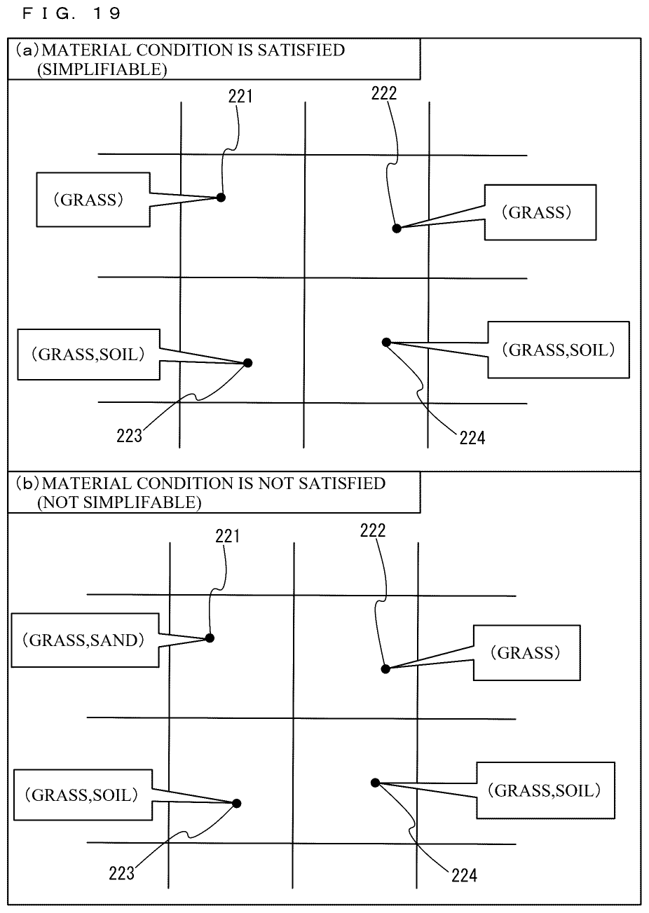

In the present example, as the condition regarding the material, a condition regarding the number of types of materials to be set for the vertices in the predetermined number of vertex division regions to be subjected to simplification, is used. FIG. 19 shows an example of the condition regarding the material. In FIG. 19, (a) shows a case where the materials of vertices 221 to 224 are “grass”, “grass”, “grass and soil”, and “grass and soil”, respectively, and (b) shows a case where the materials of the vertices 221 to 224 are “grass and sand”, “grass”, “grass and soil”, and “grass and soil”, respectively. In the present example, the condition regarding the material is that the total number of the types of materials set for the vertices to be subjected to simplification is equal to or less than a predetermined number. For example, the condition regarding the material is that the total number is equal to or less than the number of materials that can be set for one vertex. In the present example, the predetermined number is 2. For example, in the case of (a) shown in FIG. 19, since the total number of the types of materials set for the vertices 221 to 224 to be subjected to simplification is 2 (e.g., grass and soil), the condition regarding the material is satisfied. In this case, it is determined that the vertices 221 to 224 can be subjected to simplification on the condition that the aforementioned condition regarding the shape of the object is satisfied. On the other hand, in the case of (b) shown in FIG. 19, since the total number of the types of materials set for the vertices 221 to 224 to be subjected to simplification is 3 (e.g., grass, soil, and sand), the condition regarding the material is not satisfied. In this case, it is determined that the vertices 221 to 224 cannot be subjected to simplification regardless of whether or not the condition regarding the shape of the object is satisfied.

In the game system 1, multiple types of materials to which the same property is set and which are different in appearance may be prepared even though these materials should strictly be classified into different types. Some of the multiple types of materials may be regarded as being of the same type in determining whether the condition regarding the material is satisfied. For example, multiple types of soil materials having the same property and similar appearances (e.g., texture colors or patterns) may be prepared. In this case, the game system 1 may determine whether the condition regarding the material is satisfied while regarding the multiple types of soils as being of the same type.

In the present example, at most two types of materials can be set for a vertex as in the case of a voxel. Meanwhile, in the present example, if the total number of the types of materials set for the vertices to be subjected to simplification is three or more, simplification is not performed. That is, if the total number of the types of materials exceeds the number of materials that can be set for one vertex, simplification is not performed. Therefore, even when the number of vertices is reduced through simplification, the simplification does not cause missing of information on the materials set for the vertices, thereby maintaining the information on the materials.

In the present example, a material of the vertex after the simplification is determined based on the materials of the vertices before the simplification. Specifically, the game system 1 sets the one or two types of materials set on the vertices before the simplification, as the first material and the second material of the vertex after the simplification. This allows the information on the materials to be maintained. The ratio of the materials after the simplification is determined based on the ratio of the materials of the vertices before the simplification. In the present example, the radio of the materials after the simplification is calculated similarly to the aforementioned method for calculating the ratio of materials of vertices by using the evaluation values. That is, the game system 1 calculates weight values based on the distances between the vertex after the simplification and the vertices before the simplification, and calculates an evaluation value for each material, based on the weight values and the densities of the materials of the vertices before the simplification (the evaluation values of the materials described in [2-4. Determination of material of vertex] can be used as the densities of the materials here). Then, the ratio of the materials is calculated based on the calculated evaluation values of the materials.

### 2-6. Generation of Mesh

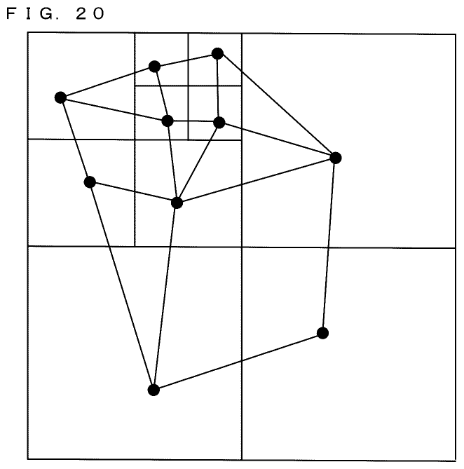

In the present example, a mesh of a voxel object is generated based on vertices having been simplified as described above. FIG. 20 shows an example of a mesh generated based on such vertices. Each of squares shown in FIG. 20 represents a vertex division region as described above, or a vertex division region obtained by integrating a plurality of vertex division regions through simplification. As shown in FIG. 20, the game system 1 generates a mesh that is composed of polygonal shapes each having, as one side, a straight line connecting vertices of adjacent vertex division regions. Each of the polygonal shapes forming the mesh is a triangle or a quadrangle.

In the present example, the game system 1 generates two types of meshes—e.g., a display mesh and a determination mesh. The display mesh is a mesh used for displaying a voxel object. The determination mesh is a mesh used for collision determination for a voxel object. As will be described in detail below, by using the two types of meshes, the game system 1 can perform processing with the meshes suitable for display of the voxel object and collision determination, respectively.

In the present example, the game system 1 generates the display mesh and the determination mesh, based on data of the SVO described above (e.g., based on the simplified vertices). Thus, sharing vertex data in generating the two types of meshes improves efficiency of processing. In other examples, the game system 1 may not necessarily perform simplification of vertices, and may generate a display mesh and/or a determination mesh, based on vertices that are not simplified.

In the present example, the game system 1 generates the determination mesh so as to be simpler in shape than the display mesh. Specifically, the game system 1 makes the number of vertices of the determination mesh less than the number of vertices of the display mesh. Here, in the present example, the data of the SVO holds, in an octree data structure, data of vertices before simplification and data of simplified vertices, and also includes data used for determining whether or not simplification can be performed. This data includes, for example, data of vertices (referred to as “provisional vertices”) calculated as candidates for a vertex after simplification, and data of the aforementioned index indicating an error between the vertices before simplification and the provisional vertices. For example, the game system 1 may use, among the provisional vertices, a vertex the index of which is equal to or less than a predetermined threshold value (this threshold value is greater than the aforementioned allowable value), for generation of the determination mesh. This allows the number of vertices of the determination mesh to be less than the number of vertices of the display mesh. The number of vertices of the determination mesh being less than the number of vertices of the display mesh allows a reduction in processing load for collision determination. Moreover, since the number of vertices of the display mesh is not excessively reduced, the appearance of the voxel object can be represented in detail.

In other examples, the display mesh and the determination mesh may be generated based on the same data, or may be generated based on different data. The display mesh and the determination mesh may have the same shape (even in this case, materials set for these meshes may be different from each other). The number of vertices of the determination mesh may be equal to the number of vertices of the display mesh, or may be greater than the number of vertices of the display mesh.

### 2-6-1. Determination of Material of Display Mesh

Next, an example of a method for determining materials and an appearance of a display mesh will be described. In the present example, the game system 1 determines a material for each of the polygonal shapes forming the display mesh. As will be described in detail below, in the present example, a polygon corresponding to each polygonal shape is rendered using at most two types of textures corresponding to at most two types of materials. Therefore, the game system 1 determines materials for the polygonal shapes forming the mesh such that two or less types of materials are finally set for one polygonal shape. In other examples, three or more materials may be set. For example, in an example in which three or more types of voxel materials and three or more types of vertex materials are set, the same number of materials may be set for the polygonal shapes.

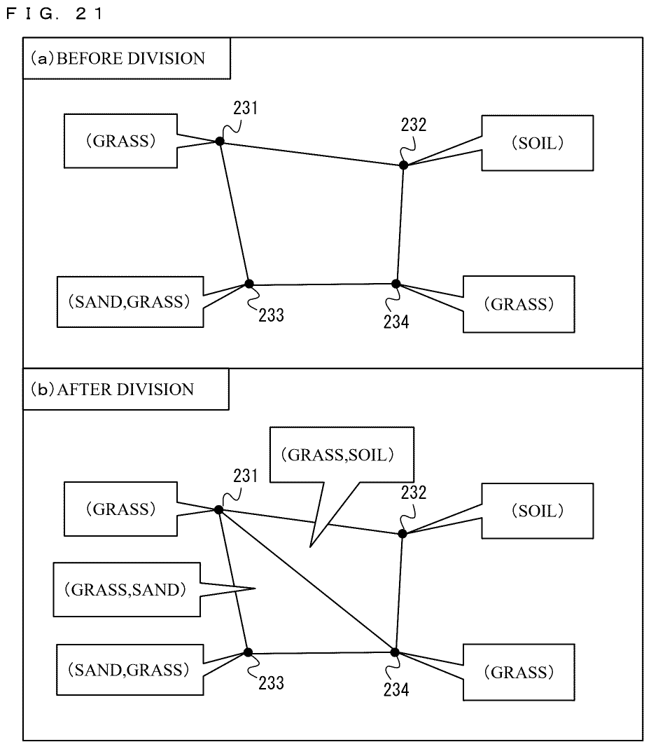

In the present example, quadrangles may be formed as polygonal shapes forming the display mesh (see FIG. 20). In determining materials of the display mesh, the game system 1 firstly divides each of the quadrangles forming the display mesh into two triangles under certain conditions. Hereinafter, a process of dividing a quadrangle into two triangles will be described with reference to FIG. 21.

FIG. 21 shows an example of dividing a quadrangle forming a mesh into two triangles. In FIG. 21, (a) shows a quadrangle before division, formed by vertices 231 to 234 included in the vertices of the mesh. In FIG. 21, (b) shows two triangles into which the quadrangle is divided. In the example shown in FIG. 21, “grass”, “soil”, “sand and grass”, and “grass” are set as materials of the respective vertices 231 to 234.

In the present example, if the number of types of materials set for the vertices of the quadrangle is three or more in total, the game system 1 determines whether or not a division condition is satisfied. In the present example, the division condition is that dividing the quadrangle into two triangles allows the number of types of materials set for the vertices of each triangle to be two or less in total. If the division condition is satisfied, the game system 1 divides the quadrangle into two triangles each having two or less types of materials set for the vertices. In the example shown in FIG. 21, three types of example materials, grass, soil, and sand, are set for the vertices 231 to 234 forming the quadrangle. If the quadrangle is divided into a triangle formed by the vertices 231, 232, 234 and a triangle formed by the vertices 231, 233, 234, two types of materials, sand and grass, are set for the vertices of the former triangle, and two types of materials, grass and soil, are set for the vertices of the latter triangle (see (b) shown in FIG. 21). Since the division condition is satisfied for the quadrangle, the game system 1 divides the quadrangle into two triangles.

Since there are two methods for dividing a quadrangle into two triangles, if the division condition is satisfied for the triangles into which the quadrangle is divided by at least one of the two methods, the game system 1 performs the division by the method satisfying the division condition. Meanwhile, if the division condition is not satisfied for the triangles into which the quadrangle is divided by either of the two methods, the game system 1 performs the division by either method.

By performing the division as described above, the game system 1 can generate two triangles each having two or less types of materials set for the vertices, without missing information on three or more types of materials set for the vertices of the quadrangle as much as possible. Here, as described above, each of the polygons forming the mesh is rendered using at most two types of textures. Therefore, by performing the division, the game system 1 can render each polygon by using two types of textures without missing information on the materials set for the vertices as much as possible.

In the present example, the game system 1 sets polygons corresponding to the polygonal shapes obtained through the aforementioned division. That is, the vertices of the polygonal shapes obtained through the division become the vertices of the polygons of the display mesh.

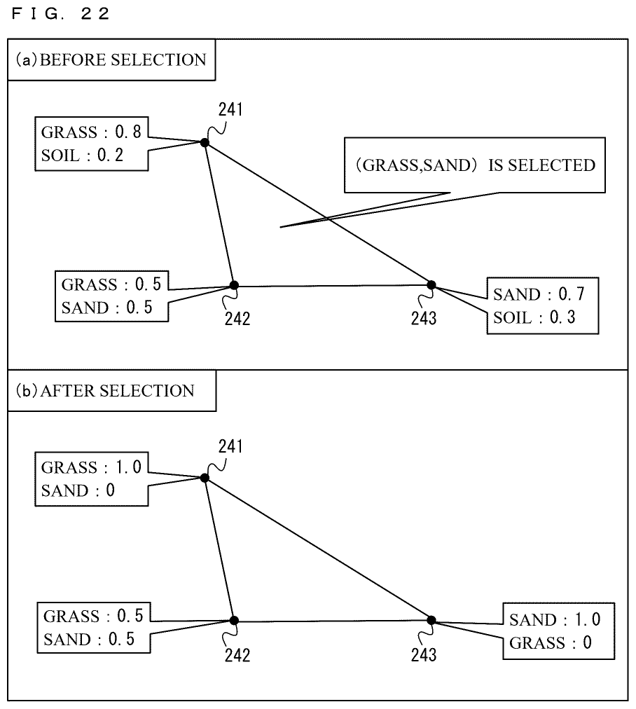

In the present example, as for the polygons forming the display mesh, if the number of types of materials set for the vertices of one polygon is three or more in total, the game system 1 selects two types of materials to determine materials of this polygon. FIG. 22 shows an example of a method for determining materials of a polygon forming the display mesh. In the example shown in FIG. 22, as for a vertex 241 of a triangular polygon forming the display mesh, the first material is “grass”, the second material is “soil”, and the material ratio of the first material to the second material is 0.8:0.2. As for a vertex 242 of the polygon, the first material is “grass”, the second material is “sand”, and the material ratio of the first material to the second material is 0.5:0.5. As for a vertex 243 of the polygon, the first material is “sand”, the second material is “soil”, and the material ratio of the first material to the second material is 0.7:0.3.

If the number of types of materials set for the vertices of the polygon is three or more in total, the game system 1 calculates a determination value for each material. The determination value is calculated as a sum of the proportions of the material at the vertices on which the material is set. Then, the game system 1 selects two materials in order from one having the greatest determination value, as materials of the polygon. In the example shown in FIG. 22, the determination value of the grass material is 0.8+0.5=1.3, the determination value of the sand material is 0.5+0.7=1.2, and the determination value of the soil material is 0.2+0.3=0.5. Therefore, the grass material and the sand material are selected as materials of the polygon shown in FIG. 22 (see (a) shown in FIG. 22).

The specific method for selecting a material of a polygon of the display mesh is discretionary. In other examples, a material of a polygon of the display mesh may be selected by any method based on information set for the vertices of the polygon. For example, a material of a polygon of the display mesh may be selected as follows. That is, a material having the greatest proportion at one vertex is specified for each vertex, and a material that is most frequently specified for each vertex is selected as a material of the polygon.

In the present example, the selected materials of the polygon are indicated as materials set for the vertices of the polygon. That is, when the materials of the polygon have been selected, the game system 1 changes the materials being set for the vertices of the polygon (e.g., the material IDs included in the vertex data) to the selected materials. In the example shown in FIG. 22, as for the vertex 241 and the vertex 243, “grass and soil” and “sand and soil” are respectively set before the selection of materials of the polygon (see (a) shown in FIG. 22). When grass and sand have been selected as materials of the polygon as described above, the materials set for the vertex 241 and the vertex 243 are changed to “grass and sand” (see (b) shown in FIG. 22). Since the materials set for the vertex 242 before the selection are the same as the selected materials of the polygon, the materials are not changed. In the case where two types of materials are selected as materials of the polygon as described above, information on the third and subsequent types of materials set for the vertices of the polygon are deleted.

According to the change of the materials set for each vertex, the game system 1 changes the ratio of the materials set for the vertex. For example, as for the vertex 241, the content indicating that the first material is grass and the second material is soil is changed to the content indicating that the first material is grass and the second material is sand. Here, since the proportion of the sand material is 0, the material ratio of the first material to the second material becomes 1:0. Thus, the above change is formally changing the materials of the vertices of the polygon in order to represent the materials of the polygon by the materials of the vertices of the polygon.

According to the above, since the materials set for the vertices of one polygon are only the materials corresponding to the textures used for rendering described below, a rendering process using the textures can be easily performed.

There may be a case where the aforementioned change causes all the materials at a certain vertex to be changed (e.g., none of the materials after the change correspond to the materials before the change). For example, there is a case where the material set for the vertex before the change is soil, and the materials selected as materials of the polygon are grass and sand. In this case, the ratio of the materials at the certain vertex may be set based on the material ratios at the other vertices of the polygon. For example, in the above example, in the case where the first material set for one of the remaining two vertices of a triangular polygon is grass and the material ratio of grass to sand is 1:0 while the material set for the other vertex is sand and the material ratio of sand to grass is 1:0, the material ratio at the certain vertex may be set to grass: sand=0.5:0.5. The game system 1 may determine the material ratio at the certain vertex in consideration of the distance between this vertex and the other vertex (e.g., based on a weight value that increases as the distance is shorter).

As described above, in the present example, the game system 1 selects, for each polygon, at most a predetermined number of (here, two) material IDs from among the material IDs set for the vertices included in the polygon (e.g., material IDs set for the vertices of the polygonal shape corresponding to the polygon), and determines the selected material IDs as material IDs of the polygon. Thus, the game system 1 can perform the rendering process with the number of textures to be used being reduced, while incorporating (e.g., reflecting) the materials set for the vertices into the appearance of the polygon.

In the present example, regarding the materials of all the vertices forming a polygon, if the number of the materials is equal to or less than the predetermined number, the game system 1 determines the materials as materials of the polygon. Meanwhile, if the number of the materials exceeds the predetermined number, the game system 1 selects a predetermined number of materials having higher priorities, based on the priority parameters of the vertices (specifically, based on the determination values calculated based on the aforementioned evaluation values), and determines the selected materials as materials of the polygon. Thus, even if the number of the materials set for the vertices exceeds, in total, the predetermined number, the number of the materials of the polygon can be made equal to or less than the predetermined number in consideration of the priority.

As described above, in the present example, the first and second materials set for each of the vertices of one polygon are changed to the two types of materials to be set for the polygon. In performing such a change, as for a vertex shared by adjacent two polygons, there is a possibility of inconsistency in the first and second materials to be set.

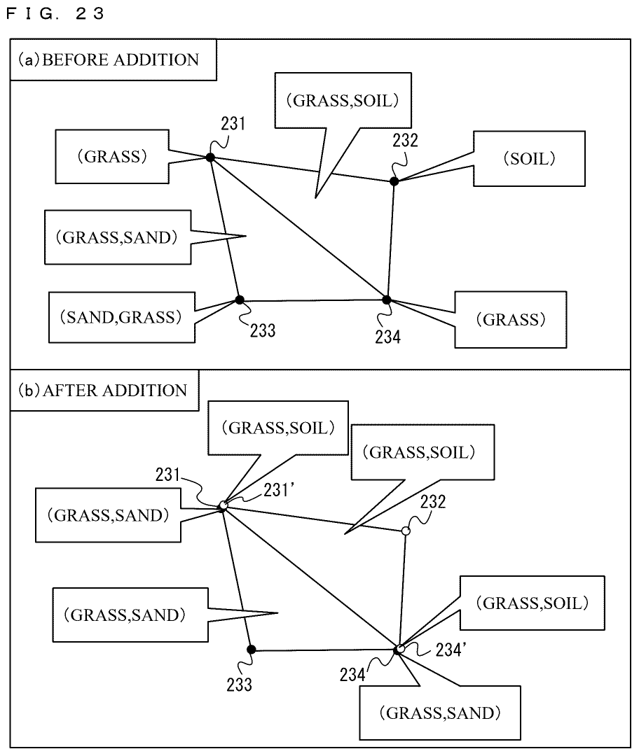

FIG. 23 shows an example of materials set for vertices of adjacent two polygons. FIG. 23 shows a state in which two polygons are formed by the vertices 231 to 234 shown in FIG. 21 ((b) shown in FIG. 21). In the example shown in FIG. 23, since grass and sand are determined as materials of a first polygon formed by the vertices 231, 233, and 234, the first and second materials of these vertices should be set to grass and sand, respectively. Meanwhile, since grass and soil are determined as materials of a second polygon formed by the vertices 231, 232, and 234, the first and second materials of these vertices should be set to grass and soil, respectively. Therefore, in the example shown in FIG. 23, as for the vertices 231 and 234 shared by the two polygons, inconsistency occurs in the materials to be set.

In the present example, when inconsistency occurs in material to be set for a vertex shared by two polygons, the game system 1 adds another vertex at the position of the vertex. In FIG. 23, (b) shows an example of a state in which a vertex 231′ is added for the vertex 231 and a vertex 234′ is added for the vertex 234. In the example shown in FIG. 23, the game system 1 sets, for the vertices 231 and 234, grass and sand as the first and second materials according to the materials of the first polygon. In addition, the game system 1 sets, for the vertices 231′ and 234′, grass and soil as the first and second materials according to the materials of the second polygon. By formally setting two vertices as vertices to be shared by two polygons (e.g., by generating data of two vertices located at the same position and having different materials), it is possible to inhibit occurrence of inconsistency in materials to be set for the vertices.

The game system 1 generates a display mesh composed of the polygons whose vertices and materials are determined as described above. In addition, the game system 1 renders the polygons, based on information on the materials set for the vertices (e.g., the first material and the second material), thereby rendering a voxel object.

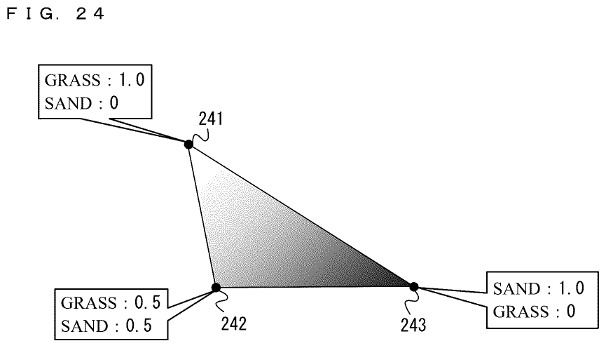

FIG. 24 shows an example of applying a texture to a polygon. FIG. 24 shows a triangular polygon formed by the vertices 241 to 243 shown in FIG. 22. The materials set for the vertices 241 to 243 are those shown in (b) shown in FIG. 22.

As for the position of a vertex of a polygon, rendering is performed by a mapping in which a texture of a first material set for the vertex and a texture of a second material set for the vertex are blended at a ratio of the materials set for the vertex (e.g., using this ratio as a blending ratio). The textures of the first and second materials used for the rendering are textures indicated by information on rendering setting associated with the material ID that is associated with data of the vertex in the aforementioned material data (see FIG. 13). In the example shown in FIG. 24, as for the position of the vertex 241, since the material ratio of grass to sand is 1:0, rendering is performed by using only the texture of grass. As for the position of the vertex 243, since the first material is sand and the material ratio of sand to grass is 1:0, rendering is performed by using only the texture of sand. As for the position of the vertex 242, since the first material is grass, the second material is sand, and the material ratio of grass to sand is 0.5:0.5, rendering is performed such that the texture of grass and the texture of sand are blended at a blending ratio of 0.5:0.5.

As for positions other than the vertices of the polygon, the game system 1 determines a blending ratio by interpolating the blending ratios at the vertices. Then, rendering is performed by a mapping in which the textures of two materials set for each vertex are blended at the interpolated blending ratio. The specific method for interpolation is discretionary. As an example, a blending ratio between vertices is subjected to linear interpolation. In FIG. 24, a position at which the texture of grass material is applied at a high ratio is shown in white, and a position at which the texture of sand material is applied at a high ratio is shown in black. In the example shown in FIG. 24, the texture of grass is applied to the vertex 241, and the blending ratio of the texture of sand increases toward the vertex 243. At the position of the vertex 242, the blending ratio of grass to sand becomes 1:1, and only the texture of sand is applied at the position of the vertex 243. Thus, rendering is performed with the two textures set for the polygon (e.g., set for the vertices of the polygon) being blended with the blending ratio according to the material ratio, whereby the appearance at the boundary between different materials can be made natural in the display mesh. This makes the appearance of the display mesh, in which a plurality of types of materials are set, natural.

### 2-6-2. Determination of Material of Determination Mesh

Next, an example of a method for determining materials of a determination mesh will be described. As will be described in detail below, in the present example, there may be a case where collision determination is performed for a voxel object by using a determination mesh, and processing is performed according to a material of a voxel object for which a collision has been determined. Therefore, in the present example, materials are determined also for the determination mesh.

In the present example, the game system 1 sets polygons corresponding to the polygonal shapes forming the determination mesh such that one type of material is set for one polygon. Specifically, the game system 1 determines a material to be set for a polygon of the determination mesh, based on information on materials set for vertices of this polygon (e.g., information on first and second materials, and a material ratio).

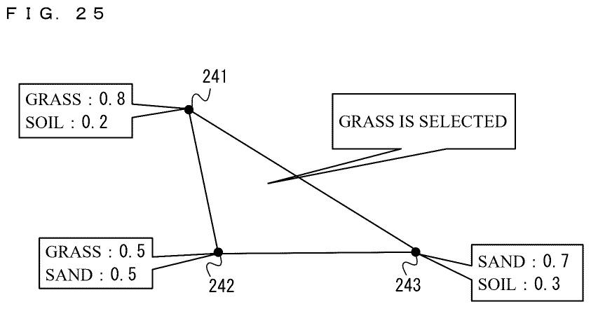

FIG. 25 shows an example of a method for determining a material of a polygon forming the determination mesh. FIG. 25 shows an example of determining a material for a triangular polygon formed by the vertices 241 to 243 shown in FIG. 22. The materials set for the vertices 241 to 243 are those shown in (a) shown in FIG. 22.

In determining a material of a polygon, the game system 1 calculates a determination value for each of materials set for the vertices of the polygon. In the present example, a calculation method for the determination value is identical to the calculation method for the determination value that is used for selection of the materials to be set for the polygonal shapes of the display mesh. The specific calculation method for the determination value is discretionary. In other examples, the determination value may be calculated in any method based on information set for the vertices of the polygon of the determination mesh.

In the example shown in FIG. 25, the determination value for each material is 1.3 for the grass material, 1.2 for the sand material, and 0.5 for the soil material as in the case shown in FIG. 22. Therefore, the grass material is selected as a material of the polygon shown in FIG. 25.

As described above, in the present example, the game system 1 selects, for each polygon, at most a predetermined number of (here, one) material IDs from among the material IDs set for the vertices included in the polygon (e.g., material IDs set for the vertices of the polygonal shape corresponding to the polygon), and determines the selected material ID as a material ID of the polygon. This allows the game system 1 to reduce the number of materials to be set for the determination mesh to the predetermined number or less. Thus, processing based on the material type, which is performed according to the result of collision determination using the determination mesh, is prevented from being complicated. The method for determining a material of a polygon of the determination mesh is discretionary, and is not limited to the above method. In other examples, a material of a polygon of the determination mesh may be determined by any method based on information set for the vertices of the polygon.

In the present example, one type of material is set for a polygon of the determination mesh while at most two types of materials are set for a polygon of the display mesh. Therefore, natural appearance can be achieved for the polygon of the display mesh by using two types of textures. In addition, as for the determination mesh, a process to be performed according to the result of collision determination using the determination mesh can be prevented from being complicated. In other examples, the types of materials settable for polygons of the display mesh and the determination mesh are discretionary. The number of materials settable for a polygon of the display mesh and the number of materials settable for a polygon of the determination mesh each may be plural, and may be the same or different from each other.

In the present example, the number of types of materials to be set for one voxel is two at most, and the number of types of materials to be set for one polygon in the display mesh is two at most. Thus, information on materials set in the voxel data can be used for (e.g., reflected in) the materials of the display mesh while reducing the data amount of the voxel data. Moreover, in the present example, the number of types of materials to be set for vertices based on the voxel data is also two at most (see FIG. 17). In this case, since two types of materials can be set also for vertices that are generated during the process to obtain the display mesh from the voxel data, the information on materials set in the voxel data used for (e.g., reflected in) the display mesh, without missing the information on materials during the process.

In other examples, the game system 1 may set materials such that, regarding vertices to be set based on the voxel data, materials set for vertices to be used for generation of the display mesh are different from materials set for vertices to be used for generation of the determination mesh. For example, the game system 1 may set at most two types of materials as described above for the vertices to be used for generation of the display mesh, and may set one type of material for the vertices to be used for generation of the determination mesh. Then, the game system 1 may set two types of materials as materials of a polygon of the display mesh, and may set one type of material as a material of a polygon of the determination mesh, based on one type of material that is set for each vertex of this polygon. In setting one type of material for the vertices to be used for generation of the determination mesh, a material having the greatest determination value, among the determination values calculated for each material, may be set as a material of the vertices. Also in this case, as in the present example, the number of types of materials to be set for one polygon in the display mesh may be two at most, and the number of types of materials to be set for one polygon in the determination mesh may be one. Therefore, the information on materials set in the voxel data can be used for (e.g., reflected in) the display mesh, and the process to be performed according to the result of collision determination using the determination mesh is prevented from being complicated.

As described above, in the present example, a display mesh and a determination mesh are set for one voxel object. However, depending on the game situation, both the display mesh and the determination mesh may not necessarily be set for one voxel object at the same time (e.g., both the meshes may not necessarily be set in processing one frame). For example, in the game space, the determination mesh may be generated in a range where collision determination is performed, and may not necessarily be generated in a range where collision determination is not performed. As an example, the game system 1 may generate the determination mesh for voxel objects within a predetermined range around the player character. For voxel objects outside the predetermined range, the game system 1 may generate only the display mesh without generating the determination mesh.

As for the display mesh, the game system 1 may store data regarding the generated mesh in a memory. In frames after generation of the mesh, the game system 1 may use the stored data without executing the mesh generating process again, except for a range where an update is performed. This can decrease the processing load for generating the display mesh. Meanwhile, as for the determination mesh, the game system 1 may not necessarily store data regarding the generated mesh in the memory, and may generate a mesh on an as-needed basis (e.g., each time collision determination is required). This saves memory use for generation of the mesh.

The method for, when voxel data has been changed from its initial state, generating meshes (e.g., a display mesh and a determination mesh) based on the changed voxel data, has been described above. This method can also be used for a case where the meshes are generated based on the voxel data in the initial state when a game is started, for example. However, the meshes based on the voxel data in the initial state may not necessarily be generated based on the voxel data in the initial state when the game is started, and may be prepared in advance of starting the game.

In addition, in another example, only one of the above display mesh and determination mesh may be set (e.g., the same mesh is used as a display mesh and a determination mesh). In that case, the above display mesh may also be used as a determination mesh, or the above determination mesh may also be used as a display mesh.

### 2-7. Process Using Object for Which Material on Mesh is Set

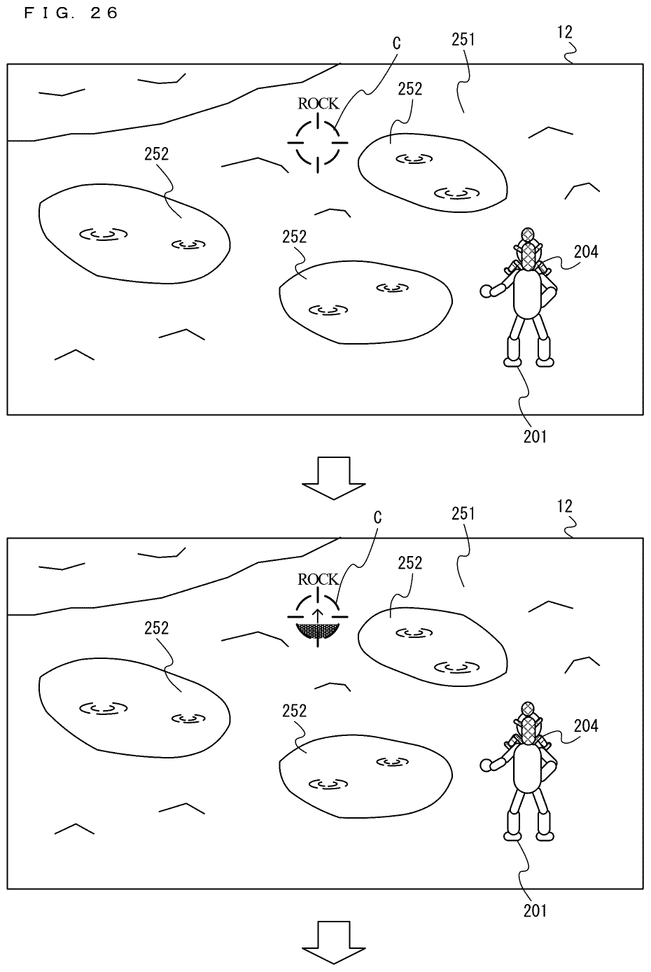

Next, an example of a process of acquiring a material on a mesh and performing a game using an object for which the material is set will be described with reference to FIGS. 26 to 38. Hereinafter, a description will be given of a case where a terrain object such as a ground or a wall is a voxel object, a player character performs an action, and an in-game behavior is generated as a result of collision determination.

The “in-game behavior” can include any change that occurs in the game. For example, the in-game behavior is a change that occurs due to a “process of reflecting a result of contact between objects”. The “in-game behavior” may be any behavior as long as it is based on collision determination between the determination mesh and a determination shape corresponding to a determination target based on the game processing (e.g., a determination region set for an object such as a player character or a shout object). The behavior may also occur in an object corresponding to the determination mesh. The content of the “in-game behavior” may be associated with a material set for a polygon on which a collision has been determined in collision determination that causes occurrence of the behavior (e.g., the content of the behavior may be determined based on the material).

FIG. 26 is a diagram showing an example of a game image representing a state in which a player character moves on a terrain object. In an example game described below, a first player character 201 and a second player character 204 appear in a game space in which the game is played. A motion of the first player character 201 in the game space is controlled based on an operation input from a controller operated by a first user. A motion of the second player character 204 in the game space is controlled based on an operation input from a controller operated by a second user. Here, as shown in FIG. 26, the second player character 204 is sitting on a portion (e.g., a shoulder, arm, back, head, etc.) of the first player character 201. The second player character 204 can move in the game space together with the first player character 201 while maintaining the above state. Therefore, when the first player character 201 moves in the game space based on an operation input from a controller operated by the first user, the first user can move not only the first player character 201 but also the second player character 204 because the second player character 204 moves together with the first character 201. It should be noted that the embodiment in which the first player character 201 and the second player character 204 move together in the game space is not particularly limited. For example, the second player character 204 may move, invariably following the first player character 201, or may be invariably disposed, floating above the first player character 201 or preceding the first player character 201. In addition, the second player character 204 may be a portion of the first player character 201, or may be integrated with the first player character 201. For example, one arm, hand, or eye of the first player character 201, or a portion of clothes, accessory, ornament, or the like that the first player character 201 is wearing, may serve as the second player character 204, or the first user and the second user may operate each portion of the single first player character 201.

In the example shown in FIG. 26, a material of polygons of a terrain object 252 that is a portion of a determination mesh of a terrain object that is a ground is set to “lava”. Meanwhile, a material of polygons of the determination mesh of the terrain object excluding the terrain object 252 is set to “rock”.

In the example shown in FIG. 26, the game system 1 performs collision determination between the terrain object, and the first player character 201 and the second player character 204, by using the determination mesh. That is, the game system 1 performs collision determination as to whether or not the determination mesh of the terrain object comes into contact with a determination region set for the player character (e.g., a region having a predetermined shape that is set based on the position of the first player character 201). When a collision between a polygon whose material is lava, and the first player character 201 and the second character 204, has been determined, a process of reducing the hit points of the first player character 201 and/or the second player character 204, is performed as a process of generating an in-game behavior. Moreover, in the above case, a process of causing the first player character 201 and/or the second player character 204 to perform a predetermined reaction is performed. It should be noted that collision determination may be performed for each of the first player character 201 and the second player character 204, or for a determination region representing both of the player characters. Alternatively, collision determination may be performed only for the first player character 201, and may not be performed for the second player character 204.

In the present example, regarding the lava material, a property of reducing the hit points of the player character that has come into contact with the material (e.g., a property of having a temperature equal to or higher than a predetermined value) is set as property information included in the aforementioned material data. The game system 1 generates an in-game behavior (in the above example, reduction in the hit points of the player character) based on the property information corresponding to the material set for the polygon in the determination mesh for which a collision has been determined through the collision determination.

When a collision between a polygon whose material is rock, and the first player character 201 and the second player character 204, has been determined, the process of reducing the hit points of the player character is not performed. Based on the collision, the first player character 201 (and the second player 204) is controlled so as not to be able to enter the polygon. Therefore, the player character can stand and walk on the polygon. Thus, in the present example, by setting a material for each polygon, the game system 1 can perform different processes depending on which part of the voxel object another object has come into contact with. In addition, the content of a process to be performed can be matched to the type of the material. It should be noted that in the present example, a player character can change a terrain object (e.g., a player character deforms a terrain object, or changes a material of a terrain object).

The content of the process to be performed when a collision between the voxel object and another object has been determined, is discretionary. For example, if the other object is a moving object such as the player character or an enemy character, the process may be a process of outputting the sound of footsteps of the object, or displaying an effect (e.g., effect of representing dust or splash of water) on the contact part. In this case, the game system 1 can change the sound of footsteps or the effect according to the type of the material set for the polygon, in the contact part, of the voxel object.

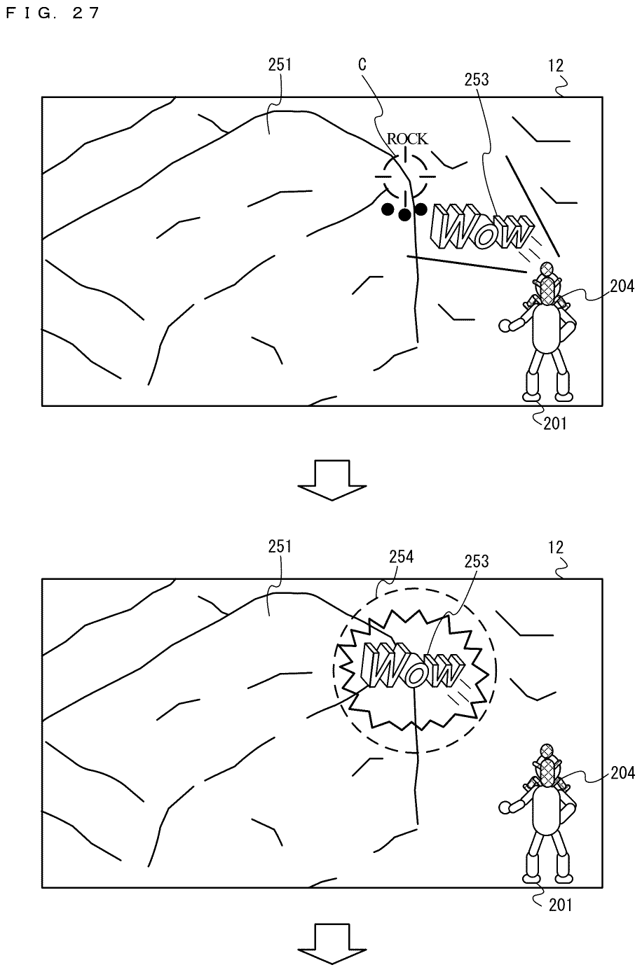

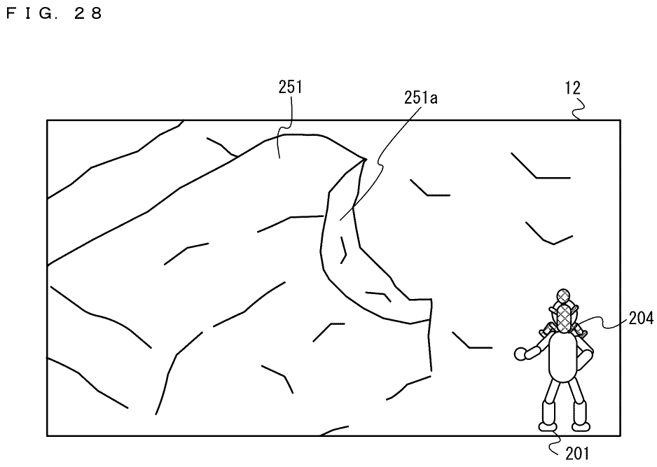

FIG. 26 is a diagram showing an example of a game image representing a state in which the second player character 204 acquires a material of a determination mesh of a terrain object, and acquires a shout object 253 for which the material is set. FIG. 27 is a diagram showing an example of a game image representing a state in which the second player character 204 emits the shout object 253. FIG. 28 is a diagram showing an example of a game image representing a state after the second player character 204 has emitted the shout object 253.

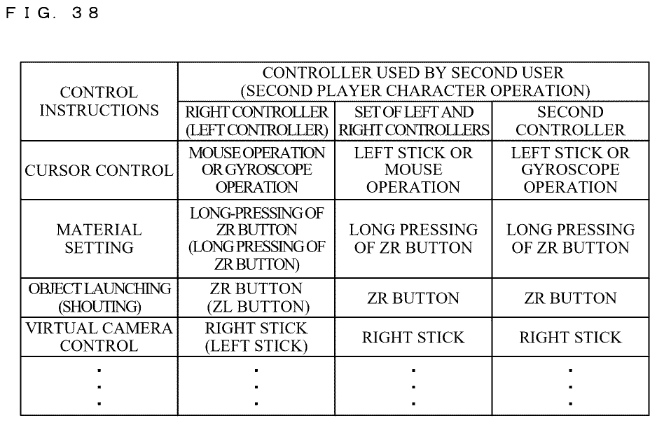

In the upper diagram of FIG. 26, in the present example, a cursor C is displayed which indicates a position in a displayed game space. A position indicated by the cursor C is moved based on a predetermined operation input (see FIG. 38) from a controller operated by the second user. As a first example, when the second user is operating the left controller 3 or the right controller 4 in a portrait orientation, the position of the cursor C is controlled so as to indicate a position based on an operation using the mouse function or a position based on an operation using the inertial sensors for detecting the motion and orientation of the entire left controller 3 or the entire right controller 4. As a second example, when the second user is operating using a set of the left controller 3 and the right controller 4, the position of the cursor C is controlled so as to indicate a position based on the tilt direction and tilt amount of the analog stick 32 (left analog stick), or a position based on an operation using the mouse function of the left controller 3 or the right controller 4. As a third example, when the second user is operating the second controller 7, the position of the cursor C is controlled so as to indicate a position based on the tilt direction and tilt amount of the left analog stick, or a position based on an operation using the inertial sensors for detecting the motion and orientation of the entire second controller 7. Thus, the cursor C can be moved upward, downward, leftward, and rightward on the display 12 based on the second user's operation. It should be noted that the cursor C may be displayed, overlaying the game space image displayed on the display 12, or may be disposed and displayed in the game space.

The game system 1 identifies a material at a position in the game space corresponding to the position indicated by the cursor C, and displays the name of the identified material in the vicinity of the cursor C. For example, the game system 1 identifies a material at a position on a determination mesh of a terrain object in the game space corresponding to the position indicted by the cursor C. As an example, in the upper diagram of FIG. 26, the cursor C indicates a position that is a portion of a material of a terrain object 251 whose material is rock. The “rock” material of a determination mesh corresponding to that position is identified, and the name of the identified material, “rock”, is displayed in the vicinity of the cursor C.

Next, in the present example, the material identified by the cursor C is set as a material of the shout object 253 emitted by the second player character 204 in accordance with an instruction based on a predetermined operation input (see FIG. 38) from a controller operated by the second user. For example, when the ZR button of a controller (e.g., the operation button 61 when the right controller 4 is operated, or the ZL button (operation button 39) when the left controller 3 is operated) operated by the second user is long-pressed, and the period of time for which the long-pressing operation has been continued reaches a predetermined period of time, the material identified by the cursor C is set as a material of the shout object 253. In the lower diagram of FIG. 26, a gauge indicating the period of time for which the long-pressing operation has been continued is displayed inside the cursor C. When the gauge has extended to the upper limit, it is indicated that a material of the shout object 253 is set to the “rock” material. When a material of the shout object 253 is set, a label indicating the number of remaining shots that can be used to emit the shout object 253 is attached and displayed in the vicinity of the cursor C (see the upper diagram of FIG. 27). It should be noted that some types of materials may not be able to be set as a material of the shout object 253. As an example, a material whose hardness is set so high that the material cannot be destroyed, a material that causes damage to a player character, or the like may not be able to be set for the shout object 253. Although in the present example, the material identified by the cursor C and set as a material of the shout object 253 is a material on a determination mesh, other embodiments may be provided in other examples. For example, the game system 1 may identify a material at a position on a display mesh of a terrain object in the game space corresponding to the position indicated by the cursor C. When one of a determination mesh and a display mesh is set, the game system 1 may identify a material on the one mesh. In addition, the number of remaining shots set for the shout object 253 may be a predetermined fixed value, or may vary depending on the type of the set material, the game stage, the type or level of the second player character 204.

As shown in the upper diagram of FIG. 27, the shout object 253, for which a material has been set by the above process, is emitted and moved toward a position in the game space corresponding to the position of the cursor C in response to a shouting action performed by the second player character 204 in accordance with an instruction based on a predetermined operation input (see FIG. 38) from a controller operated by the second user. Here, the cursor C, which is the target destination of the shout object 253, can be moved based on the above operation input from a controller operated by the second user. As in the above process, the game system 1 identifies a material at a position in the game space corresponding to the position indicated by the cursor C, and displays the name of the identified material in the vicinity of the cursor C. In the example shown in the upper diagram of FIG. 27, the cursor C indicates a portion of the terrain object 251 of the “rock” material, and therefore, the name of the material, “rock”, is displayed in the vicinity of the cursor C.

As shown in the upper and lower diagrams of FIG. 27, when the ZR button of a controller operated by the second user (the ZL button when the left controller 3 is operated), the shout object 253, for which a material has been set, is moved toward a position in the game space corresponding to the position of the cursor C at a predetermined movement speed. It should be noted that during the start of movement of the shout object 253, a scene that the shout object 253 appears from the inside of the second player character 204 (or the first player character 201), or a scene that the shout object 253 appears from near the second player character 204 or the first player character 201, may be displayed. In addition, the number of remaining shots indicated by the label that is reduced by one may be displayed in response to the start of movement of the shout object 253.

The shout object 253 is a virtual object that appears in the game space due to a voice uttered by the second player character 204 shouting. The shout object 253 is made of a material set by the above process. The size and shape of the shout object 253 are not particularly limited. For example, the shout object 253 is a 3D object that indicates the word or phrase shouted by the second player character 204 and to which a texture corresponding to the set material (e.g., a texture representing a surface of the set material) is attached. In the example shown in FIG. 27, the shout object 253 is a 3D object that indicates the word “Wow” shouted by the second player character 204 and to which a texture representing a rock surface is attached. It should be noted that the shout object 253 may be a non-voxel object or a voxel object. In the description that follows, an example in which the shout object 253 is a non-voxel object is used.

When the shout object 253 collides with another object, the game system 1 sets an update range in which a voxel object is to be updated at a collision position, based on collision determination between a determination region set for the shout object 253 and a determination mesh of the another object. In the example shown in the lower diagram of FIG. 27, based on collision determination between a determination region set for the shout object 253 and a determination mesh of the terrain object 251, which is a voxel object, an update range 254 is set at a collision position. In the present example, the position, shape, and size of the update range 254 are not particularly limited. For example, the position of the update range 254 may be the position where the shout object 253 is in contact with the determination mesh of the terrain object 251. A position that is located inside the terrain object 251 and at a predetermined distance from the contact position may be a center position of the update range 254. In addition, the shape and size of the update range 254 may be determined such that the update range 254 is in the shape of a sphere having a predetermined size, irrespective of the size of the shout object 253. In addition, the size of the update range 254 may be determined based on a material of the shout object 253.

For voxels corresponding to the set update range 254, the game system 1 generates an in-game effect that changes at least one of the density and material. For example, the game system 1 performs one of a plurality of effects including at least the following that corresponds to the type of a material of the shout object 253.
Reduction of the densities of voxels in voxel data corresponding to the update range 254
Increasing of the densities of voxels in voxel data corresponding to the update range 254 and setting of materials of the voxels to a predetermined material
Changing of materials of voxels in voxel data corresponding to the update range 254 to a predetermined material, when a material of a determination mesh at a collision position and a material of the shout object 253 are a predetermined combination

For example, in the example shown in FIG. 28, the game system 1 reduces the densities of voxels in voxel data corresponding to the update range 254. As a result, an in-game effect is produced in which the terrain object 251 at the collision position of the terrain object 251 is deformed so as to be destroyed and extinguished. For example, in the present example, the reduction of each voxel is controlled by rewriting the density of the voxel based on the SDF of the voxel. As an example, the terrain object 251 that is at least a portion of the update range 254 is removed by rewriting the densities of voxels whose SDF has a negative distance with a value that decreases with an increase in the magnitude of the absolute value of that distance, and rewriting the densities of voxels the magnitudes of the absolute values of which are greater than a predetermined value with a lower limit value. It should be noted that in the example shown in FIG. 28, a state is displayed in which a rock surface 251a generated by removal of a portion of the terrain object 251 due to collision with the shout object 253 is newly exposed to the outside.

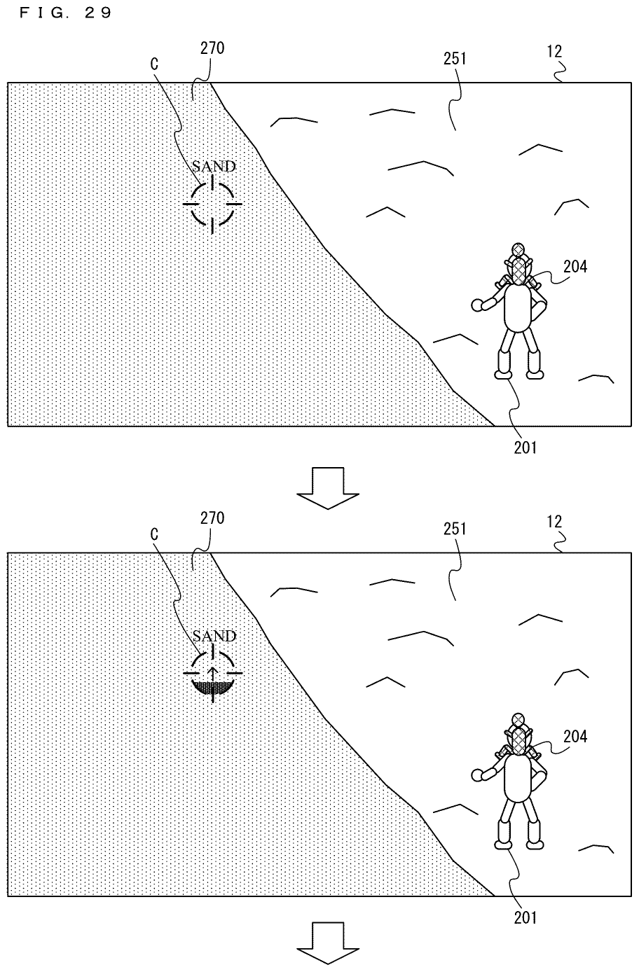

As another example, in the upper diagram of FIG. 29, the cursor C indicates a position of a portion of a terrain object 270 whose material is sand. A material of a determination mesh corresponding to the position is identified as “sand”, and the name of the identified material, “sand”, is displayed in the vicinity of the cursor C.

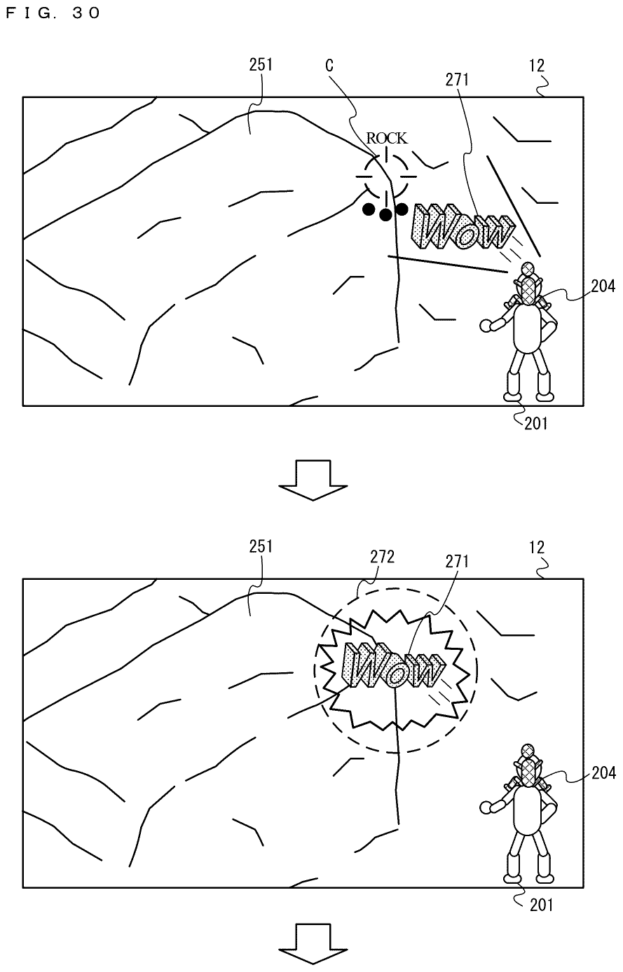

Next, when a period of time for which a predetermined operation input (see FIG. 38) from a controller operated by the second user has been continued reaches a predetermined period of time, the “sand” material identified by the cursor C is set as a material of a shout object 271. In the example shown in the lower diagram of FIG. 29, a gauge indicating a period of time for which the operation input has been continued is displayed inside the cursor C. When the gauge has extended to the upper limit, it is indicated that a material of the shout object 271 is set to the “sand” material. When a material of the shout object 271 is set, a label indicating the number of remaining shots that can be used to emit the shout object 271 is attached and displayed in the vicinity of the cursor C (see FIG. 30).

As shown in the upper diagram of FIG. 30, the shout object 271, for which the “sand” material is set, is emitted and moved toward a position in the game space corresponding to the position of the cursor C in response to the shouting action of the second player character 204 performed in accordance with an instruction based on a predetermined operation input (see FIG. 38) from a controller operated by the second user. As in the above process, the game system 1 identifies a material at a position in the game space corresponding to the position indicated by the cursor C, and displays the name of the identified material in the vicinity of the cursor C. In the example shown in the upper diagram of FIG. 30, as in the example shown in the upper diagram of FIG. 27, a portion of the terrain object 251 of the “rock” material is indicated by the cursor C, and therefore, the name of the material, “rock”, is displayed in the vicinity of the cursor C.

As shown in the upper and lower diagrams of FIG. 30, the shout object 271, for which the “sand” material has been set, is moved toward a position in the game space corresponding to the position of the cursor C at a predetermined movement speed, based on a predetermined operation input (see FIG. 38) from a controller operated by the second user. In the example shown in FIG. 30, the shout object 271 is a 3D object that indicates the word “Wow” shouted by the second player character 204 and to which a texture representing a sand surface is attached.

When the shout object 271 collides with another object, the game system 1 sets an update range in which a voxel object is to be updated, at a collision position based on collision determination between a determination region set for the shout object 271 and a determination mesh of the another object. In the example shown in the lower diagram of FIG. 30, based on collision determination between a determination region set for the shout object 271 and a determination mesh of the terrain object 251, which is a voxel object, an update range 272 is set at a collision position. The position, shape, and size of the update range 272 are not particularly limited, as with the update range 254.

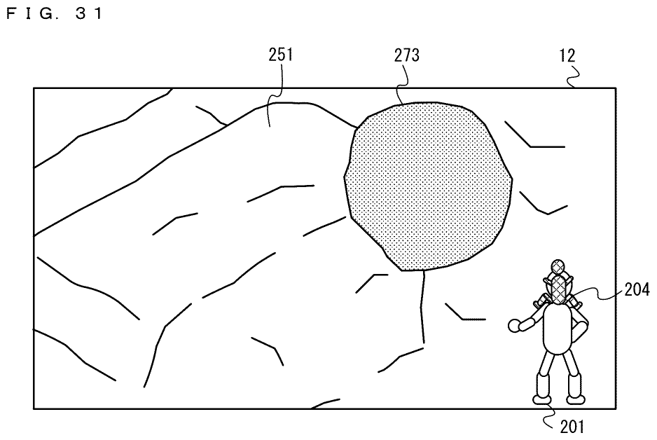

For voxels corresponding to the update range 272 set due to collision of the shout object 271, which is made of the sand material, with the terrain object 251, which is made of the solid rock material, the game system 1 increases the densities thereof, and produces the in-game effect of setting a material thereof to a predetermined material. For example, as shown in FIG. 31, the game system 1 increases the densities of voxels in voxel data corresponding to the update range 272, and sets materials of the voxels whose densities have been increased to the “sand” material. As a result, an in-game effect is produced in which a terrain object 273 made of the sand material is put on the terrain object 251 at the collision position, so that the terrain object 251 is increased. For example, an increase in each voxel is controlled by rewriting the density of the voxel based on the SDF of the voxel. As an example, the terrain object 273 made of the sand material is put on the terrain object 251 that is at least a portion of the update range 272 by rewriting the densities of voxels whose SDF has a negative distance with a value that increases with an increase in the magnitude of the absolute value of that distance, and rewriting the densities of voxels the magnitudes of the absolute values of which are greater than a predetermined value with an upper limit value. It should be noted that a material set for voxels in voxel data corresponding to the update range 272 (e.g., materials of voxels whose densities are increased) may be a material of the shout object 271, a material set at the collision position of the determination mesh of the terrain object 251, or a material including these materials mixed at a predetermined ratio (e.g., 1:1).

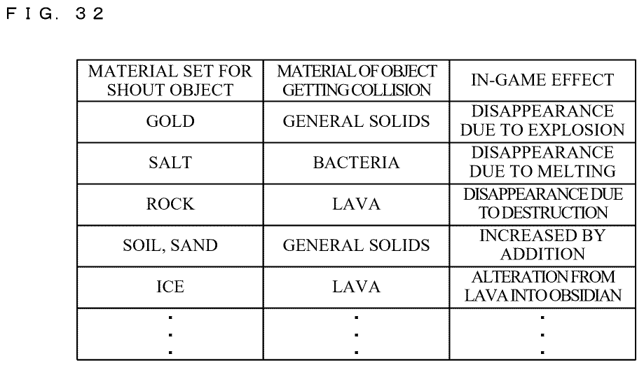

In the present example, various in-game effects may be produced based on the type of a material set for a shout object and the type of a material set at a collision position between a shout object and a determination mesh of an object with which the shout object collides. For example, as illustrated in FIG. 32, as a first example, a gold material is set for a shout object, and a general solid material is set at a collision position between the shout object and a determination mesh of an object with which the shout object collides. For the gold material, it is assumed that a property that the material explodes and destroys a contact object is set as property information included in the material data. In this case, an in-game effect is produced in which an explosion occurs in a predetermined range with reference to the collision position, and the densities of voxels in voxel data corresponding to an update range set based on the collision position are reduced.

As a second example, a salt material is set for a shout object, and a bacterial material is set at a collision position between the shout material and a determination mesh of an object with which the shout material collides. For the salt material, it is assumed that a property that the material sterilizes a contact object is set as property information included in the material data. In this case, an in-game effect is produced in which melting occurs in a predetermined range with respect to the collision position, and the densities of voxels in voxel data corresponding to an update range set based on the collision position are reduced.

As a third example, a rock material is set for a shout object, and a general solid material is set at a collision position between the shout object and a determination mesh of an object with which the shout object collides. For the rock material, it is assumed that a property that the material destroys a contact object is set as property information included in the material data. In this case, an in-game effect is produced in which destruction occurs in a predetermined range with reference to the collision position, and the densities of voxels in voxel data corresponding to an update range set based on the collision position are reduced.

As a fourth example, a material such as soil or sand is set for a shout object, and a general solid material is set at a collision position between the shout object and a determination mesh of an object with which the shout object collides. For the material such as soil or sand, it is assumed that a property that the material solidifies on a contact object is set as property information included in the material data. In this case, an in-game effect is produced in which the densities of voxels in voxel data corresponding to an update range set based on the collision position is increased, and materials of the voxels are set to a predetermined material, whereby a voxel object of a predetermined material is put in a predetermined range with reference to the collision position.

As a fifth example, an ice material is set for a shout object, and a lava material is set at a collision position between the shout object and a determination mesh of an object with which the shout object collides. For the ice material, it is assumed that a property that the material reduces the temperature of a contact object (e.g., a property that the temperature is lower than or equal to a predetermined value (e.g., a temperature lower than or equal to the freezing point)) is set as property information included in the material data. In this case, an in-game effect is produced in which when the lava material is cooled by the ice material, so that materials of voxels in voxel data corresponding to an update range set based on the collision position are changed from lave to obsidian.

It should be noted that in another example, the shout object illustrated in each of the first to fifth examples may be included in the shout object illustrated in the other examples. For example, the shout object described in the third example for which the rock material is set may be included in the shout object illustrated in the fourth example. In addition, a shout object for which a material that is not described in the above examples is set may be further included in any of the first to fifth examples.

In the foregoing, it is assumed that a voxel object corresponding to an update range set due to a collision with a shout object is unconditionally changed. Alternatively, in another example, a voxel object corresponding to an update range may be changed, depending on the amount of damage set for voxels. For example, instead of unconditionally changing a voxel object corresponding to an update range, the game system 1 may increase the amount of damage set for voxels corresponding to an update range, and change the voxel object if the amount of damage exceeds a predetermined value. In that case, the amount of an increase in damage may be determined based on the shout object 253 that has collided with the voxel object.

In addition, in the present example, when the first player character 201 performs an action of throwing a fragment object, an update range in which a voxel object is updated is set at a collision position based on collision determination between a determination region set for the fragment object and a determination mesh of the another object. For voxels corresponding to the set update range, the game system 1 can produce the in-game effect of changing at least one of the density and material based on the action of the first player character 201.

The fragment object may or may not be a voxel object. The material, size, and shape of the fragment object are not particularly limited. In the present example, a plurality of fragment objects may be disposed in the game space. The fragment object may be generated by the first player character 201 performing an action described below. When the fragment object is a voxel object, a specific voxel space is defined for the fragment object, and a specific display mesh and a specific determination mesh are set based on the specific voxel data. The specific voxel space can be moved/rotated in the game space for each defined fragment object. The position, direction (orientation), and the like in the game space of the specific voxel space are controlled. It should be noted that voxels defined in the specific voxel space may have a size different from that of voxels constituting a terrain object, and may have a smaller voxel size. In the following description, an example is described in which the fragment object is a voxel object.

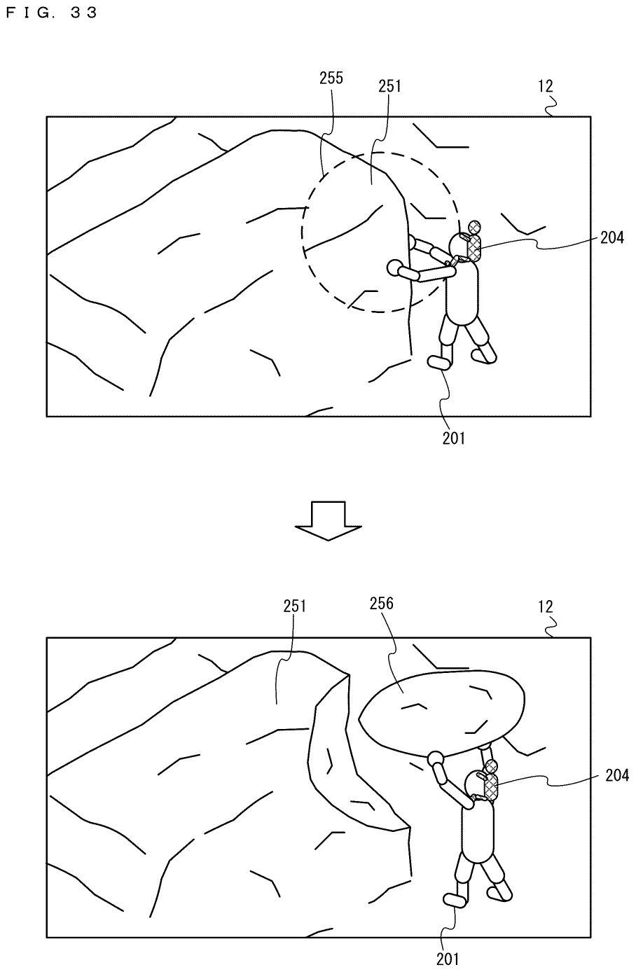

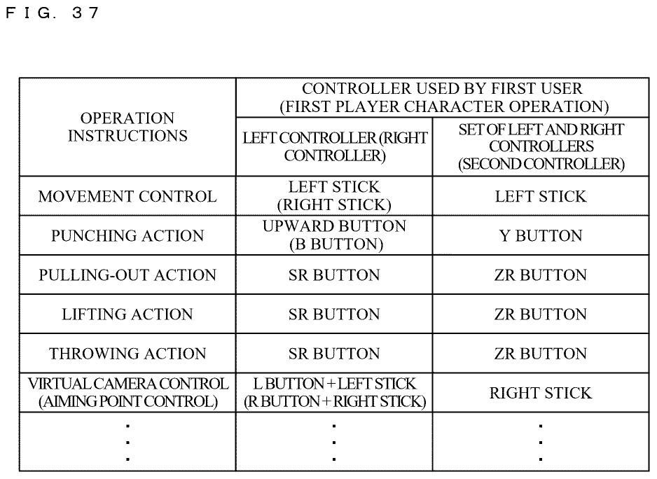

FIG. 33 is a diagram showing an example of a game image representing a state in which a first player character 201 pulls out a fragment object 256 from a terrain object 251. In the present example, by a predetermined operation input (see FIG. 37) from a controller operated by the first user, the player character 201 can be caused to perform an action of holding the terrain object 251, pulling out a portion of the terrain object 251 as a fragment object 256, and grasping the fragment object 256 (hereinafter referred to as “pulling-out action”). For example, when the first user is operating the left controller 3 alone or the right controller 4 alone, the pulling-out action is performed by pressing down the SR button (operation button 44 or 66). When the first user is operating a set of the left controller 3 and the right controller 4, or is operating the second controller 7, the pulling-out action is performed by pressing down the ZR button (e.g., the operation button 61). The game system 1 deletes a portion of the terrain object 251 and generates the fragment object 256 in response to the pulling-out action of the first player character 201.

For example, in performing the pulling-out action, the game system 1 executes the following process. For example, when the user performs an operation input that causes the first player character 201 to perform the pulling-out action, the game system 1 causes the first player character 201 to perform an action of digging forward and holding, and performs collision determination. When a collision between the first player character 201, which has performed the pulling-out action, and the terrain object has been determined, the game system 1 generates an update range 255 based on the position and direction of the first player character 201. For example, the update range 255 is generated in a predetermined direction (e.g., forward) with reference to the first player character 201. It should be noted that the shape and size of the update range 255 may be previously determined according to the type or level of the action of the player character 201. Furthermore, the game system 1 decreases the densities of voxels corresponding to the update range 255. By updating the mesh according to the decrease in the densities of the voxels, the terrain object 251 is deformed such that a portion of the update range 255 is deleted (see the lower diagram of FIG. 33). Although in the present example, the density of every voxel corresponding to the update range 255 is decreased, voxels whose densities are to be decreased may be at least a portion of the voxels corresponding to the update range 255.

In the present example, the voxel object corresponding to the update range 255 is unconditionally deformed due to the pulling-out action. In other examples, the voxel object corresponding to the update range 255 may be deformed, depending on the amount of damage set for the voxels. For example, instead of unconditionally deforming the voxel object corresponding to the update range 255, the game system 1 may increase the amount of damage set for the voxels corresponding to the update range 255, and decrease the densities of the voxels in response to the amount of damage having exceeded a predetermined value. In this case, the amount of an increase in damage may be determined according to the action performed on the voxel object.

The game system 1 generates the fragment object 256 representing the deleted portion of the terrain object 251. For example, as shown in the lower diagram of FIG. 33, based on the pulling-out action, the game system 1 generates the fragment object 256 in the state of being held by the first player character 201. The fragment object 256 may be generated so as to have a shape corresponding to the deleted portion of the terrain object 251, or a predetermined shape. A specific voxel space different from the voxel space of the voxels corresponding to the terrain object 251 or the like is defined for the fragment object 256.

The game system 1 determines a material of the fragment object 256. The material of the fragment object 256 is determined based on materials set for polygons in a determination mesh that comes into contact with the update range 255 among determination meshes of the terrain object 251. The material of the fragment object 256 is determined to be the same as at least one of the materials set for the polygons in the determination mesh that comes into contact with the update range 255. Thus, the material of the fragment object 256 can be made identical to the material of the deleted portion of the terrain object 251. As is apparent from the above description, the fragment object 256 is actually not a portion of the terrain object 251. However, since the fragment object 256 is generated simultaneously with deletion of a portion of the terrain object and takes over the material of the deleted portion of the terrain object 251, an impression that the first player character 201 removes a portion of the terrain object 251 by a pulling-out action can be given to the user. It should be noted that as another example, the material of the fragment object 256 may be determined based on a material set in the voxel data for voxels that are in contact with the update range 255.

In the present example, priorities are set for the types of materials prepared, and the game system 1 determines, as a material of the fragment object 256, a material having the highest priority among the materials set for the polygons of the determination mesh in the update range 255. If the determination mesh in the update range 255 includes polygons for which different types of materials are set, it may be difficult for the user to predict a material of the fragment object 256, and the above inconvenience may occur against the user's will. Meanwhile, in the present example, since the priorities are given to the materials to be set as a material of the fragment object 256, the risk of the above inconvenience can be reduced. It should be noted that in another example, the game system 1 may determine, as a material of the fragment object 256, a material having the highest material mixing ratio of the materials set for the polygons of the determination mesh in the update range 255. Furthermore, not only the priority levels, but also a setting for excluding a particular material from those to be pulled out, may be set. For example, in the case in which the determination mesh in the update range 255 includes polygons whose material is rock and polygons whose material is lava, then if a material of the fragment object 256 is set to lava, the hit points of the player character 201 are reduced when the first player character 201 grasps the fragment object 256 by performing the pulling-out action (it should be noted that as described with reference to FIG. 26, it is assumed that the lava material has the property that the hit points of the first player character 201 are reduced when the first player character 201 comes into contact with the lava material), which is likely to be an inconvenience. Therefore, materials that cause damage such as lava may be excluded from those to be pulled out, and therefore, may not be included in materials of the fragment object 256.

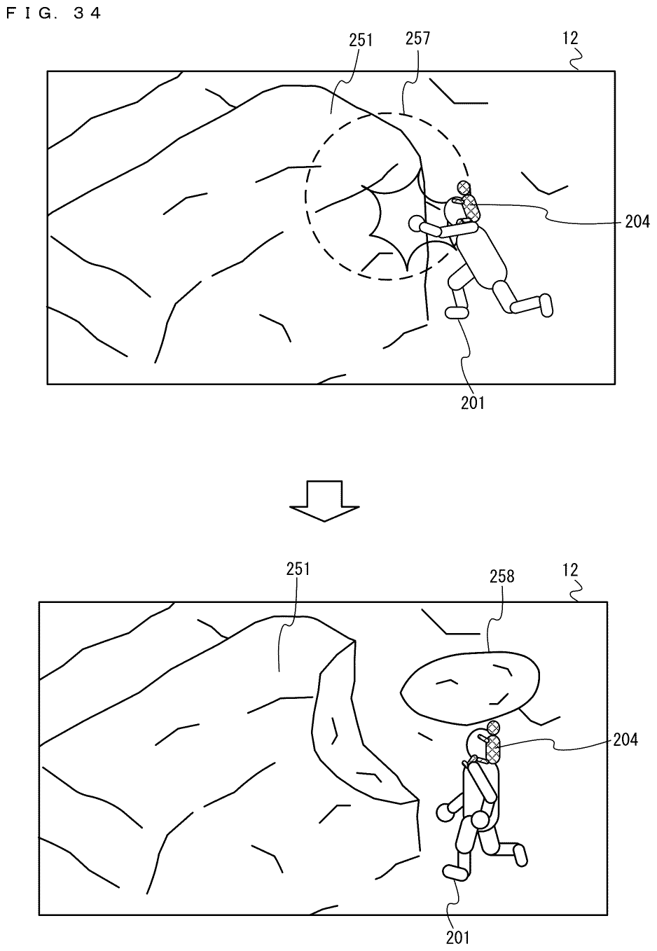

FIG. 34 shows an example of a game image representing a state in which a fragment object 258 is generated by the first player character 201 destroying the terrain object 251. In the present example, by a predetermined operation input (see FIG. 37) from a controller operated by the first user, the first player character 201 can be caused to perform a punching action. For example, when the first user is operating the left controller 3 alone or the right controller 4 alone, the punching action is performed by pressing down the upward button (operation button 35) or the B button (operation button 54). When the first user is operating a set of the left controller 3 and the right controller 4, or is operating the second controller 7, the punching action is performed by pressing down the Y button (e.g., the operation button 56). As in the case of the pulling-out action, the game system 1 deletes a portion of the terrain object 251 and generates a fragment object 258, as an in-game behavior caused by the punching action. Specifically, the game system 1 deforms the terrain object 251 such that a portion of the terrain object 251 is deleted. In the case of the punching action, unlike the pulling-out action, the fragment object 258 is not held by the first player character 201 but is disposed near the position where the punching action has been performed (see the lower diagram of FIG. 34).

In performing the punching action, specifically, the game system 1 executes the following process. For example, when an operation input to cause the first player character 201 to perform the punching action has been performed by the user, the game system 1 causes the first player character 201 to perform an action of punching forward, and performs collision determination. Then, when a collision between the first player character 201, which has performed the punching action, and the terrain object 251 has been determined, the game system 1 generates an update range 257 based on the position and direction of the player character. For example, the update range 257 is generated in a predetermined direction (e.g., forward) with reference to the first player character 201. The position, shape, and size of the update range 257 due to the punching action may be the same as or different from those of the update range 255 due to the pulling-out action. Then, the game system 1 decreases the densities of voxels corresponding to the update range 257. Thus, the terrain object 251 is deformed such that the part inside the update range 257 is deleted by the punching action, similarly to the pulling-out action (see the lower diagram of FIG. 34). In the case of the punching action, as in the case of the pulling-out action, instead of unconditionally deforming the voxel object corresponding to the update range 257, the game system 1 may increase the amount of damage set for the voxels in the update range 257 according to the punching action, and decrease the densities of the voxels in response to the amount of damage having exceeded a predetermined value. In addition, the voxels whose densities are to be decreased by the punching action may be at least a portion of the voxels corresponding to the update range 257.

The game system 1 generates a fragment object 258 corresponding to the deleted portion of the terrain object 251. That is, based on the punching action, the game system 1 generates the fragment object 258 in the state of not being held by the first player character 201 (e.g., in the state of being disposed near the position where the punching action has been performed). The fragment object 258 may be a voxel object, and may be generated so as to have a shape corresponding to the deleted portion of the terrain object 251, or a predetermined shape.

The game system 1 determines a material of the fragment object 258. The material of the fragment object 258 is determined based on materials set for polygons in a determination mesh that comes into contact with the update range 257 among the determination meshes in the terrain object 251. The material of the fragment object 258 is determined to be the same as at least one of the materials set for the polygons in the determination mesh that comes into contact with the update range 257. Thus, the material of the fragment object 258 can be made identical to the material of the deleted part of the terrain object 251. Since the fragment object 258 is generated simultaneously with deletion of a part of the terrain object 251 and takes over the material of the deleted part of the terrain object 251, an impression that a part of the terrain object 251 destroyed due to a punching action of the first player character 201 is generated as the fragment object 258 can be given to the user.

In the present example, the material of the fragment object 258 is set to a material having the greatest degree of decrease in voxel density among the materials set for the polygons in the determination mesh that comes into contact with the update range 257. This allows generation of the fragment object 258 in which the material composition of the part, of the terrain object 251, deleted due to the punching action is more accurately shown (e.g., reflected).

The method for determining the material of the fragment object 256 or 258 removed by the pulling-out action or the punching action is discretionary. For example, the method for determining the material of the fragment object 256 or 258 may be the same between the pulling-out action and the punching action. Moreover, for example, among the materials set for the polygons of the determination mesh in the update range 255 or 257, a material that is set for the largest number of polygons may be determined as the material of the fragment object 256 or 258. Alternatively, for example, a material that is set for a polygon satisfying a predetermined condition (e.g., a polygon at a position that comes into contact with a hand of the first player character 201, which is performing the pulling-out action or the punching action) among the polygons of the determination mesh in the update range 255 or 257, may be determined as the material of the fragment object 256 or 258. In other examples, a plurality of types of materials may be set for the fragment object 256 or 258.

In the present example, the user can perform various actions using a fragment object that is generated by being removed from a terrain object as described above. For example, in the present example, in the case in which a material of a fragment object is a particular material, an in-game effect corresponding to the particular material is produced for the fragment object, and the size of the fragment object is reduced according to game progression.

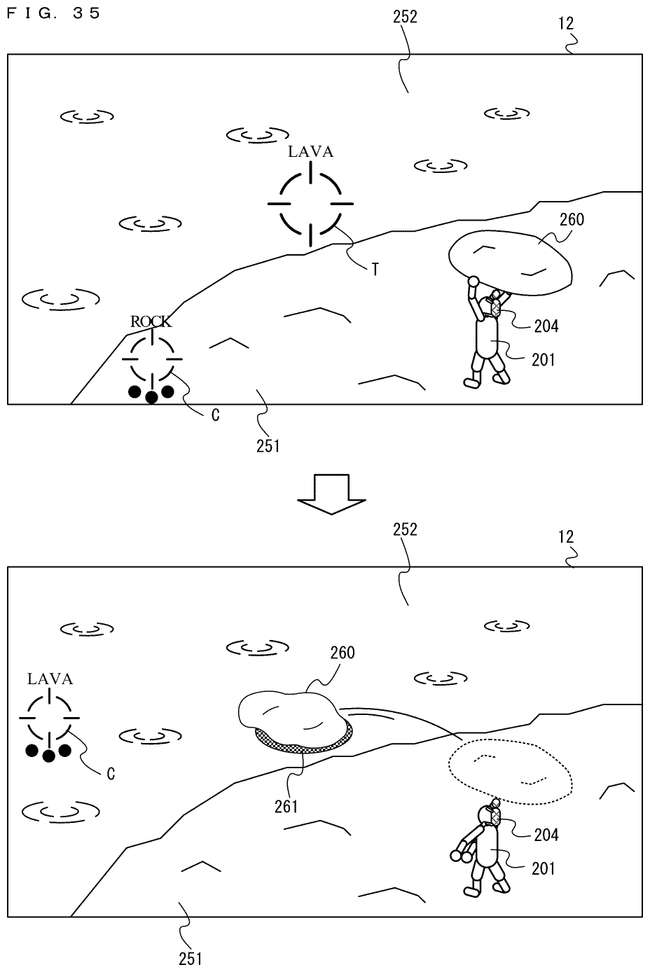

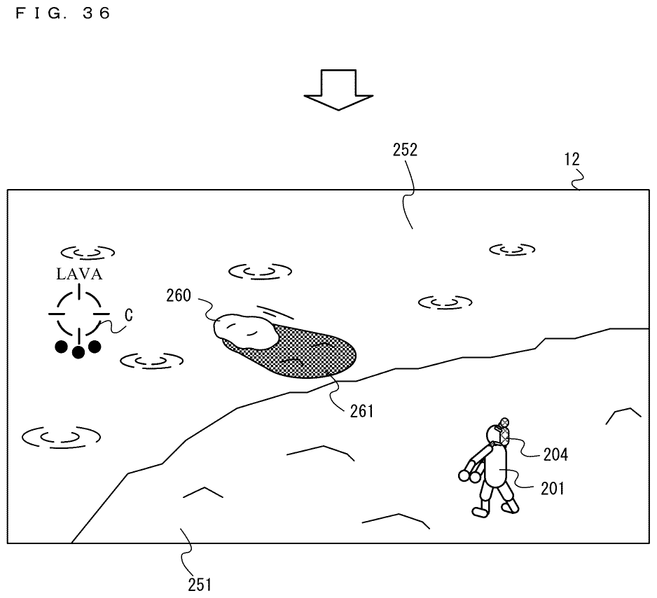

Referring to FIG. 35 and FIG. 36, an example will be described in which when a first player character 201 performs an action of throwing a fragment object generated in the game space as described above to change a material of another voxel object. FIGS. 35 and 36 are a diagram showing an example of a game image representing a state in which the first player character 201 throws a fragment object 260 into a terrain object 252 made of a lava material.

In the present example, in the case in which a material of a fragment object removed from a terrain object as described above includes ice (the fragment object 260 of FIGS. 35 and 36), the first user can change a material in the terrain object 252 by causing the first player character 201 to perform an action of throwing the fragment object 260 into the terrain object 252 made of a lava material. It should be noted that as described above, the first player character 201 is caused to hold the fragment object 260 by performing the pulling-out action or an action of holding the fragment object after the punching action. As shown in the upper and lower diagrams of FIG. 35, the first user can cause the first player character 201 to perform an action of throwing the fragment object 260, which is being held by the first player character 201, by performing a predetermined operation input (see FIG. 37). For example, when the first user is operating the left controller 3 alone or the right controller 4 alone, the throwing action is performed by pressing down the SR button (operation button 44 or 66). When the first user is operating a set of the left controller 3 and the right controller 4 or is operating the second controller 7, the throwing action is performed by pressing down the ZR button (e.g., the operation button 61).

As shown in the upper and lower diagrams of FIG. 35, when the first player character 201 performs an action of throwing the fragment object 260, the fragment object 260 is moved toward a position in the game space corresponding to the position of an aiming point T. The aiming point T is, for example, displayed when the first player character 201 is holding a fragment object, and indicates a position in the game space corresponding to the position where the aiming point T is displayed. The aiming point T is fixed and displayed at a predetermined position in the display screen (e.g., the center position of the display screen, or a position that is located a predetermined length away from the center in the upward direction). Here, as can be seen from the description below, the direction of a virtual camera can be changed based on a predetermined operation input from a controller operated by the first user (see FIG. 37). As a first example, when the first user is operating the left controller 3 or the right controller 4 in a landscape orientation, the light-of-sight direction of the virtual camera is changed based on pressing down of the L button (operation button 38) and the tilt direction and tilt amount of the analog stick 32 (left analog stick), or based on pressing down of the R button (operation button 60) and the tilt direction and tilt amount of the analog stick 52 (right analog stick). As a second example, when the first user is operating a set of the left controller 3 and the right controller 4 or is operating the second controller 7, the light-of-sight direction of the virtual camera is changed based on the tilt direction and tilt amount of the analog stick 52 (right analog stick). When the light-of-sight direction of the virtual camera is thus changed, the position of the aiming point T fixed and displayed on the display screen is also changed. Thus, the first user can control a position in the game space corresponding to the position of the aiming point T based on the above operation. Although the aiming point T is typically displayed, overlaying the game space image displayed on the display 12, the aiming point T may be disposed and displayed in the game space in another example.

As in the case of the cursor C, the game system 1 identifies a material at a position in the game space corresponding to the position indicated by the aiming point T, and displays the name of the identified material in the vicinity of the aiming point T. For example, the game system 1 identifies a material at a position in the game space on a determination mesh of a terrain object corresponding to the position indicated by the aiming point T. In the example shown in the upper diagram of FIG. 35, the aiming point T indicates the position of a portion of the terrain object 252 whose material is lava. The “lava” material of the determination mesh corresponding to that position is identified, and the name of the identified material, “lava”, is displayed in the vicinity of the aiming point T. In addition, in the present example, during a period of time when the aiming point T is displayed, the cursor C can also be simultaneously displayed at a position based on an operation input from a controller operated by the second user. In the example shown in the upper diagram of FIG. 35, the cursor C indicates the position of a portion of the terrain object 251 whose material is rock. The “rock” material of a determination mesh corresponding to that position is identified, and the name of the identified material, “rock”, is displayed in the vicinity of the cursor C.

In the example shown in the lower diagram of FIG. 35, the fragment object 260 has been thrown into the terrain object 252 made of the lava material by the first player character 201 performing the throwing action. In the vicinity of a position where the fragment object 260 has come into contact with the terrain object 252 for the first time, a portion of the terrain object 252 is cooled by the fragment object 260, so that a material of that portion is changed and altered. Specifically, the game system 1 generates an update range that includes the contact position, and changes materials of voxels of the terrain object 252 in the update range, thereby altering a portion of the terrain object 252. In addition, the size of the fragment object 260 is reduced by a scaling process for size reduction so that the terrain object 252 made of the lava material is melted due to contact with the fragment object 260.

For example, the above update range is set to a shape corresponding to a shape as is when the fragment object 260 comes into contact with the terrain object 252 for the first time, and the lava material of voxels of the terrain object 252 in the update range is set to the obsidian material. Specifically, the lava material of voxels in the update range corresponding to the terrain object 252 is changed into the obsidian material. Based on the changed voxel material, a material of a display mesh and determination mesh of the terrain object 252 is determined. In the lower diagram of FIG. 35, the portion of the terrain object 252 whose material has been changed into the obsidian material is set as a region 261. As a result, the appearance of the region 261 in which a portion of the terrain object 252 made of the lava material that has been changed into the obsidian material can be caused to be different from the appearance of the terrain object 252 made of the lava material. Therefore, the user is easily given an impression that the lava material of the terrain object 252 has been altered by being cooled by the fragment object 260, so that a situation can be represented in which an object of lava is changed into obsidian by being cooled by the fragment object 260 made of the ice material.

In addition, the size of the fragment object 260 is reduced with passage of time when the fragment object 260 has been in contact with the terrain object 252 made of the lava material. When the size of the fragment object 260 is smaller than a predetermined reference, the effect of cooling the terrain object 252 made of the lava material with the fragment object 260 is ended, and the fragment object 260 is caused to disappear from the game space.

In the example shown in FIG. 36, the fragment object 260 has further moved on the terrain object 252 from the position illustrated in the lower diagram of FIG. 35 while being in contact with the terrain object 252, and the terrain object 252 is changed such that a portion of the terrain object 252 in the vicinity of contact positions further produced due to the movement has been cooled by the fragment object 260, so that a material of that portion has been changed. In addition, the size of the fragment object 260 is reduced into a further melted shape due to additional contact with the terrain object 252.

Specifically, by a method similar to the above method for changing a material, the game system 1 generates a new update range including the position of additional contact with the reduced fragment object 260, and further changes materials of voxels of the terrain object 252 in the new update range, so that a portion of the terrain object 252 is further changed. For example, the game system 1 also reduces the new update range according to the size of the reduced fragment object 260. It should be noted that the game system 1 generates the new update range such that the new update range is smoothly connected to the previously generated update range. As a result, a shape is provided in which a region in which a material is changed and that is enlarged each time an update range is generated is smoothly connected to a region in which a material has already been changed (e.g., see the region 261 shown in FIG. 36). Thus, the region 261 in the terrain object 252 in which the lava material has been changed into the obsidian material can be enlarged. Therefore, the user can be more easily given an impression that the fragment object 260 has further cooled and altered the lava material to enlarge the altered region of the terrain object 252. In addition, the user can be more easily given an impression that the fragment object 260 has been further melted by the lava material of the terrain object 252 in order to further reduce the size of the fragment object 260.

It should be noted that the details of the aforementioned material change may be determined based on the material for a contacted terrain object, the material for a contacted fragment object, or based on the combination of the material for a contacted terrain object and the material for a contacted fragment object. This allows various changes in voxel objects constituting a terrain object or a fragment object.

In the above example, when the fragment object 260 comes into contact with another voxel object, a material of the another voxel object is changed. What of the another voxel object should be changed is not limited to this. The densities of voxels of the another voxel object may also be changed. For example, when the fragment object 260 comes into contact with the region 252 of the terrain object formed of the lava material, the densities of voxels of the lava material may be reduced in addition to changing of the material. As a result, a situation can be represented in which a portion of a terrain object formed of the lava material is cooled and reduced by the fragment object 260 formed of the ice material being in contact therewith.

In addition, as with the in-game effect produced by the shout object 253, the in-game effect of changing at least one of the densities and materials of voxels corresponding to an update range set by the first player character 201 throwing a fragment object may be produced. For example, the game system 1 may produce one of a plurality of in-game effects including at least the following, depending on the type of a material of a fragment object.
Reduction of the densities of voxels in voxel data corresponding to an update range set by collision determination with the fragment object
Increase of the densities of voxels in voxel data corresponding to an update range set by collision determination with the fragment object, and setting a material of the voxels to a predetermined material
Changing of materials of voxels in voxel data corresponding to an update range into a predetermined material in the case of a predetermined combination of a material of a determination mesh at a collision position with the fragment object, and a material of the fragment object

In addition, as described above, in the present example, an operation input can be provided in an operation embodiment varying depending on the types of controllers used by the first and second users. FIG. 37 shows an example of operation instructions corresponding to operation inputs of each controller used by the first user. FIG. 38 shows an example of operation instructions corresponding to operation inputs of each controller used by the second user.

In FIG. 37, when the first user operates the left controller 3 alone in a landscape orientation, the movement speed and movement direction of a first player character 201 are controlled based on the first user's operation input for tilting the analog stick 32 (left analog stick). As a result, the movement of a second player character 204 sitting on a portion of the first player character 201 is controlled together with the movement of the first player character 201, and therefore, the movement speed and movement direction of the second player character 204 are also controlled. The first player character 201 is caused to perform the punching action, based on the first user's operation input for pressing down the upward button (operation button 35). The first player character 201 is caused to perform the pulling-out action, lifting action, or throwing action, depending on the situation of the first player character 201, based on the first user's operation input for pressing down the SR button (operation button 44). The light-of-sight direction of the virtual camera and the position indicated by the aiming point T are controlled based on the first user's operation input for tilting the analog stick 32 (left analog stick) while pressing down the L button (operation button 38).

When the first user operates the right controller 4 alone in a landscape orientation, the movement speed and movement direction of the first player character 201 are controlled based on the first user's operation input for tilting the analog stick 52 (right analog stick). As a result, the movement speed and movement direction of the second player character 204 are also controlled. The first player character 201 is caused to perform the punching action, based on the first user's operation input for pressing down the B button (operation button 54). The first player character 201 is caused to perform the pulling-out action, lifting action, or throwing action, depending on the situation of the first player character 201, based on the first user's operation input for pressing down the SR button (operation button 66). The light-of-sight direction of the virtual camera and the position indicated by the aiming point T are controlled based on the first user's operation input for tilting the analog stick 52 (right analog stick) while pressing down the R button (operation button 60).

When the first user operates a set of the left controller 3 and the right controller 4 or operates the second controller 7, the movement speed and movement direction of the first player character 201 are controlled based on the first user's operation input for tilting the analog stick 32 (left analog stick). As a result, the movement speed and movement direction of the second player character 204 are also controlled. The first player character 201 is caused to perform the punching action, based on the first user's operation input for pressing down the Y button (e.g., the operation button 56). The first player character 201 is caused to perform the pulling-out action, lifting action, or throwing action, depending on the situation of the first player character 201, based on the first user's operation input for pressing down the ZR button (e.g., the operation button 61). The light-of-sight direction of the virtual camera and the position indicated by the aiming point T are controlled based on the first user's operation input for tilting the analog stick 52 (right analog stick).

In FIG. 38, when the second user operates the right controller 4 alone in a portrait orientation, the position where the cursor C is displayed is controlled based on the second user's operation input using the mouse function of the right controller 4 or the second user's operation input using the inertial sensors for detecting the motion and orientation of the entire right controller 4. A material of the shout object 253 is set based on the second user's operation input for long-pressing the ZR button (operation button 61). The shout object 253 is emitted in the game space based on the second user's operation input for pressing down the ZR button (operation button 61). The light-of-sight direction of the virtual camera and the position indicated by the aiming point T are controlled based on the second user's operation input for tilting the analog stick 52 (right analog stick).

When the second user operates the left controller 3 alone in a portrait orientation, the position where the cursor C is displayed is controlled based on the second user's operation input using the mouse function of the left controller 3 or the second user's operation input using the inertial sensors for detecting the motion and orientation of the entire left controller 3. A material of the shout object 253 is set based on the second user's operation input for long-pressing the ZL button (operation button 39). The shout object 253 is emitted in the game space based on the second user's operation input for pressing down the ZL button (operation button 39). The light-of-sight direction of the virtual camera and the position indicated by the aiming point T are controlled based on the second user's operation input for tilting the analog stick 32 (left analog stick).

When the second user operates a set of the left controller 3 and the right controller 4, the position where the cursor C is displayed is controlled based on the second user's operation input for tilting the analog stick 32 (left analog stick) or the second user's operation input using the mouse function of the right controller 4. A material of the shout object 253 is set based on the second user's operation input for long-pressing the ZR button (operation button 61). The shout object 253 is emitted in the game space based on the second user's operation input for long-pressing the ZR button (operation button 61). The light-of-sight direction of the virtual camera and the position indicated by the aiming point T are controlled based on the second user's operation input for tilting the analog stick 52 (right analog stick).

When the second user operates the second controller 7, the position where the cursor C is displayed is controlled based on the second user's operation input for tilting the left analog stick or the second user's operation input using the inertial sensors for detecting the motion and orientation of the entire second controller 7. A material of the shout object 253 is set based on the second user's operation input for long-pressing the ZR button. The shout object 253 is emitted in the game space based on the second user's operation input for pressing the ZR button. The light-of-sight direction of the virtual camera and the position indicated by the aiming point T are controlled based on the second user's operation input for tilting the right analog stick.

It can be considered that the position of the virtual camera in the game space is controlled based on the first user's operation input for controlling the movement of the first player character 201, since the virtual camera is moved so as to follow the first player character 201 (and the second player character 204). Meanwhile, according to the above operation instructions, the movement direction of the virtual camera can be controlled by either the first user's operation input or the second user's operation input. In the present example, when both of these operation inputs are performed, control by one of the operation inputs may be given higher priority. As an example, when both of the operation inputs are performed, control of the light-of-sight direction of the virtual camera by the operation input performed earlier may be given higher priority, and after the end of the operation input performed earlier, control of the light-of-sight direction of the virtual camera may be performed based on the other operation input. As another example, when both of the operation inputs are performed, control of the light-of-sight direction of the virtual camera based on a predetermined one of the operation inputs (e.g., the second user's operation input) may be given higher priority, and when the operation input given higher priority is not performed, control of the light-of-sight direction of the virtual camera may be performed based on the other operation input. In another example, control of the light-of-sight direction of the virtual camera may be performed based on only one of the first user's operation input and the second user's operation input. For example, control of the position of the virtual camera can be performed based on the first user's operation input, but not the light-of-sight direction of the virtual camera (e.g., only control based on the second user's operation input is allowed). In that case, the light-of-sight direction of the virtual camera and the position of the cursor C are controlled based on the second user's operation input, and therefore, it is easier to aim the shout object 253 in cooperation with the first user.

Thus, in the present example, the motions of the first player character 201 and the second player character 204 are controlled in accordance with the first and second users'operations, each of which is performed on the respective one of the two controllers. In addition, the movements of both of the first player character 201 and the second player character 204 are controlled by operation of one of the controllers, and therefore, the first and second users can play in cooperation with each other.

In addition, concerning the above operation instructions, in an operation embodiment in which a controller used for operation is provided with two analog sticks, different operation instructions are assigned to the tilt operations of the different analog sticks. Meanwhile, in an operation embodiment in which a controller used for operation is provided with a single analog stick, the above assignment is not allowed, and therefore, different operations are assigned to different operation instructions. Specifically, in the first user's operation embodiment, different operation instructions are assigned, depending on whether or not the operation of pressing down a predetermined operation button is simultaneously performed. In addition, in the second user's operation embodiment, different operation instructions are assigned to operations using the mouse function or inertial sensors instead of the operation of tilting an analog stick. Thus, in the present example, an appropriate operation instruction is assigned, depending on an operation embodiment used by the user, and an intuitive user operation can be performed when different controllers are used.

In addition, when at least one of an operation using the mouse function of a controller operated by the second user, an operation using an inertial sensor, and an operation using a direction input unit (e.g., an analog stick) is allowed, the cursor C can be controlled based on one of these operations. Therefore, in the present example, the cursor C can be controlled in various operation embodiments. Therefore, the second user that plays in cooperation with the first user can select an appropriate operation embodiment.

It should be noted that in the above examples, the posture and orientation of the second player character 204 when the second player character 204 emits the shout object 253 are not particularly limited. For example, the posture and orientation of the second player character 204 may be changed such that the second player character 204 views a position in the game space that is indicated by the cursor C and is the destination of the shout object 253. The posture and orientation of the second player character 204 may be controlled irrespective of the position. In addition, the object for which a material acquired at a specific position on a determination mesh of a terrain object is set is not particularly limited. In addition, before the shout object 253 is set or when an operation for emitting the shout object 253 is performed with the number of remaining shots being already zero, a predetermined object formed of a predetermined material, a material present around the second player character 204, or the like may be emitted from the second player character 204.

### 3. Specific Example of Processing in Game System

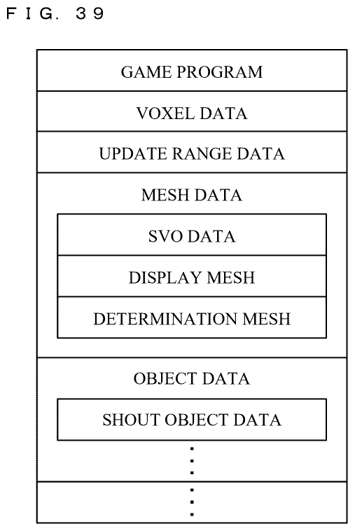

Next, a specific example of information processing in the game system 1 will be described with reference to FIGS. 39 to 42.

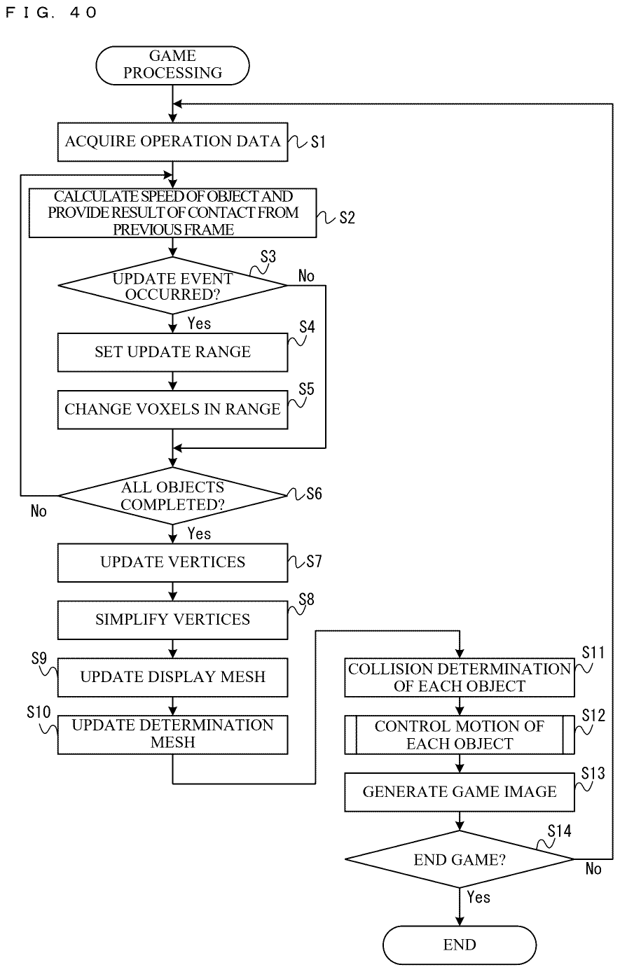

FIG. 39 shows an example of various data used for information processing in the game system 1. The data shown in FIG. 39 are stored in a memory (e.g., the flash memory 84, the DRAM 85, and/or a memory card attached to the slot 23) that is accessible by the main body apparatus 2. As shown in FIG. 39, the game system 1 stores a game program therein. The game program is a program for executing game processing (e.g., game processing shown in FIGS. 40 to 42) in the present example. The game program includes the aforementioned material data (see FIG. 13). In the memory, the aforementioned voxel data (see FIG. 12), update range data, mesh data, object data, and the like (see FIG. 39).

The update range data is data indicating the aforementioned update range. In the present example, the update range is represented by the aforementioned SDF.

The mesh data includes various data regarding meshes of a voxel object. As shown in FIG. 39, in the present example, the mesh data includes SVO data, display mesh data, and determination mesh data. The SVO data is data in which vertices calculated from the voxel data are held by the aforementioned SVO structure. In the present example, the SVO data includes data indicating materials set for the vertices (e.g., data indicating IDs of the materials) in addition to data indicating the positions of the vertices. The display mesh data includes various data regarding a display mesh. Specifically, the display mesh data includes data indicating vertices of the display mesh, and data indicating materials set for the vertices (e.g., data indicating IDs of the materials). The determination mesh data includes various data regarding a determination mesh. Specifically, the determination mesh data includes data indicating vertices of the determination mesh, and data indicating materials set for the vertices (data indicating IDs of the materials).

The object data includes various data regarding objects (e.g., the player character, the virtual object, etc.) other than the voxel object. The object data is stored for each object that appears in the game space. The object data includes data indicating, for example, the position, speed, state, etc., of the object. The object data includes shout object data. The shout object data indicates a set material, the number of remaining shots, and the type, position, speed, state, and the like of an emitted shout object.

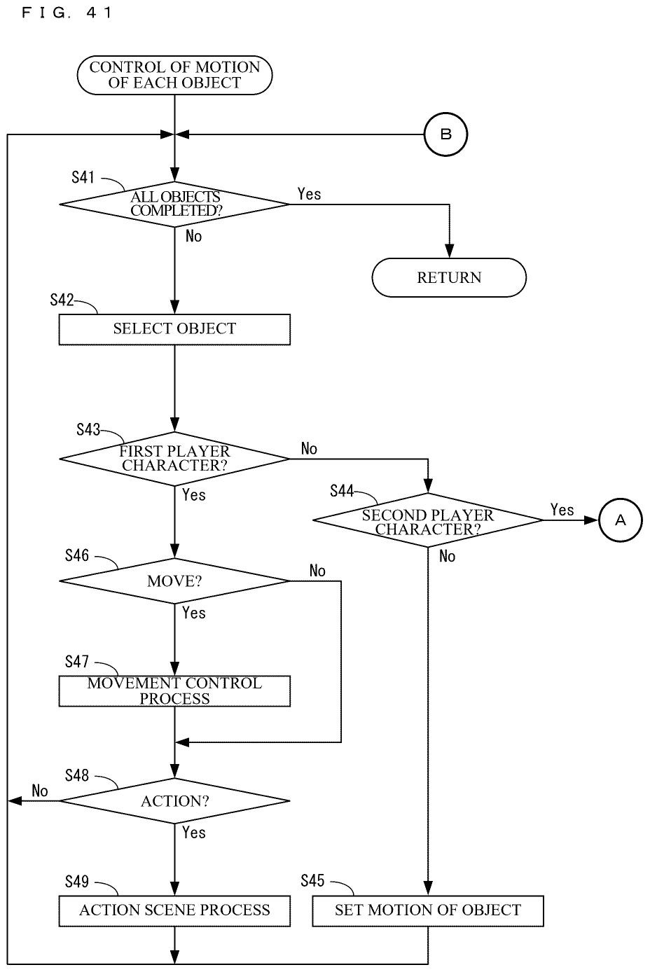

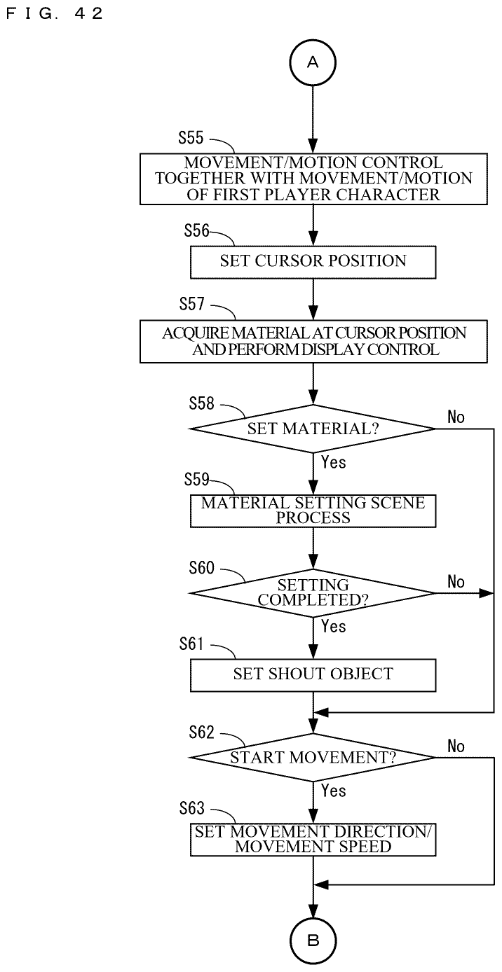

FIG. 40 is a flowchart showing an example of a flow of game processing executed by the game system 1. In addition, FIG. 41 is a subroutine showing an example of a first half of a process of controlling a motion of each object executed in step S12 of FIG. 40. FIG. 42 is a subroutine showing an example of a second half of the process of controlling a motion of each object executed in step S12 of FIG. 40. Execution of the game processing is started in response to the game having been started according to an instruction of the user, during execution of the game program, for example. A processing loop composed of a series of processes in steps S1 to S14 is performed in a cycle of once for each frame.

In the present example, the processor 81 of the main body apparatus 2 executes the game program stored in the game system 1 to execute processes in steps shown in FIGS. 40 to 42. However, in other examples, a portion of the processes in the steps may be executed by a processor (e.g., a dedicated circuit or the like) other than the processor 81. Further, if the game system 1 is communicable with another information processing apparatus (e.g., a server), a portion of the processes in the steps shown in FIGS. 40 to 42 may be executed by the other information processing apparatus. The processes in the steps shown in FIGS. 40 to 42 are merely examples, and the processing order of the steps may be changed, or another process may be executed in addition to (or instead of) the processes in the steps as long as similar results can be obtained.

The processor 81 executes the processes in the steps shown in FIGS. 40 to 42 by using a memory (e.g., the DRAM 85). That is, the processor 81 stores information (in other words, data) obtained in each process step, into the memory, and reads out the information from the memory when using the information for the subsequent process steps.

In FIG. 40, the processor 81 acquires the operation data indicating an operation input performed by the user (step S81), and proceeds to the next step. For example, the processor 81 acquires the operation data output from each of the controller operated by the first user and the controller operated by the second user via the controller communication section 83 and/or the terminals 17 and 21 (see FIG. 8) or the operation data output from the main body apparatus 2 (e.g., the touch panel 13).

Next, the processor 81 designates, as a processing target, an object for which processing has not yet been completed (including a voxel object defined in the specific voxel space) among objects to be processed in the game space, and executes, for the designated object, a process of calculating a speed, and a process of providing (e.g., reflecting) a result of contact between objects in a previous frame (step S2), and proceeds to the next step. The speed of the object is used for calculating the position of the object in the current frame, in the process of step S12 described below. For example, if the designated object is a first player character, the speed of the first player character is calculated based on the operation data acquired in step S1. If the designated object is a second player character, the speed of the second player character is calculated such that the second player character can move together with the first player character. If the designated object is an object (e.g., a shout object or fragment object) that is not operated by the user, the speed of the object is calculated based on a rule prescribed in the game program. For example, the speed of a fragment object is set to zero if the fragment object is disposed on the terrain object and does not move, is set to the same speed as that of the player character if the fragment object is held by the player character, and is set to a speed that has a magnitude determined according to the rule and at which the fragment object moves in a direction based on the position indicated by the aiming point T if the fragment object has been thrown by a throwing action of the player character. In addition, the speed of the shout object is set to a speed at which movement is continued after start of the movement based on a movement direction and movement speed set in step S53 described below. Specifically, the speed of the object is calculated based on a virtual physical calculation including interaction between objects. For example, repulsion due to a collision between objects, interaction such as friction due to contact, falling due to virtual gravity, deceleration due to virtual air resistance, or the like is provided in determination of the speed.

The process of providing the result of contact between objects in the previous frame includes a process of, when determining in the collision determination (step S11 described below) that objects have come into contact with each other, giving an influence due to the contact, to the objects. Examples of this process are as follows.
A process of reducing the hit points of the first player character when determining that the first player character has come into contact with the terrain object of lava in the previous frame.
A process of generating a fragment object when determining that the first player character has come into contact with the terrain object due to the pulling-out action, punching action or the like in the previous frame.

When the state regarding an object has been changed in the process in step S2, the processor 81 updates the corresponding object data stored in the memory regarding the object such that the object data indicates the changed content.

Next, the processor 81 determines whether or not an update event that updates the voxel object has been caused by the object designated in step S2 (step S3). For example, the determination in step S3 is performed based on the result of collision determination (step S11 described below) in the previous frame. As an example, if it is determined that in the previous frame, the first player character has come into contact with a terrain object due to the pulling-out action, punching action, or the like, it is determined that an update event in which a portion of the terrain object is deleted has occurred (see FIGS. 33 and 34). As another example, if it is determined that in the previous frame, a shout object or fragment object has collided with a terrain object, an in-game effect is determined based on materials or the like of both of the objects at the collision position, and it is determined that an update event based on the in-game effect (see FIGS. 27 to 32, 35, and 36) has occurred. When the update event has occurred, the processor 81 proceeds to step S4. When the update event has not occurred, the processor 81 proceeds to step S6.

In step S4, the processor 81 sets, in the game space, an update range in which update of the voxel object is performed, and proceeds to the next step. For example, the specific content (e.g., position, shape, and size) of the update range is associated with each of the types of update events in the game program. In step S4, the update range is set so as to have the content associated with the type of the update event that has been determined in step S3 to occur. In step S4, the processor 81 stores data indicating the set update range, as update range data in the memory.

Next, the processor 81 changes the voxels corresponding to the update range set in step S4, according to the update event (step S5), and proceeds to step S6. For example, in performing deformation such that a voxel object in the update range is deleted or downsized or a voxel object is added in the update range, the processor 81 updates the voxel data stored in the memory so as to change the densities of the voxels corresponding to the update range (see the above [2-2. Update of voxel data] and [2-7. Process using object for which material on mesh is set]). In addition, in changing the material of the voxel object in the update range, the processor 81 updates the voxel data stored in the memory so as to update at least one of the first material ID, the second material ID, and the material mixing ratio of the voxels corresponding to the update range (see [2-7. Process using object for which material on mesh is set]).

In step S6, the processor 81 determines whether or not all the objects to be processed (including a voxel object defined in the specific voxel space) have been subjected to the processes in step S2 to S5. When all the objects have been processed, the processor 81 proceeds to step S7. When not all the objects have been processed, the processor returns to and repeats step S2.

In step S7, the processor 81 updates the vertices of the voxel object in the game space, and proceeds to the next step. For example, when the voxel data has been updated in the process in step S5, the processor 81 calculates new vertices based on the updated voxel data. The positions of the new vertices are calculated according to the method described in [2-3. Calculation of vertices]. In addition, materials of the new vertices are calculated according to the method described in [2-4. Determination of material of vertex].

Next, the processor 81 performs simplification for the vertices (step S8), and proceeds to the next step. For example, the processor 81 performs simplification for the vertices updated in the process in step S7, according to the method described in [2-5. Simplification of vertices]. Thereafter, the processor 81 updates the SVO data stored in the memory is updated so as to indicate the vertices obtained through the processes in steps S7 and S8. The processes in steps S7 and S8 may not necessarily calculate new vertices for the entirety of the voxel data, and may be performed only for the part in which the content of the voxels has been changed in the process in step S5.

Next, the processor 81 updates the display mesh of the voxel object, based on the SVO data stored in the memory (step S9), and proceeds to the next step. The positions of the vertices of the display mesh and the materials of the polygons in the display mesh (e.g., the materials set for the vertices of the polygons) are calculated according to the method described in [2-6. Generation of mesh] and [2-6-1. Determination of material of display mesh]. In step S9, the processor 81 updates the display mesh data stored in the memory so as to indicate the positions and materials of the vertices of the updated display mesh. The processor 81 may start the process in step S10 and subsequent steps described below without waiting for completion of step S9 to execute these steps in parallel with step S9. In that case, step S9 needs to be completed before start of step S13 described below.

Next, the processor 81 updates the determination mesh of the voxel object, based on the SVO data stored in the memory (step S10), and proceeds to the next step. The positions of the vertices of the determination mesh and the materials of the polygons in the determination mesh (e.g., the materials set for the vertices of the polygons) are calculated according to the method described in [2-6. Generation of mesh] and [2-6-2. Determination of material of determination mesh]. In step S10, the processor 81 updates the determination mesh data stored in the memory so as to indicate the positions and materials of the vertices of the updated determination mesh.

In the example shown in FIG. 40, the determination mesh generation process in step S10 is executed for each frame, but the determination mesh generation process may not necessarily be executed for each frame. For example, in the case where the collision determination process in step S11 described below is executed only for a frame that satisfies a predetermined condition, the processor 81 may execute the determination mesh generation process in the frame in which the collision determination is performed. In addition, the processor 81 may execute the determination mesh generation process for voxels in a region, in the game space, where the collision determination in step S11 is performed. For example, in a situation where, in the game space, an object to be subjected to collision determination does not exist around the player character, except for a voxel object (e.g., a situation where only collision determination between the player character and the neighboring voxel object needs to be performed), the processor 81 may execute the determination mesh generation process for voxels within a predetermined range based on the player character.

Next, the processor 81 performs collision determination for each object in the game space, based on the determination mesh data and the object data stored in the memory (step S11), and proceeds to the next step. For example, the processor 81 performs collision determination by using a determination mesh for a voxel object, and using, for an object that is not a voxel object, a determination region having a predetermined shape, which is set for the object. In the present example, the collision determination in step S11 is performed in consideration of the speed calculated in step S2. That is, the processor 81 performs collision determination by using, as the position of each object, the position to which the object moves at the speed.

In the present example, presence/absence of the following contacts is determined by the collision determination in step S11.
Contact of the first player character with the terrain object when the first player character moves or performs a punching action or the like
Contact of the first player character with the fragment object when the first player character performs an action of lifting a fragment object
Contact of a fragment object thrown by the throwing action of the first player character, with the terrain object
Contact of a shout object emitted from the second player character, with the terrain object When the result of the collision determination in step S11 is that the objects have come into contact with each other, a process of determining (e.g., generating) the result of the contact of the objects is performed in step S2 in the next frame, or it is determined in step S3 in the next frame that an update event has occurred.

Next, the processor 81 controls a motion of each object in the game space (step S12), and proceeds to step S13. A process of controlling a motion of each object that is performed in step S12 will be described below with reference to FIG. 41 and FIG. 42.

In FIG. 41, the processor 81 determines whether or not the control process has been completed on all objects to be subjected to the motion control (step S41). If there is one of the objects on which the control process has not been completed, the processor 81 proceeds to step S42. Otherwise, i.e., if the control process has been completed on all of the objects, the processor 81 ends the subroutine.

In step S42, the processor 81 selects an object to be subjected to the motion control from objects on which the motion control has not been complete, and proceeds to the next step.

Next, the processor 81 determines whether or not the object currently selected as one to be subjected to the motion control process is the first player character (step S43). If the object currently selected as one to be subjected to the motion control process is not the first player character, the processor 81 proceeds to step S44. Otherwise, i.e., if the object currently selected as one to be subjected to the motion control process is the first player character, the processor 81 proceeds to step S46.

In step S44, the processor 81 determines whether or not the object currently selected as one to be subjected to the motion control process is the second player character (step S43). If the object currently selected as one to be subjected to the motion control process is not the second player character, the processor 81 proceeds to step S45. Otherwise, i.e., if the object currently selected as one to be subjected to the motion control process is the second player character, the processor 81 proceeds to step S55 (see FIG. 42).

In step S45, the processor 81 controls a motion of the object currently selected as one to be subjected to the motion control process, and returns to and repeats to step S41. In a single process in step S45, as for a motion that is performed over a plurality of frames, the processor 81 controls each object so as to progress the motion for one frame. As a result, by the process in step S45 being repeatedly executed over a plurality of frames, each object performs a series of motions regarding movement and various actions. The position of each object is basically determined to be the position after the object has moved with the speed calculated in step S2. However, in the case where an object is determined to come into contact with another object by the collision determination in step S11 and movement of this object is prevented by the other object, the position of the object may be determined not to be changed. In step S45, the processor 81 updates the object data stored in the memory so as to have the content indicating the object after the control in step S45.

Meanwhile, if it is determined that the object that has been selected as one to be subjected to the motion control in step S43 is the first player character, the processor 81 determines, in step S46, whether or not to move the first player character in the game space. For example, the processor 81 looks up the operation data acquired in step S1. If the operation input from a controller operated by the first user is an operation instruction to move the first player character, the result of the determination in step S46 is positive. If the processor 81 determines to move the first player character, the processor 81 proceeds to step S47. Otherwise, if the processor 81 does not determine to move the first player character, the processor 81 proceeds to step S48.

In step S47, the processor 81 executes a movement control process on the first player character, and proceeds to step S48. For example, the processor 81 looks up the operation data acquired in step S1, and causes the first player character to move in the game space based on an operation input from a controller operated by the first user. In addition, the processor 81 generates, in the game space, a determination region for collision determination that depends on the position and posture of the first player character after the movement. Thereafter, the processor 81 updates the object data stored in the memory such that the object data indicates the object that has been controlled in step S47.

In step S48, the processor 81 determines whether or not to cause the first player character to perform a specific action in the game space. As an example, the processor 81 looks up the operation data acquired in step S1, and if an operation input from a controller operated by the first user is an operation instruction to cause the first player character to perform a specific action, the result of the determination in step S48 is positive. If the processor 81 causes the first player character to perform a specific action, the processor 81 proceeds to step S49. Otherwise, i.e., if the processor 81 does not cause the first player character to perform a specific action, the processor 81 returns to and repeats step S41.

In step S49, the processor 81 executes an action scene process on the first player character, and returns to and repeats step S41. For example, the processor 81 performs control to cause the first player character to perform various actions (e.g., the pulling-out action shown in FIG. 33, the punching action shown in FIG. 34, the throwing action shown in FIGS. 35 and 36, etc.), based on the operation data acquired in step S1. If a predetermined action has occurred, the processor 81 generates, in the game space, a determination region for collision determination depending on the action. In addition, the processor 81 performs control to move a fragment object in a direction based on a position in the game space indicated by an aiming point T set in step S13 described below in response to the fragment object being thrown due to the first player character's throwing action. It should be noted that in a single process in step S49, as for a motion of an action of the first player character that is performed over a plurality of frames, the processor 81 controls the first player character so as to progress the motion for one frame.

Referring to FIG. 42, in step S55, the processor 81 controls a motion of the second player character such that the movement and motion of the second player character are performed together with the movement and motion of the first player character, and proceeds to the next step. It should be noted that in a single process in step S55, as for a motion that is performed over a plurality of frames (e.g., a motion of the first player character is performed over a plurality of frames), the processor 81 controls the movement and motion of the second player character so as to progress the motion for one frame. In addition, the processor 81 generates, in the game space, a determination region for collision determination depending on the position and posture of the second player character after the movement and motion. It should be noted that as described above, the determination region for collision determination for the second player character may be omitted. In step S55, the processor 81 updates the object data stored in the memory such that the object data indicates the second player character after the control in step S55.

Next, the processor 81 sets the position of the cursor C (see FIGS. 26, 27, 29, and 30) (step S56), and proceeds to the next step. For example, the processor 81 looks up the operation data acquired in step S1, and if an operation input from a controller operated by the second user is an operation instruction to change the position of the cursor C, the position of the cursor C is changed based on the operation input. It should be noted that the process of setting the position of the cursor C in step S56 is executed in accordance with the method described in [2-7. Process using object for which material on mesh is set].

Next, the processor 81 performs control to acquire a material at a position in the game space corresponding to the position of the cursor C, and display the material in the vicinity of the cursor C (step S57), and proceeds to the next step. It should be noted that the process of acquiring and displaying a material in step S57 is executed in accordance with the method described in [2-7. Process using object for which material on mesh is set] based on contents set in the shout object data.

Next, the processor 81 determines whether or not to set a material of a shout object (step S57). For example, the processor 81 looks up the operation data acquired in step S1, and if an operation input from a controller operated by the second user is an operation instruction to set a material, the result of the determination in step S57 is positive. If the processor 81 determines to set a material, the processor 81 proceeds to step S59. Otherwise, i.e., if the processor 81 does not determine to set a material, the processor 81 proceeds to step S62.

In step S58, the processor 81 generates a scene in which a material of a shout object is set, and proceeds to the next step. For example, the processor 81 generates a scene in which an amount indicated by the gauge displayed inside the cursor C is increased by a predetermined amount (see the lower diagram of FIG. 26 and the lower diagram of FIG. 29).

Next, the processor 81 determines whether or not the process of setting a material of a shout object has been completed (step S60). For example, if the period of time for which the second user's operation input indicating an operation instruction to set a material has reached a predetermined period of time, the result of the determination by the processor 81 in step S60 is positive. If the process of setting a material has been completed, the processor 81 proceeds to step S61. Otherwise, i.e., if the process of setting a material has not been completed, the processor 81 proceeds to step S62.

In step S61, the processor 81 sets a shout object, and proceeds to step S62. It should be noted that the process of setting a shout object in step S61 is executed in accordance with the method described in [2-7. Process using object for which material on mesh is set]. In step S61, the processor 81 updates the shout object data in the object data stored in the memory based on the contents set in step S61 (the set material, the number of remaining shots, etc.).

In step S62, the processor 81 determines whether or not an operation of starting movement of the shout object has been performed. For example, the processor 81 looks up the operation data acquired in step S1, and if an operation input from a controller operated by the second user is an operation instruction to emit a shout object (e.g., an operation instruction to cause the second player character to perform a shouting action for emitting a shout object), the result of the determination in step S62 is positive. If an operation of starting movement of the shout object has been performed, the processor 81 proceeds to step S63. Otherwise, i.e., if an operation of starting movement of the shout object has not been performed, the processor 81 returns to and repeats step S41 (see FIG. 41).

In step S63, the processor 81 sets the movement direction and movement speed of the emitted shout object, and returns to and repeats step S41 (see FIG. 41). For example, the processor 81 sets a shout object made of a material set in the shout object data, calculates the movement speed based on a rule previously determined in a game program, and calculates the movement direction based on the direction from a predetermined position in the vicinity of the position where the second player character emits the shout object toward the position in the game space indicated by the cursor C. In addition, the processor 81 reduces the number of remaining shots set in the shout object data by one. In step S63, the processor 81 updates the shout object data in the object data stored in the memory based on contents set in step S63 (the type, position, speed, and state of the emitted shout object, the number of remaining shots, etc.). It should be noted that if a shout object has not been set in the shout object data or the number of remaining shots is already zero, the processor 81 may set a predetermined object made of a predetermined material, a material present around the second player character, or the like, set the movement direction and movement speed of the predetermined object, and update the shout object data. In that case, the second player character emits a predetermined object.

Referring back to FIG. 40, after step S12, the processor 81 generates a game image (step S13), and proceeds to the next step. For example, the processor 81 generates a game image by performing rendering, based on the virtual camera, for the polygons of the display mesh of the voxel object, and the polygons of objects other than the voxel object. The polygons of the display mesh are rendered by using rendering setting such as textures corresponding to materials set for the polygons, according to the method described in [2-6-1. Determination of material of display mesh]. The game image generated in step S13 is outputted to the display device and displayed in a cycle of once for each frame.

It should be noted that the position of the virtual camera set for generating the game image may be a predetermined position that follows the first player character. In addition, the light-of-sight direction of the virtual camera may be controlled based on an operation input from a controller operated by the first or second user (see FIGS. 37 and 38).

In addition, in step S13, the processor 81 causes the cursor C set in step S12 (see FIGS. 26, 27, 29, and 30) to overlay the game image, and outputs the resultant game image to the display device. In addition, if the condition under which the aiming point T (see FIG. 35) is displayed is satisfied, the processor 81 sets the aiming point T at a predetermined position in the display screen, acquires a material at a position in the game space that is displayed, overlaying the position of the aiming point T, causes the aiming point T, in the vicinity of which the name of the material is attached, to overlay the game image, and outputs the resultant game image to the display device.

Next, the processor 81 determines whether or not to end the game (step S14). For example, when a predetermined operation input to end the game has been performed by the user or when a condition for ending the game is satisfied, the determination result in step S14 is positive. When the processor 81 determines to end the game, the processor 81 ends the flowchart. When the processor 81 does not determine to end the game, the processor returns to and repeats step S1. Thereafter, a series of processes in steps S1 to S14 is repeatedly executed until the processor 81 determines to end the game in step S14.

Thus, in the present example, a material at a specific position on a determination mesh of a terrain object is acquired, and a shout object for which the material is set is caused to collide with the terrain object, so that an in-game effect can be produced based on interaction between the shout object and the determination mesh of the terrain object. Therefore, in the present example, a material set for an object using voxel data can be further utilized in a game.

Although in the foregoing description, an example has been described in which a voxel object is specified by generating a three-dimensional mesh based on voxel data set for voxels in a three-dimensional space, a voxel object may be specified based on voxel data set for two-dimensional voxels.

It should be noted that the information processing apparatus 1 may be any suitable apparatus, including handheld game apparatuses, personal digital assistants (PDAs), mobile telephones, smartphones, personal computers, cameras, tablet computers, and the like. In that case, an input apparatus for performing a user operation of moving a player character or the like may not be the left controller 3, the right controller 4, the touch panel 13, or the like, and may be other controllers, a mouse, a touch pad, a touch panel, a trackball, a keyboard, a directional pad, a slide pad, or the like.

In the foregoing, each information process (game process) is performed in the game system 1 by way of example. Alternatively, at least a portion of the process steps may be performed in another apparatus. For example, when the information processing apparatus 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the information processing apparatus 1 executing predetermined programs. Alternatively, all or a portion of the above processes may be performed by a dedicated circuit included in the information processing apparatus 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the information processing apparatus 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

Thus, the present example is useful as a game program, game system, game processing method, game apparatus, and the like in which a material set for an object using voxel data can be further utilized in a game.

What is claimed is:

1. One or more non-transitory computer-readable storage media having stored therein instructions that, when executed, cause an information processing system to perform operations comprising:
generating and updating a mesh based on voxel data defined in a virtual space, wherein the mesh is a mesh of a voxel object related to the voxel data, wherein in the voxel data, for each of a plurality of voxels, at least a density indicating the degree of virtual occupation of a content in a space defined by the voxel, and a material indicating the type of the content, are set, and wherein vertex coordinates of the mesh are determined based on at least the density, and a material of the mesh is determined based on at least the material included in the voxel data;
controlling a position of a first cursor based on an operation input from a first operation device;
identifying a material of the mesh at a position in the virtual space related to the position of the first cursor according to a first instruction based on an operation input from the first operation device, wherein the identified material is a first material;
moving a first object for which the first material is set, toward the position in the virtual space related to the position of the first cursor, according to a second instruction based on an operation input from the first operation device; and
setting a first voxel update range at a collision position based on collision determination between the first object and the mesh, and producing a first in-game effect including a change in at least one of the densities and materials of voxels in the voxel data related to the first voxel update range.

2. The one or more non-transitory computer-readable storage media according to claim 1, wherein
the operations further comprise:
controlling movement of the first player character in the virtual space based on an operation input from a second operation device;
controlling movement of the second player character together with the movement of the first player character;
causing the first player character to perform a first action according to a third instruction based on an operation input from the second operation device; and
causing the second player character to perform a second action, and moving the first object, according to the second instruction.

3. The one or more non-transitory computer-readable storage media according to claim 2, wherein
the operations further comprise:
controlling a position of a virtual camera in the virtual space based on a position of the first player character; and
controlling an orientation of the virtual camera based on at least an operation input from the first operation device.

4. The one or more non-transitory computer-readable storage media according to claim 3, wherein
the operations further comprise:
controlling the orientation of the virtual camera, additionally based on an operation input from the second operation device.

5. The one or more non-transitory computer-readable storage media according to claim 2, wherein
the operations further comprise:
controlling a position of a second cursor;
causing the first player character to perform the first action, and moving a second object for which a second material is set toward a position in the virtual space related to the position of the second cursor, according to the third instruction; and
setting a second voxel update range at a collision position based on collision determination between the second object and the mesh, and producing a second in-game effect including a change in at least one of the densities and materials of voxels in the voxel data related to the second voxel update range.

6. The one or more non-transitory computer-readable storage media according to claim 1, wherein
the operations further comprise:
producing, as the first in-game effect, one of a plurality of effects including at least
an effect of reducing the densities of voxels in the voxel data related to the first voxel update range,
an effect of increasing the densities of the voxels in the voxel data related to the first voxel update range and setting the materials of the voxels in the voxel data related to the first voxel update range to the first material, and
an effect of, when a third material that is a material of the mesh at the collision position and the first material are a first combination, changing the materials of the voxels in the voxel data related to the first voxel update range to a fourth material,
depending on the type of the first material.

7. The one or more non-transitory computer-readable storage media according to claim 1, wherein
the operation input from the first operation device includes at least one of data based on a mouse, data based on an inertial sensor, and direction input data, and
the operations further comprise:
controlling the position of the first cursor based on at least one of the d based on a mouse, the data based on an inertial sensor, and the direction input data.

8. The one or more non-transitory computer-readable storage media according to claim 1, wherein
the mesh is a determination mesh used in the collision determination, and
the operations further comprise:
generating or updating a display mesh related to the voxel data and to be rendered based on a virtual camera, by determining vertex coordinates of the display mesh based on at least the density included in the voxel data, and determining a material of the display mesh based on at least the material included in the voxel data; and
rendering the virtual space including the display mesh based on the vertex coordinates of the display mesh and a texture related to the material of the display mesh.

9. The one or more non-transitory computer-readable storage media according to claim 1, wherein
the operations further comprise:
rendering the virtual space including the mesh based on the vertex coordinates of the mesh and a texture related to the material of the mesh.

10. A game system comprising:
one or more processors;
a first operation device; and
one or more memories storing instructions to perform operations comprising:
generating and updating a mesh based on voxel data defined in a virtual space, wherein the mesh is a mesh of a voxel object related to the voxel data, wherein in the voxel data, for each of a plurality of voxels, at least a density indicating the degree of virtual occupation of a content in a space defined by the voxel, and a material indicating the type of the content, are set, and wherein vertex coordinates of the mesh are determined based on at least the density, and a material of the mesh is determined based on at least the material included in the voxel data;
controlling a position of a first cursor based on an operation input from a first operation device;
identifying a material of the mesh at a position in the virtual space related to the position of the first cursor according to a first instruction based on an operation input from the first operation device, wherein the identified material is a first material;
moving a first object for which the first material is set, toward the position in the virtual space related to the position of the first cursor, according to a second instruction based on an operation input from the first operation device; and
setting a first voxel update range at a collision position based on collision determination between the first object and the mesh, and producing a first in-game effect including a change in at least one of the densities and materials of voxels in the voxel data related to the first voxel update range.

11. The game system according to claim 10, further comprising:
a second operation device,
wherein the operations further comprise:
controlling movement of the first player character in the virtual space based on an operation input from a second operation device;
controlling movement of the second player character together with the movement of the first player character;
causing the first player character to perform a first action according to a third instruction based on an operation input from the second operation device; and
causing the second player character to perform a second action, and moving the first object, according to the second instruction.

12. The game system according to claim 11, wherein
the first operation device includes at least a first direction input unit, and is configured to output first direction input data based on an input to the first direction input unit, and
the operations further comprise:
controlling a position of a virtual camera in the virtual space based on a position of the first player character; and
controlling an orientation of the virtual camera based on at least the first direction input data.

13. The game system according to claim 12, wherein
the second operation device includes at least a second direction input unit, and configured to output second direction input data based on an input to the second direction input unit,
the operations further comprise:
controlling movement of the first player character in the virtual space based on the second direction input data,
the game system includes a first embodiment in which the second operation device further includes a third direction input unit and is configured to output third direction input data based on an input to the third direction input unit, and a second embodiment in which the second operation device does not include the third direction input unit, and
the operations further comprise:
controlling an orientation of the virtual camera based on the third direction input data in the first embodiment.

14. The game system according to claim 11, wherein
the operations further comprise:
controlling a position of a second cursor;
causing the first player character to perform the first action, and moving a second object for which a second material is set toward a position in the virtual space related to the position of the second cursor, according to the third instruction; and
setting a second voxel update range at a collision position based on collision determination between the second object and the mesh, and producing a second in-game effect including a change in at least one of the densities and materials of voxels in the voxel data related to the second voxel update range.

15. The game system according to claim 11, wherein
the operations further comprise:
producing, as the first in-game effect, one of a plurality of effects including at least
an effect of reducing the densities of voxels in the voxel data related to the first voxel update range,
an effect of increasing the densities of the voxels in the voxel data related to the first voxel update range and setting the materials of the voxels in the voxel data related to the first voxel update range to the first material, and
an effect of, when a third material that is a material of the mesh at the collision position and the first material are a first combination, changing the materials of the voxels in the voxel data related to the first voxel update range to a fourth material,
depending on the type of the first material.

16. The game system according to claim 11, wherein
the first operation device includes at least one of a mouse and an inertial sensor,
the first operation device is configured to output at least one of mouse data based on an output of the mouse and inertial data based on an output of the inertial sensor, and
the operations further comprise:
controlling the position of the first cursor based on at least one of the mouse data and the inertial data.

17. The game system according to claim 11, wherein
the first operation device includes at least one of a mouse, an inertial sensor, and a fourth direction input unit,
the first operation device is configured to output at least one of mouse data based on an output of the mouse, inertial data based on an output of the inertial sensor, and fourth direction input data based on an input to the fourth direction input unit, and
the operations further comprise:
controlling the position of the first cursor based on at least one of the mouse data, the inertial data, and the fourth direction input data.

18. The game system according to claim 11, wherein
the mesh is a determination mesh used in the collision determination, and
the operations further comprise:
generating or updating a display mesh related to the voxel data and to be rendered based on a virtual camera, by determining vertex coordinates of the display mesh based on at least the density included in the voxel data, and determining a material of the display mesh based on at least the material included in the voxel data; and
rendering the virtual space including the display mesh based on the vertex coordinates of the display mesh and a texture related to the material of the display mesh.

19. The game system according to claim 11, wherein
the operations further comprise:
rendering the virtual space including the mesh based on the vertex coordinates of the mesh and a texture related to the material of the mesh.

20. A game processing method, comprising:
generating and updating a mesh based on voxel data defined in a virtual space, wherein the mesh is a mesh of a voxel object related to the voxel data, wherein in the voxel data, for each of a plurality of voxels, at least a density indicating the degree of virtual occupation of a content in a space defined by the voxel, and a material indicating the type of the content, are set, and wherein vertex coordinates of the mesh are determined based on at least the density, and a material of the mesh is determined based on at least the material included in the voxel data;
controlling a position of a first cursor based on an operation input from a first operation device;
identifying a material of the mesh at a position in the virtual space related to the position of the first cursor according to a first instruction based on an operation input from the first operation device, wherein the identified material is a first material;
moving a first object for which the first material is set, toward the position in the virtual space related to the position of the first cursor, according to a second instruction based on an operation input from the first operation device; and
setting a first voxel update range at a collision position based on collision determination between the first object and the mesh, and producing a first in-game effect including a change in at least one of the densities and materials of voxels in the voxel data related to the first voxel update range.

21. The game processing method according to claim 20, further comprising:
controlling movement of the first player character in the virtual space based on an operation input from a second operation device;
controlling movement of the second player character together with the movement of the first player character;
causing the first player character to perform a first action according to a third instruction based on an operation input from the second operation device; and
causing the second player character to perform a second action, and moving the first object, according to the second instruction.

22. The game processing method according to claim 21, further comprising:
controlling a position of a virtual camera in the virtual space based on a position of the first player character; and
controlling an orientation of the virtual camera based on at least an operation input from the first operation device.

23. The game processing method according to claim 22, further comprising:
controlling the orientation of the virtual camera, additionally based on an operation input from the second operation device.

24. The game processing method according to claim 21, further comprising:
controlling a position of a second cursor;
causing the first player character to perform the first action, and moving a second object for which a second material is set toward a position in the virtual space related to the position of the second cursor, according to the third instruction; and
setting a second voxel update range at a collision position based on collision determination between the second object and the mesh, and producing a second in-game effect including a change in at least one of the densities and materials of voxels in the voxel data related to the second voxel update range.

25. The game processing method according to claim 20, further comprising:
producing, as the first in-game effect, one of a plurality of effects including least
an effect of reducing the densities of voxels in the voxel data related to the first voxel update range,
an effect of increasing the densities of the voxels in the voxel data related to the first voxel update range and setting the materials of the voxels in the voxel data related to the first voxel update range to the first material, and
an effect of, when a third material that is a material of the mesh at the collision position and the first material are a first combination, changing the materials of the voxels in the voxel data related to the first voxel update range to a fourth material,
depending on the type of the first material.

26. The game processing method according to claim 20, wherein
the operation input from the first operation device includes at least one of data based on a mouse, data based on an inertial sensor, and direction input data, and
the method further comprises:
controlling the position of the first cursor based on at least one of the d based on a mouse, the data based on an inertial sensor, and the direction input data.

27. The game processing method according to claim 20, wherein
the mesh is a determination mesh used in the collision determination, and
the method further comprises:
generating or updating a display mesh related to the voxel data and to be rendered based on a virtual camera, by determining vertex coordinates of the display mesh based on at least the density included in the voxel data, and determining a material of the display mesh based on at least the material included in the voxel data; and
rendering the virtual space including the display mesh based on the vertex coordinates of the display mesh and a texture related to the material of the display mesh.

28. The game processing method according to claim 20, further comprising:
rendering the virtual space including the mesh based on the vertex coordinates of the mesh and a texture related to the material of the mesh.
